(19) United States
(12) Patent Application Publication
(10) Pub. No.: US 2026/0361546 A1
(43) Pub. Date: Nov. 12, 2026

(54) CONSTRAINT-ADAPTIVE COMMUNICATION ENVELOPE FOR INTERACTIVE APPLICATIONS WITHIN RESOURCE-CONSTRAINED MESSAGE SURFACES

(71) Applicant: Benjamin Hopwood, Denver, CO (US)

(72) Inventor: Benjamin Hopwood, Denver, CO (US)

(73) Assignee: Agentic Solutions LLC, Denver, CO (US)

(21) Appl. No.: 19/669,705

(22) Filed: May 6, 2026

Related U.S. Application Data
(60) Provisional application No. 63/802,464, filed on May 8, 2025.

(51) Int. Cl. H04L 9/32; G06F 21/60; G06F 21/62; H04L 9/00

(52) U.S. Cl. CPC H04L 9/3234; G06F 21/602; G06F 21/6227; H04L 9/50

(57) ABSTRACT

A constraint-adaptive system resolves byte-ceiling, execution-sandbox, and absent-middleware constraints on resource-constrained electronic message surfaces to enable multi-step interactive workflows within the surface without redirection. A budget-aware allocator selects conversational state by relevance, replacing excluded elements with typed placeholder assets that simultaneously satisfy surface constraints and ensure no sensitive data traverses the standard message delivery transport. Sensitive data is delivered exclusively through an authenticated secure channel. Progressive disclosure transitions sensitive data from obscured through masked to visible based on escalating authentication gated by dynamically selectable compliance profiles. The system transforms constrained surfaces into interactive service endpoints providing both a visual interface for humans and a structured interface for autonomous agents within a unified byte-budgeted payload. A tamper-evident hash-linked audit ledger records every interaction, disclosure, and adaptation decision.

### CROSS-REFERENCE TO RELATED APPLICATIONS

This application claims the benefit of priority under 35 U.S.C. § 119(e) to U.S. Provisional Patent Application No. 63/802,464, filed May 8, 2025, entitled “Architecture for Multi-Turn Conversational Agents and Data Interchange in Electronic Messages with Cross-Platform Routing,” the entire disclosure of which is incorporated herein by reference in its entirety.

This application is related to U.S. Patent Application No. [Application No. to be inserted by Preliminary Amendment], entitled “Agent-Orchestration Bridge for Resource-Constrained Electronic Message Surfaces,” filed on the same day as the present application by the same inventor and claiming the benefit of priority to the same U.S. Provisional Patent Application No. 63/802,464. The two applications disclose related but distinct inventions sharing a common technical foundation.

### COPYRIGHT AND TRADEMARK NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. Trademarks used in the disclosure of the invention, and the applicants, make no claim to any trademarks referenced.

### FIELD OF THE INVENTION

The present disclosure relates to electronic messaging systems, and more particularly to constraint-adaptive architectures that embed interactive, multi-turn applications-including commerce, regulated-data workflows, and payment processing-within resource-constrained message delivery surfaces while enforcing channel-specific byte budgets.

### BACKGROUND OF THE INVENTION

Electronic message surfaces impose three primary architectural constraints that together prevent application-grade interactive workflows: hard byte ceilings on delivered payloads, sandbox restrictions limiting executable logic, and an absence of sender-accessible server-side middleware. Byte ceilings vary by platform: AMP for Email enforces approximately 102,400 bytes, Apple Push Notification Service and Firebase Cloud Messaging reject payloads exceeding 4,096 bytes, Microsoft Teams imposes approximately 28,000 bytes for Adaptive Cards, and Google's RCS Business Messaging API caps AgentMessage payloads at approximately 250,000 bytes with text limited to 3,072 characters. When these ceilings are exceeded, the platform truncates, rejects, or silently rewrites the message, destroying both interactivity and content integrity. Beyond these primary constraints, additional secondary constraints—attachment and remote-content blocking, user-interface element quotas, privacy gates suppressing tracking, and latency service-level agreements—further restrict the design space, as further described below.

Beyond payload size, these message surfaces impose multiple additional constraint categories. Sandbox restrictions prohibit or severely restrict executable logic—most surfaces forbid custom JavaScript, external iframes, and untrusted fonts, preventing embedded payment SDKs or agent runtimes from executing. Attachment and remote-content blocking policies prevent surfaces from fetching external assets—many email clients block remote images by default, requiring content to be inlined or deferred. User-interface element quotas limit the structural complexity of interactive content—RCS limits quick-reply buttons to three, Adaptive Cards impose maximum nesting depth, and social messaging surfaces restrict interactive element counts. Privacy gates suppress tracking mechanisms—modern email clients proxy remote content and block tracking pixels, preventing the attribution and telemetry mechanisms that web applications rely on. Latency service-level agreements require responses within platform-specific time windows—slash-command surfaces reject responses exceeding approximately three seconds, and action-card surfaces timeout asynchronous callbacks. These constraints compound the byte-ceiling problem: even if content could fit, the execution environment, structural limits, privacy restrictions, and latency requirements independently prevent interactive application behavior.

These compounding constraints force conventional systems to redirect users to external interfaces—separate web views, checkout pages, or siloed channels—to complete multi-step interactions. Each context switch produces significant user drop-off. Moreover, because the final transaction occurs outside the message rail, senders lack verifiable records that conversions actually completed, hindering attribution and regulatory compliance.

Message surfaces also lack server-side middleware capabilities. Unlike web applications that can apply middleware chains for security, compliance, and content classification, message surfaces provide no pre-delivery processing hooks. Email is delivered as-is; push notifications are fire-and-forget; RCS provides no sender-accessible server-side filtering layer. Any security, compliance, or classification processing must occur before the envelope reaches the surface. Furthermore, no existing messaging architecture provides a tamper-evident record linking each conversational turn, policy decision, and constraint-adaptation event into a verifiable chain of custody—a requirement for regulated industries including healthcare, financial services, and consumer privacy. Additionally, no prior system dynamically adjusts the content fidelity of an interactive message in response to runtime network or device telemetry, instead forcing interactive applications to either fail entirely or degrade in an uncontrolled manner when conditions fluctuate.

The compounding effect of these three constraint categories—byte ceilings, sandbox restrictions, and absent sender-accessible middleware—has prevented any prior system from delivering application-grade interactive experiences within message surfaces. While AMP for Email provides limited interactivity (forms, image carousels), it cannot embed payment SDKs due to sandbox restrictions, cannot maintain server-side session state, and cannot apply security middleware. While Microsoft Adaptive Cards support action-based interactions, they are limited to approximately 28,000 bytes of JSON, cannot render arbitrary HTML, and keep state client-side. No prior system resolves these compounding constraints simultaneously to enable a complete multi-step interactive workflow entirely within a single message delivered through any of these constrained surfaces—whether that workflow involves commerce transactions, healthcare billing, insurance claims processing, financial account servicing, government form completion, customer service case management, document review with digital signatures, interactive advertising with in-message conversion, educational assessments, or autonomous agent-mediated negotiations.

Accordingly, there is a need for an architecture that constructs communication envelopes guaranteed to fit within channel-specific byte budgets, resolves the compounding constraints of byte ceilings, execution sandboxes, and absent sender-accessible middleware to enable fully interactive multi-turn applications—including but not limited to payment processing, regulated data handling, advertising interactions, agent-mediated transactions, document execution, and digital workflows across any domain—entirely within the message surface without redirection, and applies server-side security and compliance controls that the message surfaces themselves do not provide.

### BRIEF SUMMARY OF THE INVENTION

The present invention provides a constraint-adaptive architecture for delivering interactive multi-turn applications within resource-constrained electronic message surfaces. The architecture solves the technical problem of executing application-grade interactive workflows—including commerce, regulated-data handling, payment processing, and agent-mediated transactions—entirely inside delivery channels that impose strict byte ceilings, sandbox limits on executable logic, attachment-blocking and privacy-gating policies, and the absence of sender-accessible server-side middleware. By coordinating byte-budget enforcement, typed placeholder substitution, two-phase delivery, server-side security controls, and a tamper-evident audit ledger, the architecture enables a recipient to complete an interactive workflow without being redirected outside the message surface, while preserving cryptographic chain-of-custody for every interaction.

In one embodiment, for a resource-constrained electronic message surface that imposes at least one constraint, including without limitation a byte-ceiling constraint, a sandbox restriction limiting executable logic, an attachment or remote-content restriction, a user-interface element quota, a privacy-gate restriction limiting tracking mechanisms, a latency service-level constraint, or an absence of sender-accessible server-side middleware, a system resolves the imposed constraint or combination of imposed constraints by assembling a communication envelope compatible with each imposed constraint, the envelope fitting within a channel byte-budget derived from the byte-ceiling constraint when the byte-ceiling constraint is among the imposed constraints. The system applies server-side security and compliance controls to the envelope prior to transmission, providing controls that the message surface does not expose to the message sender. The system maintains interactive session state across a plurality of sequential interaction turns within the message surface, each turn generating updated session state incorporated into a refreshed communication envelope constrained to the channel byte-budget when a byte-ceiling constraint is imposed. The system enables a recipient to complete a multi-step interactive workflow—including at least three distinct interaction steps with session state persisting across steps—entirely within the message surface without the recipient being redirected to an external interface at any step.

In one embodiment, the system identifies elements subject to a regulatory retention mandate and unconditionally retains those elements in the envelope regardless of relevance score, such that regulation-mandated content survives eviction under byte pressure.

In one embodiment, a server-side control pipeline applies a plurality of controls including rate limiting, policy evaluation, content classification, or other equivalent control mechanisms to the communication envelope prior to transmission, enforcing security and compliance controls that the message surface does not expose to the message sender.

In one embodiment, the system adapts the channel byte-budget in response to runtime resource telemetry indicating elevated network latency, packet loss, device resource constraints, or other runtime resource signal, reducing the byte-budget so that the interactive session continues operating under prevailing conditions rather than failing.

In one embodiment, the system generates a replay-detection token that cryptographically binds at least two identifiers selected from a conversation identifier, a platform identifier, a recipient identifier, a session identifier, a device identifier, or other identifying credential, such that the communication envelope is rejected when executed in a context that does not match the bound identifiers.

In one embodiment, the system records each conversational turn, policy decision, and constraint-adaptation event in a tamper-evident audit ledger using hash-linked records, a Merkle tree structure, a blockchain anchor, signed timestamps, or other tamper-evident mechanism, enabling regulated senders to prove the complete chain of custody for every interaction conducted within the message surface.

In one embodiment, a method includes deriving a channel byte-budget, assembling a communication envelope within the byte-budget, and transmitting the envelope enabling a recipient to conduct a multi-turn interactive session within the message surface without redirection.

In one embodiment, a machine-readable data structure defines a communication envelope comprising at least a shard field including conversational state elements selected by relevance and constrained to the channel byte-budget, and further including one or more of a payload field, a token field storing a replay-detection token, a policy-receipt field, a signature field including a cryptographic message-authentication code, or other functionally equivalent field, the entire data structure serialized so as not to exceed the channel byte-budget when a byte-ceiling constraint is imposed.

In one embodiment, the resource-constrained electronic message surface operates as an interactive service endpoint accessed by one or more of human recipients, autonomous software agents, or human-agent hybrid participants wherein a human recipient and an autonomous software agent interact within the same session. The system delivers a unified payload supporting a visual interface layer for human interaction and a structured agent interface layer carrying machine-readable affordances for agent invocation, both layers being subject to the same channel byte-budget when applicable and the same server-side security and compliance controls. A payment transaction may be initiated and completed entirely within the interactive service endpoint without redirection, and federated commerce across multiple merchants is supported through merchant-scoped session bindings within the same envelope. The interactive service endpoint thereby transforms the message surface from a static delivery target into a multi-party transaction venue while preserving the byte-budget, sandbox, and audit-ledger guarantees of the constraint-adaptive architecture.

In one embodiment, the system implements a two-phase delivery security model. In a first phase, an envelope skeleton comprising at least a plurality of typed placeholder assets—each placeholder occupying the structural position of a sensitive data element—and further comprising one or more of presentation markup, application logic, and a replay-detection token, is transmitted through the standard message delivery transport, with no sensitive data traversing that transport. In a second phase, the host-channel client establishes a secure runtime channel directly to the envelope generator upon rendering the envelope, and the sensitive data is delivered exclusively through the secure runtime channel for hydration in place of the corresponding placeholders. The same typed placeholder asset that satisfies a surface-imposed byte-ceiling, sandbox, attachment, element-quota, privacy-gate, latency, or other surface-imposed constraint simultaneously enforces transport-security compliance, providing a single structural mechanism by which constraint satisfaction and transport-security enforcement are architecturally coextensive.

### BRIEF DESCRIPTION OF THE DRAWINGS

FIG. 1 is a block diagram of a constraint-adaptive messaging system and its principal components.

FIG. 2 is a flowchart of the budget-aware allocator's operation during communication envelope assembly.

FIG. 3 is a schematic diagram of the internal layout of a communication envelope.

FIG. 4 is a swim-lane sequence diagram of placeholder hydration through three-tier storage.

FIG. 5 is a sequence diagram of replay-detection token generation and verification.

FIG. 6 is a block diagram of a server-side ordered control pipeline and its three sequential stages.

FIG. 7 is a decision-flow diagram of runtime resource adaptation by a budget-aware allocator and routing engine.

FIG. 8 is a block diagram of a tamper-evident audit ledger as a chain of hash-linked turn records.

FIG. 9 is a diagram of a two-phase delivery security model showing a standard transport phase and a secure runtime channel phase.

FIG. 10 is a diagram of a PCI-scoped payment interface rendered within a message surface.

FIG. 11 is a decision-flow diagram of a reopen-and-resume state resolution process.

FIG. 12 is a workflow diagram of a representative multi-step interactive workflow conducted entirely within a resource-constrained message surface.

FIG. 13 is a comparison diagram contrasting a conventional static-display-plus-redirect model with a constraint-adaptive interactive service endpoint model.

FIG. 14 is a data structure diagram of a unified payload including a visual interface layer and a structured interface layer.

### DETAILED DESCRIPTION OF THE INVENTION

While various aspects and features of certain embodiments have been summarized above, the following detailed description illustrates exemplary embodiments in further detail. The described examples are provided for illustrative purposes and are not intended to limit the scope of the invention. In the following description, “in one embodiment” or “in some implementations” indicates that the described feature is not required in every embodiment. Enumerated lists of representative examples introduced by “including,” “such as,” “for example,” “examples include,” or similar enumerations throughout this specification are intended to be non-exhaustive and illustrative; the absence of an explicit qualifier such as “without limitation” shall not be construed as limiting any enumeration to the items expressly listed.

### Definitions

As used herein, “channel byte-budget B” refers to the maximum serialized size, in bytes, that a host delivery channel accepts for a single communication envelope. Representative values include 102,400 bytes for AMP for Email, 4,096 bytes for push notification services, 28,000 bytes for Adaptive Cards, and approximately 250,000 bytes for Google's RCS Business Messaging API.

As used herein, “communication envelope” refers to a composite data structure including interactive application logic, conversational state, presentation markup, and security credentials, constrained to fit within a channel byte-budget B.

As used herein, “message surface” refers to any electronic rendering environment—accessed by a human user, a system process, or an autonomous software agent—that imposes resource constraints on delivered content, including but not limited to email renderers, push notification handlers, RCS chat interfaces, productivity-suite card renderers, mobile advertising slots, web advertising display units, connected-television overlays, in-application interstitial surfaces, social media message units, IoT device displays, augmented-reality and spatial-computing overlays, vehicle infotainment interfaces, wearable device screens, digital signage, accessibility interfaces (screen readers, braille displays, voice-only renderers), industrial monitoring displays, and any current or future rendering environment that imposes byte-budget, sandbox, structural, or modality constraints on delivered content.

As used herein, “sliding-window shard” refers to the subset of conversational state selected for inclusion in the current communication envelope, the subset being constrained so that its serialized size does not exceed B.

As used herein, “typed placeholder asset” (or “placeholder asset”) refers to a structural data surrogate that replaces an excluded conversational state element, including a content-type identifier indicating the category of content replaced (inheriting the semantic type of the missing data), a condensed surrogate enabling the recipient to continue interaction with a meaningful representation of the excluded element, and an authenticated retrieval reference (manifest pointer) enabling on-demand recovery of the full element. The typed placeholder asset serves a dual function. First, it satisfies at least one constraint imposed by the resource-constrained electronic message surface. The constraint so satisfied may be (a) a byte-ceiling constraint—the placeholder occupies substantially fewer bytes than the original element while preserving the element's structural position, keeping the envelope within the channel byte-budget; (b) a sandbox restriction limiting executable logic—the placeholder is static structural data rather than the executable component (for example, a payment SDK or agent runtime) that the sandbox would reject, with the executable functionality deferred to the authenticated secure runtime channel; (c) an attachment or remote-content blocking policy—the placeholder avoids remote asset fetches that the surface would suppress, inlining a surrogate while deferring the full asset to the secure runtime channel (see paragraph [0096]); (d) a user-interface element quota—the placeholder consolidates what would otherwise be multiple discrete UI elements into a single addressable structural slot, keeping the envelope under the surface's element-count quota; (e) a privacy gate suppressing tracking mechanisms—the placeholder's authenticated retrieval reference routes hydration through the tamper-evident audit ledger and secure runtime channel rather than through tracked remote-image URLs or cookies that the surface would block (see paragraph) [0102]); or (f) a latency service-level target—the placeholder permits the initial envelope to be assembled and delivered within the latency budget, with the full element hydrated asynchronously (see paragraph [0101]). Second, the typed placeholder asset simultaneously enforces transport-security compliance by ensuring that the actual sensitive data never traverses the standard message delivery transport—the sensitive data is delivered exclusively through the authenticated secure runtime channel established when the host-channel client renders the envelope (see paragraphs [0139]-[0145]). This dual-function property—one structural element simultaneously satisfying a surface-imposed constraint and a transport-security requirement—distinguishes the typed placeholder asset from generic loading indicators, skeleton screens, or lazy-loading placeholders used in conventional web development, which serve only a performance or visual-stabilization purpose and do not enforce transport-security compliance, and from secure-message architectures that protect sensitive content via gateway-level conversion or portal redirect, which do not satisfy surface-imposed constraints through structural substitution.

The dual function of the typed placeholder asset set forth in paragraph [0037] follows necessarily from the placeholder's structural composition: (i) the content-type identifier classifies the excluded element semantically, (ii) the condensed surrogate is by construction a non-sensitive representation of the excluded element, and (iii) the authenticated retrieval reference is cryptographically bound to the conversation, platform, and recipient identifiers (paragraphs [0071]-[0077]) and resolves only through a secure runtime channel established at envelope render time (paragraphs [0134]-[0141]). The substitution operation that replaces the sensitive element with the placeholder thereby simultaneously (a) removes the sensitive data from the initial envelope traversing the standard message delivery transport and (b) routes any subsequent hydration of the sensitive element exclusively over the authenticated channel. This single-element coextensiveness—one structural component simultaneously satisfying a surface-imposed constraint and excluding sensitive data from the standard transport—is architecturally distinct from prior-art approaches that address surface-constraint satisfaction and transport security as independent concerns through separate mechanisms (for example, a content delivery network resolving byte limits combined with a separate gateway-level tokenization resolving transport security).

As used herein, “replay-detection token” refers to a per-envelope cryptographic credential that binds at least two identifiers selected from a conversation identifier, a platform identifier, a recipient identifier, a session identifier, a device identifier, or other identifying credential into a single verifiable token, such that the communication envelope is rejected when executed in a context that does not match the bound identifiers.

As used herein, “tamper-evident audit ledger” refers to an append-only ledger in which each record is cryptographically bound to preceding records using a hash-linked chain, a Merkle tree structure, a blockchain anchor, signed timestamps, or other tamper-evident mechanism, such that alteration of any record is detectable.

As used herein, “host-channel client” refers to the application running on the recipient's device that renders the communication envelope, including but not limited to email clients, push notification handlers, RCS messaging applications, and productivity-suite card renderers.

As used herein, “platform descriptor” refers to data supplied by or derived from the host-channel client identifying the execution environment and its resource constraints, from which the channel byte-budget B is derived.

As used herein, “relevance criterion” refers to any function, rule set, or model that produces a ranking of conversational state elements enabling subset selection when the full state exceeds B. Embodiments include deterministic scoring functions, fixed priority levels, machine-learned relevance predictors, user-interaction recency measures, and hybrid combinations thereof.

As used herein, “degraded-resource indicator” (also “degraded-connectivity indicator”) refers to a flag embedded in the communication envelope signaling that the byte-budget has been reduced from its nominal value due to network, device, or resource constraints, and that the envelope includes reduced content.

As used herein, “PolicyReceipt” refers to a per-event record appended to the tamper-evident audit ledger including at least a policy identifier, an action taken, a risk score, and a timestamp.

As used herein, “condensed surrogate” refers to a compact representation of an excluded element that enables the recipient to understand what content was replaced without requiring retrieval of the full element. Examples include thumbnails, text summaries, perceptual hashes, and abbreviated data previews. A condensed surrogate is distinguished from a generic loading indicator, skeleton screen, shimmer animation, or other content-agnostic placeholder, which conveys only that content is loading or pending without conveying the semantic category, content type, or any meaningful representation of the underlying element that was excluded.

As used herein, “content-type identifier” on a typed placeholder asset refers to a semantic or categorical label that classifies the nature of the content the placeholder represents, examples including without limitation “patient-diagnosis,” “billing-statement,” “billing-line-item,” “product-catalog-image,” “product-variants-overflow,” “form-fields-overflow,” “diagnostic-form,” “transaction-summary,” “appointment-availability,” and “payment-token.” A content-type identifier is distinct from (a) MIME type labels identifying media encoding (for example, image/jpeg or application/pdf), (b) file-extension identifiers (for example, .docx or .zip), (c) file-system or storage-partition metadata identifiers (for example, NTFS reparse-point stream identifiers, hierarchical-storage-management tier indicators, or file-path-keyed stub identifiers used by cloud-file-sync placeholder files), and (d) generic structural container designators identifying only the container shape without conveying the semantic category of the elements carried by the container (for example, a “type”: “overflow” designation on a Slack Block Kit “overflow” element).

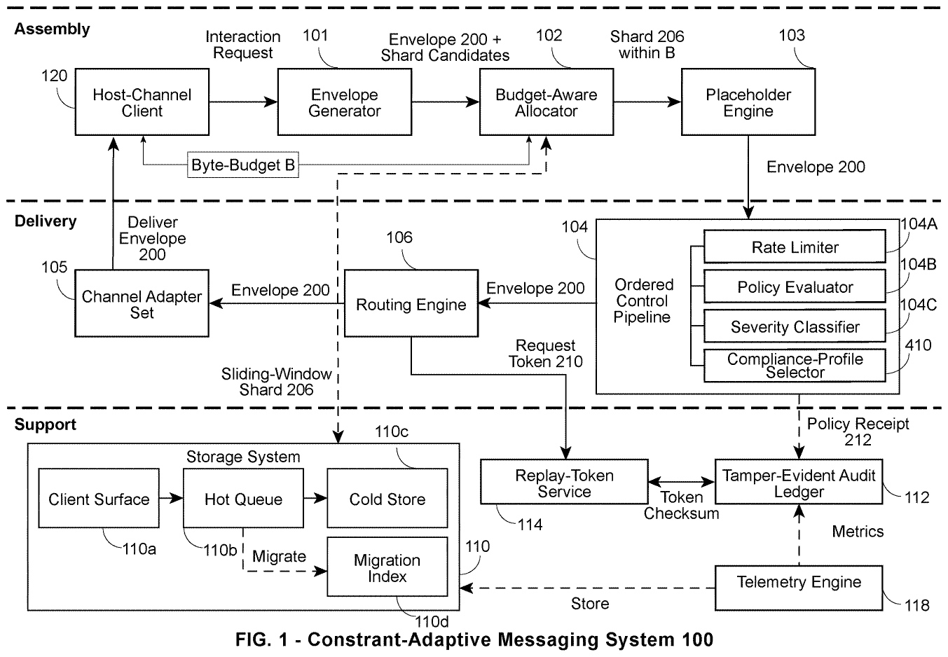

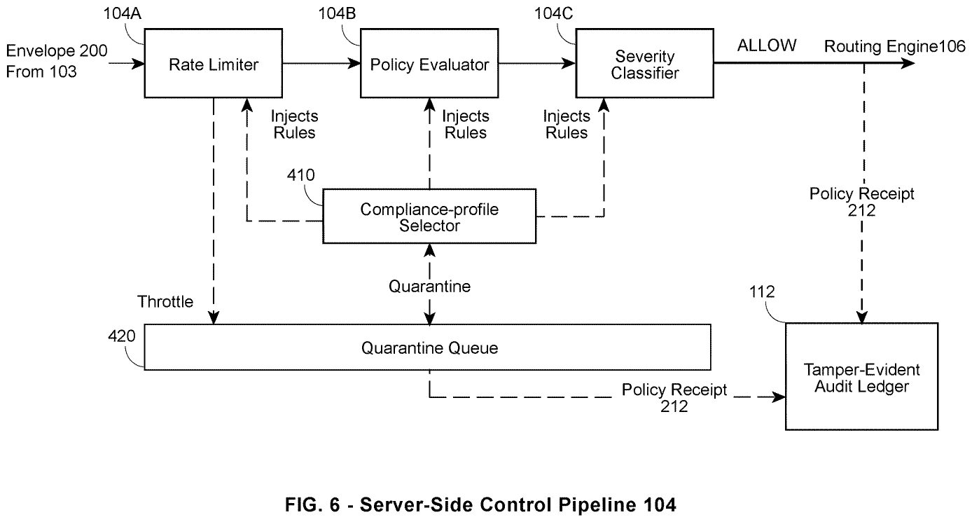

FIG. 1 is a block diagram illustrating a constraint-adaptive messaging system 100. Referring now to FIG. 1, constraint-adaptive messaging system 100 includes envelope generator 101, budget-aware allocator 102, placeholder engine 103, ordered control pipeline 104, channel adapter set 105, routing engine 106, storage system 110, tamper-evident audit ledger 112, replay-token service 114, and telemetry engine 118. As shown in FIG. 1, ordered control pipeline 104 further includes three sequential pipeline stages—rate limiter 104A, policy evaluator 104B, and severity classifier 104C—together with compliance-profile selector 410 positioned to inject regulatory-regime-specific rules upward into all three stages, the operational details of these sub-components being described in connection with FIG. 6. As further shown in FIG. 1, storage system 110 includes a plurality of storage tiers—the message-surface tier (client surface 110a, the on-device tier), the hot tier (hot queue 110b, providing low-latency access to recent state), the cold tier (cold store 110c, providing cost-efficient storage for aged state), and the migration index (110d, tracking elements scheduled for relocation between the hot tier and the cold tier)—the operational details of these tiers being described in the Storage System section below. System 100 facilitates exchange of communication envelopes between host-channel client 120—such as an email renderer, push notification handler, RCS chat application, or other byte-constrained runtime—and an envelope generator 101.

As shown in FIG. 1, the main data flow follows a U-shaped path. In the assembly row (left to right), host-channel client 120 initiates a conversational turn; envelope generator 101 derives channel byte-budget B from the platform descriptor; budget-aware allocator 102 selects the sliding-window shard; and placeholder engine 103 substitutes oversized elements with typed placeholder assets. The assembled envelope then proceeds to the gating row (right to left), where control pipeline 104 applies security and compliance controls, routing engine 106 formats the envelope for the target surface, and channel adapter set 105 serializes the envelope into the surface-native representation. The formatted envelope is delivered back to host-channel client 120, completing the U-shaped flow. Supporting components in the bottom row—storage system 110, tamper-evident audit ledger 112, and telemetry engine 118—provide state persistence, auditing, and runtime monitoring respectively, connected to the main flow via secondary data paths.

The resource-constrained electronic message surface as used herein is not limited to surfaces delivered via real-time electronic message transports. In one embodiment, the resource-constrained electronic message surface is a machine-readable code presentation, including without limitation a Quick Response (QR) code, a Data Matrix pattern, a PDF417 barcode, or an Aztec code, which may be rendered on a physical medium (printed on product packaging, printed on a receipt or invoice, displayed on out-of-home advertising, embossed on a medical device label, affixed to an industrial asset) or on an electronic display (rendered on a point-of-sale terminal, on a mobile device for presentation to another device, or on a connected-television screen). In such embodiments, the communication envelope is delivered through an access-point mode: the machine-readable code includes a conversation reference—for example, a URL, a conversation identifier, and a signed token—that, when decoded by a scanning device (typically a mobile device camera), triggers delivery of the communication envelope from envelope generator 101 to the scanning device's display. Envelope generator 101 determines the scanning device's constraints from the scan request's user-agent and device hints and derives the applicable channel byte-budget from those constraints. The constraint-adaptive mechanisms described herein—budget-aware allocator 102, placeholder engine 103, control pipeline 104, replay-detection token 210, and tamper-evident audit ledger 112—operate identically to their operation on message-transport-delivered surfaces, demonstrating that the architecture is agnostic to whether the resource-constrained surface is accessed via a real-time message transport or via a visually-encoded machine-readable code that references and triggers delivery of the envelope.

In one embodiment, the resource-constrained electronic message surface is further selected from, without limitation, a spatial computing display presenting three-dimensional interaction objects (for example, an augmented-reality or virtual-reality display overlaying interactive content onto the user's field of view), a connected-transportation dashboard (for example, a vehicle-infotainment panel or a fleet-management dashboard), a wearable device display (for example, a smartwatch tile or a fitness-band interaction panel), or any current or future surface that imposes a byte-ceiling constraint, a sandbox restriction limiting executable logic, an attachment or remote-content blocking policy, a user-interface element quota, a privacy gate suppressing tracking mechanisms, or a latency service-level target. Each such surface presents its own constraint profile, captured by the platform descriptor and reduced by envelope generator 101 to a constraint descriptor that drives the constraint-adaptation mechanisms of the present disclosure.

In one embodiment, the envelope generator 101 described in paragraph [0049] may be deployed at one or more edge nodes of a content-distribution network that are geographically distributed relative to an origin envelope-generation system, enabling the communication envelope for a target message surface to be assembled at an edge node from a subset of authoritative session state fetched from the origin as a differential update. When envelope assembly is delegated to an edge node, the replay-detection token defined in paragraph [0039] may incorporate within its cryptographically signed payload an edge-node identifier and a trust-level indicator signaling that envelope generation occurred at the edge rather than at the origin. If the origin subsequently observes a divergence between the turn-sequence value incorporated into the edge-assembled envelope and the authoritative origin turn-sequence, a structured conflict-event record is appended to the tamper-evident audit ledger 112, and the host-channel client receives a trust-level mismatch signal causing subsequent interactions with the envelope to be downgraded to a read-only presentation mode until re-synchronization with the origin is achieved.

Each outbound conversational turn originates in envelope generator 101, which derives channel byte-budget B from a platform descriptor supplied by the host-channel client. Envelope generator 101 assembles UI markup, executable logic, and a sliding-window shard into a communication envelope whose serialized size does not exceed B.

Budget-aware allocator 102 selects which conversational state elements are included in the sliding-window shard. When the full conversational state for the current turn would exceed B, allocator 102 ranks candidate elements based on at least one relevance criterion and selects a subset whose cumulative size fits within B, while retaining references enabling later retrieval of excluded elements.

### Application-Grade Interactivity Within Message Surfaces

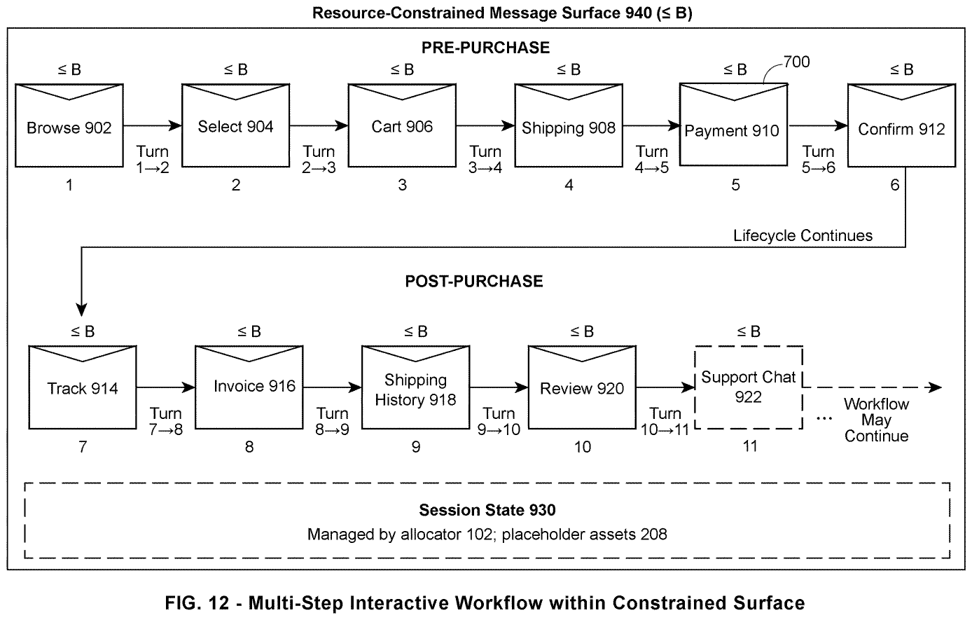

The constraint-adaptive architecture described herein enables interactive mini-applications—small, self-contained interactive programs that execute entirely within a single resource-constrained message surface, without redirection to an external interface—that rival the functionality of dedicated web applications or native mobile applications. This is a capability that no prior messaging system has achieved. The term “interactive mini-application” as used herein refers to an interactive program, embedded within a communication envelope, that presents multi-step user interface content, maintains persistent session state across interaction turns, accepts user input within the message surface, executes server-side processing via the constraint-adaptive architecture, and produces refreshed envelopes for subsequent turns—all conducted within the same message surface without redirection. The architecture is domain-agnostic: the same constraint-resolution mechanisms (budget-aware allocator 102, placeholder engine 103, control pipeline 104, replay-detection token 210, audit ledger 112, channel adapter set 105) support interactive mini-applications of many distinct types, including (without limitation) commerce and retail mini-applications with pre-purchase and post-purchase lifecycles (browse, select, cart, ship, pay, confirm, track, invoice, ship-history, review, and support as illustrated in FIG. 12); healthcare and protected-health-information mini-applications compliant with HIPAA and functionally equivalent regulatory regimes (patient billing, appointment booking, lab-result delivery, prescription refills, intake forms, consent acknowledgments); financial services mini-applications including loan origination, wealth management statements, investment servicing, banking disclosures, FINRA-compliant communications, and insurance claims processing; legal mini-applications for contract review, digital signature capture, regulatory disclosures, attorney-client communications, and non-disclosure agreement execution; real estate mini-applications for lease signing, mortgage applications, property inspections, and tenant screening; interactive advertising mini-applications including banner and display ads, connected-television shoppable overlays, in-message ad conversion, and embedded agentic ad surfaces; personal-information-protection mini-applications subject to GDPR, CCPA, state-level PII regimes, or equivalent jurisdictional privacy frameworks (consent management, data subject access requests, right-to-erasure confirmations, privacy preference updates); customer service mini-applications including AI-mediated chat, multi-turn diagnostic flows, case management, and resolution confirmation; government and public-sector mini-applications for tax filings, benefits applications, regulatory submissions, and administrative form completion; educational assessment and testing mini-applications; supply-chain and logistics mini-applications for shipping tracking, customs declarations, warehouse management, and freight booking; IoT device configuration and digital-twin monitoring mini-applications for industrial equipment, connected medical devices, and building systems; and autonomous agent-mediated mini-applications that transact, negotiate, or collaborate on behalf of human principals via an agent-orchestration bridge that establishes a stateful session between the agent and the message surface and exchanges payloads constrained to the channel byte-budget. Any multi-step interaction that can be modeled as a sequence of conversational turns with persistent state falls within the scope of the invention, and the enumerated list is non-exhaustive. FIG. 12 illustrates one representative commerce mini-application; all other mini-application types listed above are equally supported by the same architecture and are described in further detail throughout the specification.

As used herein, “resolving the compounding constraints” of a resource-constrained message surface refers to the coordinated operation of constraint-specific mechanisms that simultaneously satisfy one or more constraints imposed by the message surface, the constraints including without limitation the byte-ceiling constraint, the sandbox restriction, and the absence of sender-accessible server-side middleware—and optionally further satisfy attachment-blocking policies, user-interface element quotas, privacy gates, and latency service-level agreements—such that an interactive application can execute within the message surface. When multiple constraints are simultaneously present, they compound: the sandbox restriction blocks the custom JavaScript that web applications normally use for client-side session state management (React state, localStorage, cookies), forcing session state to be maintained entirely server-side and round-tripped within the byte budget on each interaction turn; the byte-ceiling constraint limits how much session state can be carried per turn, requiring relevance-based eviction when state grows across turns; and the absence of sender-accessible server-side middleware means that security, compliance, and content-safety controls that web applications implement via middleware chains must instead be applied to the communication envelope before transmission. Additional constraints—attachment blocking, element quotas, privacy gates, and latency SLAs—further restrict the interactive application's design space, requiring specialized adaptation for each surface. The simultaneous presence of multiple constraints is what has prevented any prior system from achieving application-grade interactivity within message surfaces.

Specifically, the byte-budget enforcement mechanisms (budget-aware allocator 102, placeholder engine 103) resolve the byte-ceiling constraint when present; the server-side control pipeline 104 and replay-detection token 210 resolve the absence of sender-accessible server-side middleware; and the surface-native formatting by routing engine 106 and channel adapter set 105 resolves the sandbox-restriction constraint when present by adapting the interactive content to each surface's permitted execution model. No single one of these mechanisms is sufficient when the corresponding constraint is present, and the application-grade experience depends on the coordinated operation of whichever mechanisms are required by the constraint profile of the target surface.

In one embodiment, the system further resolves additional surface constraints beyond the three primary constraints. Each additional constraint type is resolved through a constraint-specific adaptation mechanism that operates alongside the byte-budget enforcement described above.

In one embodiment, the multiple constraint types described herein are synthesized for each outbound turn into an extensible constraint descriptor Σ including a key-value structure that may include, without limitation, sizeCap (the channel byte-budget), sandboxMode (the execution-environment restriction indicator), attachmentPolicy (the attachment or remote-content blocking indicator), uiQuota (the user-interface element-quota indicator), privacyGate (the tracking-suppression policy indicator), and latencySla (the latency service-level target). Representative values include sizeCap=4,096 for push-notification ceilings, sizeCap≈28,672 for productivity-suite adaptive-card surfaces, sandboxMode=“no-JS” for surfaces prohibiting custom scripting, and privacyGate=true for surfaces suppressing remote tracking. The constraint descriptor Σ is schema-agnostic and extensible: administrators or operators may add additional keys (for example, accessibilityGrade, regionalPolicy, encryptionMode, or any future constraint dimension) without modification to the constraint-adaptation core because the scoring and adaptation machinery is table-driven. New constraint dimensions, new surface types, and new adaptation modules may therefore be added to the system without modification of envelope-assembly core logic—emerging message rails and future policy frameworks may be incorporated as additional descriptor keys, additional weight-vector entries, and additional adaptation modules without departing from the constraint-adaptive architecture disclosed herein.

In one embodiment, a solver and score engine, operating as a sub-component of budget-aware allocator 102, computes a weighted satisfaction score (also referred to herein as a compliance score) from constraint descriptor Σ using the formula score=Σ (w_i·s_i), where s_i represents a normalized constraint satisfaction measure for the i-th constraint dimension and w_i represents a per-surface weight value. The normalized satisfaction measure s_i is computed as a value in the closed interval [0, 1] for each descriptor key, with s_i=1 indicating that the candidate envelope fully satisfies the i-th constraint and s_i=0 indicating complete violation; intermediate values represent partial satisfaction (for example, an envelope that fits within sizeCap but exceeds latencySla yields s_size=1 and s_latency<1). The per-surface weight vector w is retrieved by the solver and score engine from a weight-vector store at the moment of envelope assembly using the platform descriptor as the lookup key. The weight-vector store supplies surface-specific weights-for example, a smartwatch may weight size and latency highly and user-interface-quota less critically, whereas a connected-television interactive advertising surface may weight latency and user-interface quota highly and size less critically. Because the weight vector is table-driven and retrieved at assembly time rather than hard-coded, new surface types may be added to the system by registering an additional row in the weight-vector store without modification of envelope-assembly core logic.

In one embodiment, the weighted satisfaction score is compared against a configurable threshold τ to determine whether the envelope is transmitted as-assembled or undergoes degradation. If score≥τ, the envelope is transmitted unchanged. If score<τ, a deterministic degradation sequence is invoked in the following ordered phases: first, budget-aware allocator 102 is invoked to reduce the sliding-window shard until s_size approaches 1; second, a sandbox compiler is invoked to convert any remaining executable logic into surface-compatible declarative markup; third, a quota normaliser is invoked to consolidate user-interface elements that would exceed uiQuota into typed placeholder assets; fourth, a privacy adapter is invoked to substitute tracking-bearing references with placeholder retrieval references that resolve only through the secure runtime channel; and fifth, a latency-acknowledgment proxy is invoked to absorb latency-budget pressure by issuing an interim acknowledgment to the host-channel client while the envelope completes assembly. Each phase is invoked only if the preceding phase did not raise the score above τ, and the sequence terminates as soon as score≥τ. The deterministic ordering ensures that envelopes assembled under identical inputs produce identical degradation sequences across deployments, which is a requirement for reproducible regulatory audit. A policy receipt logger records each degradation decision, each weight-vector revision, and each threshold crossing as a hash-linked entry in tamper-evident audit ledger 112 (see paragraph [0045]), enabling post-hoc reconstruction of every constraint-adaptation decision applied during envelope assembly.

### Budget-Aware Allocator

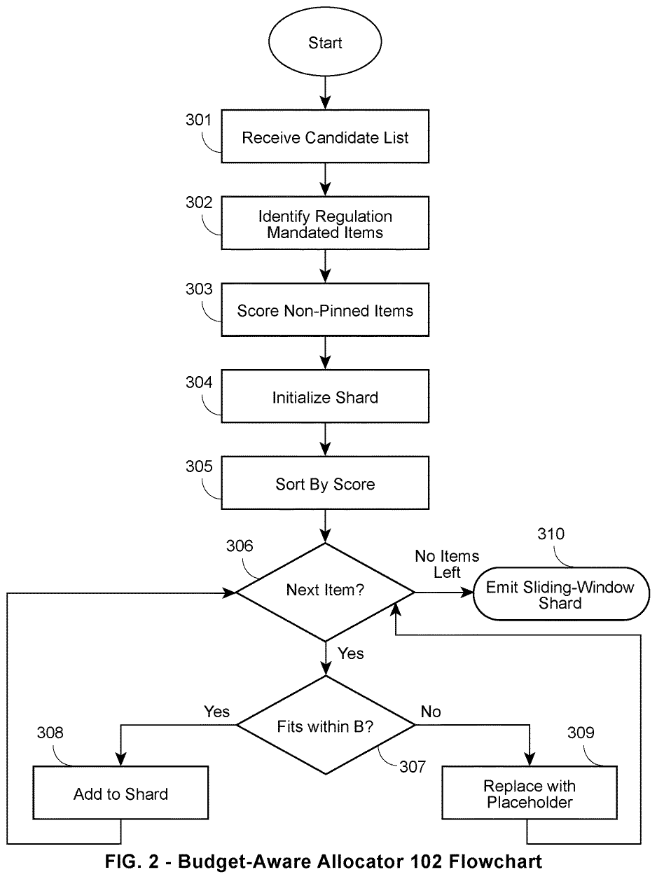

FIG. 2 is a flowchart illustrating steps 301 through 310 of budget-aware allocator 102 during communication envelope assembly. Referring to FIG. 2, in one embodiment, allocator 102 operates according to the following algorithm corresponding to flowchart steps 301 through 310: at step 301, receive a candidate list L of conversational state elements from the envelope generator; at step 302, identify regulation-mandated elements and assign them to a Pin Set P that is unconditionally retained; at step 303, score each non-pinned element by the selected relevance criterion; at step 304, initialize sliding-window shard W with Pin Set P and set currentSize equal to the serialized size of P; at step 305, sort remaining elements by score in descending order; at step 306, determine whether any items remain to process—if no items remain, proceed to step 310; at step 307, for each remaining element i, determine whether currentSize plus the serialized size of i would exceed B; at step 308, if the element fits, add i to shard W and increment currentSize, then return to step 306; at step 309, if the element does not fit, replace i with a placeholder asset retaining a retrieval reference, then return to step 306; at step 310, emit the completed sliding-window shard W with total serialized size not exceeding B.

In one embodiment, the relevance criterion is a deterministic scoring function that blends at least recency, semantic relevance, and a compliance parameter. In a preferred embodiment, the importance score S for each non-pinned element is computed as S=α·R+β·W+γ·C, where R represents a recency weight (higher for elements from recent conversational turns), W represents a semantic-relevance weight (higher for elements referenced by the current turn's context), C represents a compliance-criticality parameter (elevated for elements associated with regulatory regimes but not yet mandated for unconditional retention), and α, β, γ are operator-tunable coefficients. In a preferred embodiment, α=0.5, β=0.3, γ=0.2. The compliance parameter unconditionally retains elements subject to a regulatory retention mandate—such as HIPAA consent acknowledgments, PCI transaction disclosures, or FINRA suitability records—regardless of their relevance score. This ensures that regulation-mandated content survives eviction under byte pressure, which is a requirement for any system handling regulated workflows within constrained message surfaces.

In a second embodiment, the relevance criterion includes fixed priority levels assigned by element type: priority level 1 (critical—payment state, active form fields, compliance-mandated elements) which is never evicted; priority level 2 (important—recent product selections, user preferences) which is evicted only after all priority-3 elements have been removed; and priority level 3 (evictable—historical browsing context, older conversation turns) which is evicted first. Within each priority level, elements are evicted oldest-first by creation timestamp.

In a third embodiment, the relevance criterion includes a machine-learned relevance predictor trained on historical interaction data to predict which elements are most likely to be referenced in subsequent conversational turns. The predictor outputs a relevance probability for each element, and elements are retained in descending order of predicted relevance.

In other embodiments, the relevance criterion may include user-interaction recency (elements the user most recently viewed or modified), hybrid combinations of the above approaches, or any criterion that produces a ranking enabling subset selection. The system is not limited to any particular scoring formula. The specific formulas, algorithms, coefficient values, cryptographic primitives, and parameter values recited throughout this specification are illustrative preferred embodiments and do not limit the scope of any claim or any disclosed mechanism. Any function, rule set, model, cryptographic primitive, or successor technique that performs the corresponding computational role falls within the scope of the disclosed mechanism, regardless of whether it employs different coefficients, weighting schemes, hash or signature algorithms, parameter values, or computational approach. The system is not limited to any particular computational expression recited herein.

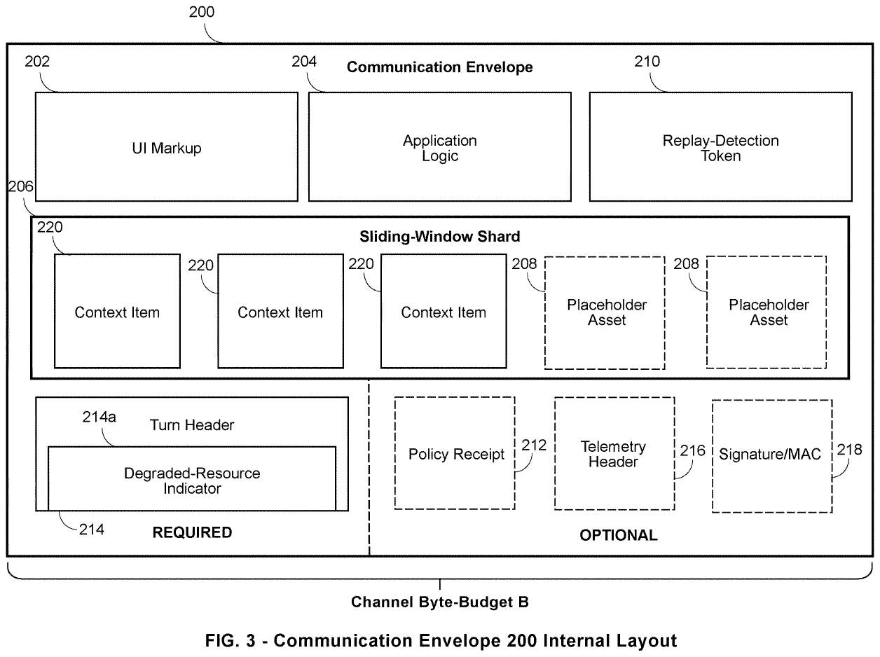

FIG. 3 is a schematic diagram illustrating an internal layout of communication envelope 200. As shown in FIG. 3, communication envelope 200 includes a plurality of fields all constrained by channel byte-budget B. UI markup 202 includes the presentation markup (for example, AMP for Email markup, Adaptive Card JSON, or RCS AgentMessage structured content) that the host-channel client renders within the message surface. Application logic 204 includes executable interactive logic (for example, amp-form actions, Action. Execute callbacks, or AgentEvent triggers) that defines the recipient's interaction affordances. Sliding-window shard 206 carries the conversational state subset selected by budget-aware allocator 102 to fit within byte-budget B and includes, as shown in FIG. 3, individual context items 220 (each representing a single conversational state element retained in the shard) and typed placeholder assets 208 (each representing an element excluded from the shard but recoverable via authenticated retrieval reference). Replay-detection token 210 stores the per-envelope cryptographic credential generated by replay-token service 114 that binds at least conversation, platform, and recipient identifiers. Policy receipt 212 includes metadata generated by control pipeline 104 for the current turn. Turn header 214 includes per-turn metadata including turn sequence number, total byte count, and degraded-resource indicator 214a. Degraded-resource indicator 214a is a flag within turn header 214 signaling that byte-budget B has been reduced from its nominal value due to network, device, or resource constraints. Telemetry header 216 includes compressed, encrypted interaction telemetry for the current turn. Signature field 218 includes a cryptographic message-authentication code verifying the integrity of the communication envelope. Each context item 220 represents a single conversational state element within sliding-window shard 206.

### Placeholder Substitution and Hydration

Referring to FIG. 3, when an element is excluded from sliding-window shard 206, placeholder engine 103 replaces it with a typed placeholder asset 208 that preserves workflow continuity. Each placeholder asset 208 includes: a content-type identifier indicating what category of content was replaced (e.g., product image, form field, prior-turn response), a condensed surrogate enabling the recipient to continue the interactive session with a meaningful representation of the excluded element (e.g., a thumbnail, a text summary, a perceptual hash), and an authenticated retrieval reference (manifest pointer) enabling on-demand recovery of the full element.

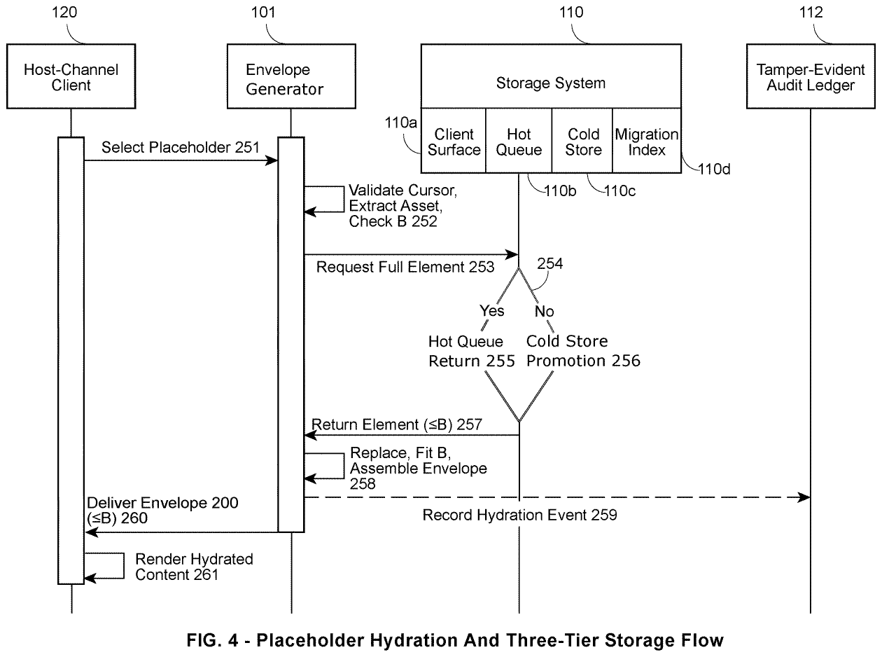

FIG. 4 is a swim-lane sequence diagram illustrating steps 251 through 261 of a placeholder hydration and three-tier storage flow across four actors, namely host-channel client 120, envelope generator 101, storage system 110, and tamper-evident audit ledger 112. Referring to FIG. 4, when the host-channel client 120 selects a placeholder asset 208—for example, by tapping a condensed surrogate such as a thumbnail or text summary—it presents the authenticated retrieval reference (manifest pointer) together with a server-signed, opaque manifest cursor to envelope generator 101 (step 251). As shown in FIG. 4, the hydration flow proceeds through the following steps: the envelope generator validates the manifest cursor signature, extracts the asset identifier from the manifest pointer, and checks byte-budget availability (step 252); the server requests the full element from storage system 110 by asset identifier (step 253); storage system 110 checks whether the element resides in hot queue 110b for low-latency retrieval (decision step 254) with a hot-queue return path (step 255) or a cold-store promotion path from cold store 110c with migration index 110d updated accordingly (step 256); the full element is returned to the envelope generator, constrained to fit within the active byte-budget B (step 257); the server replaces the placeholder with the full element and, if the hydrated shard would exceed B, re-runs budget-aware allocator 102 to evict lower-relevance elements and maintain byte-budget compliance, assembling the refreshed envelope (step 258); the hydration event is recorded in tamper-evident audit ledger 112 with a hash-link to the existing chain (step 259); and the refreshed communication envelope, with total size not exceeding B, is delivered to host-channel client 120 (step 260), which renders the hydrated content in place of the placeholder without page navigation, redirection, or a new message (step 261).

This typed-placeholder approach, as illustrated by the hydration sequence of FIG. 4, differs fundamentally from conventional truncation (which destroys workflow continuity with no recovery possible) and from generic loading indicators (which provide no meaningful representation of the excluded content). By preserving the content type and providing a meaningful condensed surrogate, placeholder assets 208 enable the recipient to continue multi-turn interaction without confusion or context loss, and the authenticated hydration mechanism ensures that the full element can be recovered on demand while maintaining byte-budget compliance and audit-chain integrity at every step.

### Replay-Detection Token

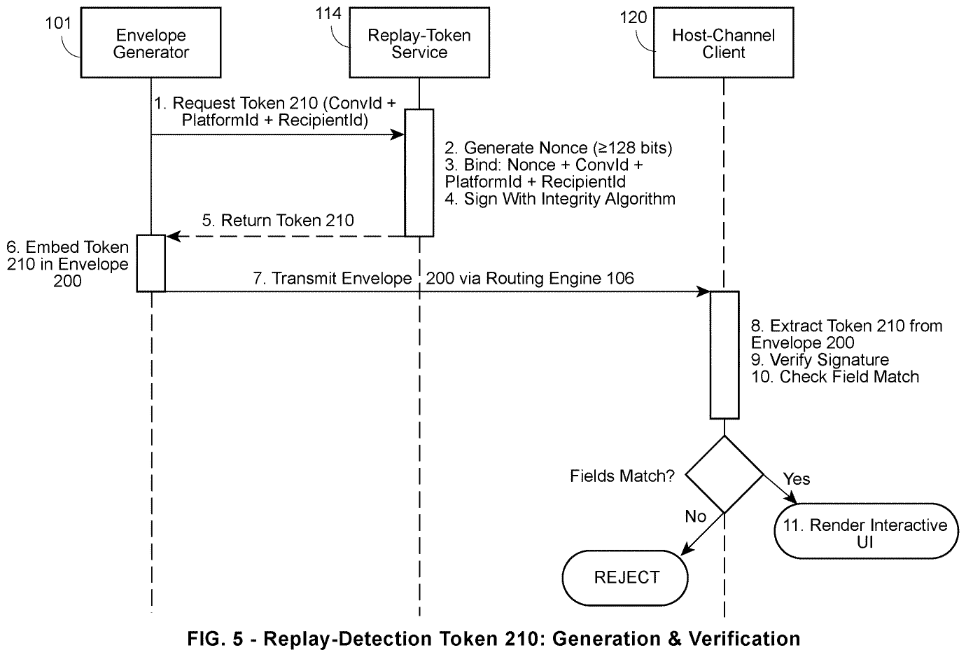

FIG. 5 is a sequence diagram illustrating replay-detection token 210 generation and verification across three actors, namely envelope generator 101, replay-token service 114, and host-channel client 120. Referring to FIG. 5, replay-token service 114 generates a replay-detection token 210 that cryptographically binds at least a conversation identifier, a platform identifier, and a recipient identifier into a single verifiable credential. This multi-field binding prevents replay or misuse of the communication envelope when forwarded across message surfaces—a scenario that is trivially possible in email and messaging environments, unlike web applications that maintain server-side sessions.

The host-channel client verifies replay-detection token 210 upon receiving the communication envelope. When any bound identifier mismatches the current execution environment—for example, when a forwarded email is opened by a different recipient on a different platform—the host-channel client rejects the envelope, preventing unauthorized execution.

In one embodiment, a distinct replay-detection token is generated for each recipient address while all tokens reference a common conversation identifier, enabling multi-party interaction within the same message surface while maintaining per-recipient provenance.

Referring to FIG. 5, replay-token service 114 generates a token according to the following algorithm: (1) generate a cryptographically random nonce N of at least 128 bits using a cryptographically secure pseudo-random number generator (CSPRNG); (2) obtain the conversation identifier convId, the platform identifier platformId (identifying the message surface type and instance), and the recipient identifier recipientId (the intended recipient's address or account); (3) concatenate the fields as N∥convId∥platformId∥recipientId; (4) apply an integrity algorithm to the concatenation using a shared secret key K to produce token T; (5) embed T in the communication envelope. In a preferred embodiment, the integrity algorithm is HMAC-SHA-256 and the secret key K is rotated every 24 hours. In other embodiments, Ed25519, post-quantum signature algorithms, or functionally equivalent integrity mechanisms may be used. The system is not limited to any particular cryptographic algorithm.

In one embodiment, the system supports runtime migration between cryptographic algorithms through an algorithm-agility registry. The registry encodes signature algorithms by a byte-valued “sigAlg” identifier—for example, 0×01 for HMAC-SHA-256, 0×02 for Ed25519, 0×03 for ECDSA-P256, and 0×04 for a post-quantum signature such as FALCON-512—and encodes digest algorithms by a byte-valued “digestAlg” identifier—for example, 0×01 for SHA-256, 0×02 for SHA-512/256, 0×03 for BLAKE3-256, and 0×04 for SHA3-256. During a configurable rolling-upgrade transition period (for example, a twenty-four-hour window with five-percent canary rollout), envelope generator 101 produces each communication envelope with a dual signature—a predecessor-algorithm signature and a successor-algorithm signature-such that host-channel clients that have migrated to the successor algorithm and clients that have not yet migrated are both able to verify the envelope. At transition completion, envelope generator 101 ceases to emit the predecessor-algorithm signature and appends a DigestChange event to tamper-evident audit ledger 112 including at least a predecessor-algorithm identifier, a successor-algorithm identifier, and a transition-completion timestamp. The system is not limited to the particular identifiers or algorithms recited in this paragraph.

In one embodiment, the replay-detection token generation operation and the envelope signing operation are performed within a hardware security module (HSM) cluster configured in an active-standby topology. A primary HSM and a standby HSM exchange heartbeat messages at a configurable interval; upon loss of primary heartbeat the standby HSM assumes active status without loss of cryptographic continuity. Key rotation within the cluster occurs on a configurable schedule (for example, every twenty-four hours for signing keys) and each rotation is appended to tamper-evident audit ledger 112 as a KeyRotate event including at least a predecessor-key identifier, a successor-key identifier, and a rotation timestamp. The active-standby topology preserves the cryptographic integrity guarantees of the replay-detection token and audit ledger across HSM failover without requiring reissuance of tokens or regeneration of ledger entries, enabling continuous operation of the constraint-adaptive architecture in regulated environments where uninterrupted cryptographic availability is mandated.

On the client side, the host-channel client verifies the token by: (1) extracting T from the received envelope; (2) extracting the claimed convId, platformId, and recipientId from the token; (3) comparing the claimed platformId against the client's actual platform identity and the claimed recipientId against the client's actual recipient address; (4) if any field mismatches, rejecting the envelope without executing any interactive logic; (5) if all fields match, verifying the cryptographic integrity of T using the shared key K; (6) if verification succeeds, rendering the interactive user interface. This constant-time verification blocks tampering before any script executes.

### Server-Side Control Pipeline

FIG. 6 is a block diagram illustrating server-side ordered control pipeline 104. Referring to FIG. 6, ordered control pipeline 104 applies security, compliance, and content-safety controls to the communication envelope prior to transmission. Message surfaces themselves provide no middleware—email is delivered as-is, push notifications are fire-and-forget, and RCS provides no server-side filtering. Control pipeline 104 fills this gap by applying server-side processing that the message surface cannot. As shown in FIG. 6, the assembled envelope enters pipeline 104 from placeholder engine 103 at the left. The envelope traverses three sequential stages from left to right; at each stage, envelopes that fail the stage's criteria are diverted downward to a quarantine queue operating with exponential back-off and retry up to a configurable maximum (retryMax). Envelopes passing all three stages exit pipeline 104 on the right and proceed to routing engine 106 with an ALLOW disposition.

In one embodiment, control pipeline 104 includes three sequential stages ordered from least computationally expensive to most expensive. Rate limiter 104A is the first stage (leftmost in FIG. 6) and applies token-bucket rate limiting to prevent flood traffic; rate limiter 104A maintains a token counter that is decremented on each envelope and replenished at a configurable rate, and rejects envelopes when the counter reaches zero—this O(1) arithmetic check is positioned first because it is the cheapest stage and eliminates volumetric abuse before more expensive processing occurs. Policy evaluator 104B is the second stage and applies deterministic rule-based evaluation using a configurable rule set (for example, YAML-encoded rules evaluated in first-match order); representative rules include requiring a vault token when the sliding-window shard includes payment data, sanitizing executable markup when the target surface is sandboxed, and redacting fields identified by the active compliance profile. Severity classifier 104C is the third and final stage and applies machine-learning classification, producing a risk score in the continuous range [0,1] for each envelope; envelopes with a risk score at or above a configurable threshold θ are diverted to the quarantine queue, while envelopes below the threshold proceed to routing engine 106. In other embodiments, the control pipeline may include a different number of stages, alternative stage orderings, parallel processing architectures, or other control mechanisms producing equivalent security and compliance effects.

In one embodiment, severity classifier 104C is extended with a content-verification sub-stage that applies one or more of the following techniques to media, text, and metadata fields of the envelope prior to the risk-score computation: (a) perceptual-hash matching, in which a perceptual hash of each embedded image or media asset is computed and compared against a configured denylist of known problematic perceptual hashes; (b) regular-expression scanning, in which configurable pattern sets are applied to text elements, form fields, and metadata in first-match order; and (c) embedding-based similarity comparison, in which a vector embedding of the envelope content is compared against a content-policy model to detect semantically problematic content that evades exact pattern matching. Each content-verification result is recorded in the policy receipt appended to the envelope, including at least a filter-action value (selected from at least block, redact, and allow) and a sixty-four-bit filter-hash value over the evaluated content. The content-verification sub-stage operates before the MAC-sign step of envelope assembly, ensuring that any filter-action decision and associated filter-hash is included within the signed envelope and is therefore tamper-evident.

As shown in FIG. 6, compliance-profile selector 410 is positioned below the three pipeline stages and injects regulatory-regime-specific rules upward into all three stages simultaneously via three separate injection paths—one to rate limiter 104A, one to policy evaluator 104B, and one to severity classifier 104C. Selector 410 dynamically selects and applies a compliance profile based on the regulatory regime applicable to the current conversation—such as HIPAA, GDPR, PCI DSS, or FINRA—and injects additional rules into all pipeline stages accordingly. The compliance profile governs which data elements are retained in cleartext, masked, encrypted, or redacted before the envelope is transmitted. This enables the same constraint-adaptive architecture to handle regulated workflows across different jurisdictions without modification to the envelope assembly logic.

Compliance-profile selector 410 operates on a declarative rule-set representation—for example, a YAML-encoded profile document—that enumerates per-jurisdiction rules governing cleartext retention, masking, encryption, redaction, tokenization, and retention periods for data elements classified by regulatory category. Representative rule sets include (a) a HIPAA profile mandating cleartext retention only within authenticated clinical contexts, masking of protected-health-information identifiers in envelope bodies, and forty-two-U.S.C.-§-1320d-compliant audit-ledger entries for each disclosure; (b) a GDPR profile mandating consent-gated processing, data-subject-rights endpoints, and lawfulness-basis metadata on each policy receipt; (c) a PCI DSS profile mandating tokenized-only treatment of primary account numbers, scope-isolated payment sub-flows, and PCI-DSS-compliant logging; (d) a FINRA profile mandating supervisory review of outbound communications, WORM-compliant retention, and Rule-3110 correspondence-archiving obligations; and (e) a CCPA/CPRA profile mandating opt-out propagation, data-broker-registry integration, and deletion-request fulfillment within statutory timelines. Each profile is independently selectable and dynamically combinable where multiple regulatory regimes apply to the same conversation (for example, a conversation simultaneously subject to HIPAA and GDPR where a European patient interacts with a United-States-based health system). The same envelope-assembly architecture handles all such profiles without per-jurisdiction application-logic modification because the compliance-profile rules are injected at the pipeline stages rather than at the application layer.

In one embodiment, the compliance profile further supports deterministic pseudonymisation of personal identifiers through a Bloom-filter-derived surrogate (“Bloom64”). For each personal identifier subject to pseudonymisation under the active compliance profile, the system computes a deterministic keyed-hash of the identifier using a tenant-specific salt held in an HSM cluster, truncates the result to sixty-four bits, and renders the truncated result as a base-32 string used as the pseudonym in ledger entries, telemetry frames, and masked envelope content. On a configurable rotation schedule, the tenant-specific salt is rotated within the HSM, and a BloomSaltRotate event is appended to the audit ledger including at least a digest of the predecessor salt, a digest of the successor salt, and a rotation timestamp, without writing either salt value to the ledger. An auditor with access to the tenant's salt-rotation history can verify pseudonym-chain consistency across a rotation boundary without reversing any individual pseudonym, enabling regulated workflows that require both privacy-preserving identifier de-identification and long-term pseudonym continuity.

Every pipeline exit—allow, throttle, or quarantine—generates a policy receipt recorded in tamper-evident audit ledger 112.

Quarantine queue 420 receives envelopes diverted by any pipeline stage, applying exponential back-off with retry up to a configurable maximum.

### Runtime Resource Adaptation

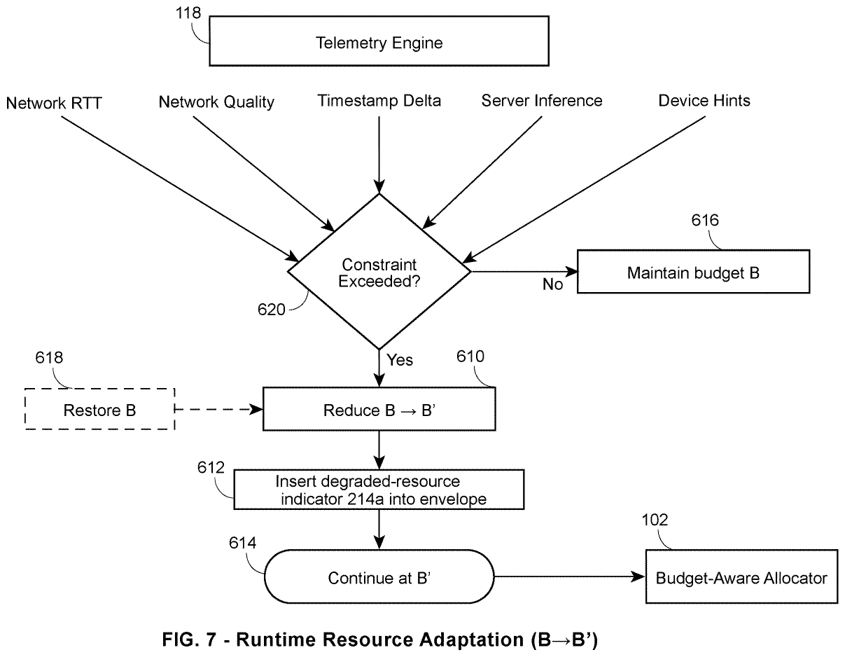

FIG. 7 is a decision-flow diagram illustrating runtime resource adaptation by budget-aware allocator 102 and routing engine 106. Referring to FIG. 7, the system adapts channel byte-budget B in response to runtime resource telemetry received from or about the host-channel client. As shown in FIG. 7, five categories of telemetry sources are depicted on the left side of the diagram: client-computed round-trip time embedded in the interaction request, browser network-quality API metrics, timestamp delta in the manifest cursor, server-side response-time inference, and device resource hints (battery, memory, CPU). All five sources converge on a central constraint-exceeded decision point. The No branch (constraint not exceeded) leads to maintenance of budget B with full-fidelity envelope delivery. The Yes branch (constraint exceeded) leads to a sequential reduction path: first, budget-aware allocator 102 reduces the byte-budget from B to a degraded value B′<B; second, routing engine 106 inserts a degraded-resource indicator into the envelope; third, the interactive session continues at B′. A dashed restoration box indicates that when conditions improve, the system restores B and hydrates excluded elements. In a preferred embodiment, B′ is computed as the floor of 0.5 times B—for example, a 102,400-byte AMP for Email budget would be reduced to 51,200 bytes under degraded conditions. In other embodiments, B′ may range from 0.3B to 0.7B depending on the severity of the degradation. In severe degradation scenarios where B′ would fall below a minimum interactive threshold (for example, below 1,024 bytes), the system may switch to a text-only mode, transmitting only textual conversational state without media elements. The degraded-resource indicator, embedded in the communication envelope's turn header as a degraded flag, signals to the host-channel client that the envelope includes reduced content and that placeholders for excluded elements are available for on-demand hydration when conditions improve.

In one embodiment, when the communication envelope assembled by envelope generator 101 exceeds the channel byte-budget B after placeholder substitution has been applied and cannot be further reduced without destroying interactive workflow continuity, routing engine 106 partitions the envelope into an ordered sequence of chunks. Each chunk includes a chunk identifier, a total-chunks count, an offset within the envelope, a chunk length, and a cryptographic hash computed over the chunk contents. The chunks are transmitted through the standard message delivery transport sequentially or in parallel depending on the transport capability; the host-channel client reassembles the chunks into the original envelope upon receipt, verifying each chunk's hash. If a chunk fails hash verification, the host-channel client requests retransmission of that chunk alone, up to a configurable maximum retry count (for example, three retries). Chunks that cannot be verified after the maximum retry count are diverted to a dead-letter queue and recorded in tamper-evident audit ledger 112 as a ChunkDeliveryFailure event. This streamed-chunk delivery mechanism enables delivery of communication envelopes that would otherwise exceed the channel byte-budget to recipients who are nonetheless connected through the standard transport, as for example a field-service technician on a high-latency satellite link requiring a detailed diagnostic envelope that exceeds the satellite-link per-message ceiling.

In one embodiment, when device resource telemetry or channel byte-budget reduction crosses a configurable text-only threshold, the system converts the communication envelope into a text-only representation. The text-only representation includes at least (i) structured markup abbreviated to plain-text form, (ii) access-key annotations enabling keyboard-only navigation, and (iii) navigation affordances sufficient to continue the interactive session at reduced fidelity. The text-only representation is constrained to a minimum-interactive floor byte size B″ that is lower than the nominal channel byte-budget B—for example, approximately one thousand twenty-four bytes, sufficient to carry a single-turn interactive choice-selection form. The text-only representation is applied when the degraded byte-budget B′ falls below the text-only threshold or when device resource hints indicate a screen-reader or voice-only rendering context. This fallback mode ensures that interactive session progression is maintained in extreme degradation scenarios, accessibility-first rendering contexts, and legacy host-channel clients lacking modern interactive markup support.

This unified constraint model—treating channel byte limits, network degradation, and device resource constraints as inputs to the same allocator—enables continuous operation across fluctuating conditions. Message surfaces lack middleware to detect or respond to network conditions, so this adaptation must occur server-side before the envelope is transmitted.

Because message surfaces provide no middleware for telemetry collection, the system employs several mechanisms to obtain runtime resource data. In one embodiment, the host-channel client embeds a client-computed round-trip-time value in each interaction request sent back to the envelope generator, calculated by measuring the time between sending the request and receiving the prior envelope. In a second embodiment, the host-channel client reads a browser-provided network-quality metric (such as the Network Information API's effectiveType and downlink properties) and includes it in the interaction request. In a third embodiment, the envelope generator infers network quality from the timestamp delta between issuing an envelope and receiving the client's interaction response-if the delta exceeds a threshold, the server infers degraded conditions. In a fourth embodiment, the host-channel client includes device resource hints (battery level, available memory, CPU utilization) obtained from platform APIs (such as the Battery Status API or Performance API) in the interaction request header. Any combination of these mechanisms may be used. The system is not limited to any particular telemetry source.

When conditions improve—as indicated by telemetry returning below threshold levels—the system may restore the byte-budget to its original value B and prompt hydration of previously excluded elements by issuing a refreshed envelope with increased content.

As shown in FIG. 7, the adaptation flow includes the following elements. Budget reduction operation 610 reduces byte-budget from B to degraded value B′. Indicator insertion operation 612 embeds degraded-resource indicator 214a in the envelope. Continuation terminal 614 represents the interactive session continuing at reduced budget B′. Budget maintenance block 616 represents continued operation at full budget B. Budget restoration block 618 restores the byte-budget to its original value B when conditions improve. Constraint-exceeded decision point 620 evaluates whether telemetry indicates resource degradation.

### Additional Surface Constraints

In one embodiment, when device resource telemetry indicates depleted battery, the system applies a media-elimination adaptation in addition to byte-budget reduction: the allocator evicts all image, video, and animation elements from the sliding-window shard and replaces them with text-only placeholder surrogates, reducing both the byte count and the rendering energy required by the host-channel client. In one embodiment, when device resource telemetry indicates limited available memory, the system reduces the structural complexity of the communication envelope—for example, collapsing multi-level nested forms into a sequential single-level flow, reducing the number of simultaneously rendered interactive elements, or deferring non-essential script execution—so that the host-channel client can render the envelope within its available memory. In one embodiment, when device resource telemetry indicates restricted processing capacity, the system pre-renders computationally expensive layout calculations server-side and delivers the result as static markup rather than dynamic templates, reducing the client-side processing burden. These device-specific adaptations operate through the same unified constraint model as network degradation (FIG. 7): the telemetry triggers budget reduction via decision point 620, and the allocator applies the adaptation appropriate to the specific constraint type. The system is not limited to these specific adaptations; any device resource constraint that can be detected via telemetry and addressed by content adaptation is within the scope of the constraint-adaptive architecture.

For sandbox restrictions limiting executable logic—where the host surface prohibits custom JavaScript, rejects external iframes, strips untrusted fonts, forbids WebAssembly, or otherwise restricts the execution environment such that embedded payment SDKs, agent runtimes, or other executable components cannot run within the surface—the system substitutes each restricted executable component with a typed placeholder asset that is itself compliant with the sandbox's declarative-only markup rules. Each such placeholder includes a content-type identifier indicating the category of the restricted executable (for example, a payment-SDK placeholder, an agent-runtime placeholder, a custom-font placeholder, or an iframe placeholder), a static visual surrogate presenting a meaningful representation of the restricted functionality to the recipient (for example, a rendered payment button appearance without the underlying SDK behavior, or a chat-input rendering without the underlying agent runtime), and an authenticated retrieval reference that, upon recipient interaction with the placeholder, causes the host-channel client to establish the secure runtime channel through which the restricted functionality is then performed server-side rather than client-side. In a representative embodiment, an AMP-for-Email surface that forbids custom JavaScript receives an envelope including (i) a declarative-only payment button placeholder in place of an embedded Stripe SDK, (ii) a declarative-only chat-input placeholder in place of an embedded agent runtime, and (iii) declarative-only form controls in place of custom input validation scripts; upon recipient tap of the payment button placeholder, the host-channel client establishes an authenticated HTTPS session to the payment endpoint and the payment operation is performed server-side with the result hydrated back into the message surface, all without any JavaScript ever executing within the sandboxed surface. In another embodiment, an Outlook Actionable Messages surface that strips forms and scripts receives an envelope including typed placeholder assets for each interactive element, with the underlying behavior delegated through Microsoft's POST-based action URLs to server-side handlers. In both embodiments, the typed placeholder asset converts an otherwise-blocked executable component into sandbox-compliant structural data while preserving the workflow continuity the executable would have provided. The typed placeholder asset described herein is a transport-layer architectural substitution for an excluded executable component—it is produced by an envelope-generation step that (i) identifies an intended client-side executable payload, (ii) detects the sandbox constraint, and (iii) replaces the payload with a sandbox-compliant surrogate—and is therefore architecturally distinct from (a) conventional user-interface state placeholders that merely mask asynchronous loading latency (such as the HTML “placeholder” attribute on input elements, or the “placeholder” and “fallback” attributes on AMP-for-Email “amp-list” and similar declarative components), (b) static fallback representations rendered when interactive code fails to execute, and (c) declarative user interface cards natively generated as the intended primary interface without any preceding substitution step (such as Adaptive Cards produced by an agent-orchestration protocol as the sole intended client-side rendering, wherein no executable payload was ever destined for the transport envelope). The system is not limited to the specific sandbox restrictions or placeholder categories described above; any execution-environment restriction imposed by a current or future message surface—including restrictions on scripting languages, runtime frameworks, cryptographic primitives, or any other executable logic—is addressed by substituting the restricted component with an appropriately-typed placeholder asset and deferring the restricted functionality to the secure runtime channel.

In one embodiment, the system further includes a lifecycle controller that transitions each conversation identifier through a finite state machine including at least five states: Active, Frozen, Archived, Deleted, and Legal-Hold. In the Active state, the conversation accepts mutation requests from authorized parties and its associated session state resides in the hot tier of storage system 110. A transition from Active to Frozen is triggered by any of a configurable set of finalization criteria, including without limitation completion of a financial-transaction workflow, expiration of a configured retention window, sender retirement, or receipt of a signed lifecycle-transition request. In the Frozen state, mutation requests are rejected but read access continues; the session state remains in the hot tier but is marked read-only by a FreezeMarker event appended to tamper-evident audit ledger 112. A transition from Frozen to Archived migrates the session state from the hot tier to the cold tier; reads against an archived conversation return from the cold tier with additional hydration latency. A transition to Deleted purges the session-state payload while preserving the cryptographic digest of the session in the ledger (see paragraph [0127]). A transition into Legal-Hold pauses retention-window timers and queues any pending erasure operations with an “erasureQueued” indicator until the hold is cleared (see paragraph [0127]). Transitions are governed by a table-driven policy configuration (for example, a “lifecycle.toml” file specifying per-tenant and per-workflow transition rules), and each transition is appended to the audit ledger as a FreezeMarker event including at least a predecessor-state indicator, a successor-state indicator, the triggering criterion, and a cryptographic signature over the transition metadata.

For attachment and remote-content blocking—where the host surface blocks external asset fetches, strips remote image references, or rejects inline attachments exceeding a per-asset size limit—the system determines, for each asset referenced by the communication envelope, whether the target surface permits retrieval of that asset type. When retrieval is permitted, the asset is referenced via an authenticated URL that the host-channel client fetches through the secure runtime channel. When retrieval is blocked (for example, because the email client proxies or suppresses remote images by default), the system inlines a compressed representation of the asset directly into the envelope payload, subject to the byte-budget B. When the asset is too large to inline within B, the system replaces it with a typed placeholder asset 208 including a condensed surrogate (such as a low-resolution thumbnail or a text description) and a retrieval reference enabling on-demand hydration when the recipient interacts with the placeholder. In a representative embodiment, a product catalog email is sent to a privacy-focused email client that blocks all remote images: the system inlines compressed thumbnails for the three highest-relevance products and replaces the remaining product images with text-description placeholders, ensuring the interactive experience renders without external fetches while maintaining byte-budget compliance. The content-type identifier on a typed placeholder asset (defined at paragraph [0047]) provides a semantic categorical label of the content represented, distinct from MIME types, file extensions, file-system metadata identifiers, and generic structural container designators. The condensed surrogate embedded in the typed placeholder asset is embedded directly within the communication envelope payload as base64-encoded inline media, a perceptual-hash-derived reconstruction, a text summary, an inline vector graphic, or equivalent representation, such that initial rendering of the envelope by the host-channel client requires zero network requests for the surrogate itself and is therefore inherently unaffected by host-client remote-content suppression policies (e.g., Apple Mail Privacy Protection, Gmail image proxying, enterprise-gateway remote-image stripping) and by Content Security Policy directives blocking external asset fetches. The system is not limited to these three asset strategies; any content-blocking policy imposed by a current or future message surface is addressed by selecting the appropriate inlining, placeholder, or retrieval strategy for each asset.

For user-interface element quotas—where the host surface imposes limits on the number, type, or nesting depth of interactive elements—routing engine 106 queries the platform descriptor for the target surface's element limits and adapts the interactive application's structural complexity accordingly. When a product catalog includes more items than the surface's maximum button count (for example, an RCS surface limiting quick-reply buttons to three), the system paginates the catalog into groups of three, with navigation controls enabling the recipient to advance through pages within the message surface. When a multi-level form structure exceeds the surface's maximum nesting depth (for example, an Adaptive Card with a two-level nesting limit), the system flattens the form into a sequential single-level flow, presenting each form section as a separate turn. When the surface imposes a character limit on text fields (for example, Slack limiting message text to 40,000 characters or WhatsApp limiting reply buttons to 20 characters), the system truncates or abbreviates labels to fit within the limit while preserving the interactive reference to the full content. The element-quota adaptation operates at envelope assembly time through routing engine 106 and channel adapter set 105, which apply surface-specific structural transformations before serializing the envelope for delivery. In a further embodiment, when the number of interactive elements would exceed the surface's quota, placeholder engine 103 substitutes multiple discrete elements with a single typed placeholder asset that consolidates them into one addressable structural slot—for example, a “View all options” placeholder replacing eight product-variant buttons where the surface permits only three—with the full element set delivered through the secure runtime channel upon recipient interaction with the placeholder. In this configuration, the typed placeholder asset itself satisfies the UI-element-quota constraint by reducing the count of interactive elements in the initial envelope while preserving workflow continuity through hydration. Unlike conventional overflow user-interface mechanisms-which perform solely visual consolidation, wherein the entire option set remains in the initial message transport envelope and is merely hidden from graphical display—the typed placeholder asset of the present invention performs payload consolidation, structurally removing the consolidated element data from the initial transport envelope such that the sensitive interactive element values are not present in the standard message delivery transport. Representative conventional visual-consolidation mechanisms that ship the full option payload in the initial transport envelope include: (a) the Slack Block Kit “overflow” menu element, which carries the full “options” array of “PlainTextOption” objects in the initial block payload; (b) Microsoft Adaptive Cards mode: “secondary” actions, which push excess actions into a flyout menu while transmitting the full secondary-action JSON; (c) WhatsApp Business Platform list pickers and Apple Messages for Business list pickers, which populate the full list-items array in the initial Graph API or REST payload; (d) GSMA RCS suggested-reply chips, which deliver all “displayText” and postback data in the initial transport envelope; and (e) iOS and Android notification-action overflow behaviors, which either cap action counts or force launch of a separate host application to render additional actions. Further, the content-type identifier on the consolidating placeholder is a semantic category label (per paragraph [0096], non-limiting examples: “product-variants-overflow,” “form-fields-overflow,” “catalog-overflow”) that informs the routing engine and the recipient client of the structural category of interactive elements pending hydration, and is distinct from generic structural container designators used by the prior art which identify only the container shape without conveying the semantic category of the consolidated elements. The system is not limited to the specific quota types or adaptation strategies described above; any structural constraint imposed by a current or future message surface—including constraints not yet defined by surface specifications that have not yet been published—is addressed by querying the platform descriptor and applying the appropriate structural transformation, which may include typed-placeholder consolidation, pagination, flattening, truncation, or any combination thereof.

The typed-placeholder consolidation mechanism of paragraph [0097] is architecturally distinct from the visual-consolidation mechanisms provided natively by conventional messaging surfaces. In a conventional visual-consolidation mechanism—for example, a chat-platform overflow menu element that hides a plurality of action options behind a compact affordance such as an ellipsis marker, a card-schema flyout mode that relocates actions exceeding a primary-action quota into a secondary menu, or a list-picker component that replaces a quick-reply button array with a bulkier list component when the button quota is exceeded—the full data payload for every consolidated interactive element nonetheless travels inline within the initial message envelope through the host platform's standard message delivery transport. The consolidation in such mechanisms is purely a rendering-time layout transformation: the graphical user interface displays a compact surrogate, while every consolidated element's label, value, target endpoint, and associated data resides in the envelope that traverses the commercial carrier infrastructure. The typed placeholder asset of the present invention, by contrast, performs payload consolidation: the plurality of consolidated interactive elements are physically absent from the initial communication envelope that traverses the standard message delivery transport, and the element set is hydrated into the message surface only after the recipient interacts with the placeholder affordance, which triggers retrieval of the element set through the authenticated secure runtime channel established per paragraph [0139]. The initial envelope includes only the typed placeholder asset itself—including a content-type identifier, a condensed surrogate, and an authenticated retrieval reference—and does not contain any of the values, labels, endpoints, or data associated with the consolidated elements. The distinction between visual consolidation and payload consolidation is architecturally significant: visual consolidation leaves all consolidated-element data exposed to the standard transport's intermediate nodes, proxy caches, and platform-level logging infrastructure, while payload consolidation ensures the consolidated-element data traverses only the authenticated secure runtime channel.

The content-type identifier carried by a typed placeholder asset performing user-interface element quota consolidation categorizes the class of interactive elements consolidated into the placeholder's structural slot. Representative content-type identifiers include, without limitation, “product-variants-overflow” identifying that the consolidated elements are product-variant selection buttons, “form-fields-overflow” identifying that the consolidated elements are form input controls, “catalog-choices-overflow” identifying that the consolidated elements are catalog item selections, “appointment-slots-overflow” identifying that the consolidated elements are appointment time-slot buttons, and “payment-method-overflow” identifying that the consolidated elements are payment-method selection buttons. The semantic categorization provided by the content-type identifier enables the host-channel client's runtime to structurally understand the class of user-interface component that will be instantiated upon hydration, prior to receiving any of the specific values, without exposing the specific values (such as product SKUs, patient-identifier fields, appointment times, or payment-method tokens) to the standard message delivery transport. Generic affordances found in conventional messaging surfaces—for example, a generic “more options” button, a platform-native overflow-menu element rendered as a generic ellipsis, or an untyped “load more” control—lack this semantic content-type categorization; such generic affordances neither identify the class of consolidated elements nor convey to the runtime what structural UI should be prepared for hydration, and therefore cannot serve as typed placeholder assets within the meaning of this disclosure.

The authenticated secure runtime channel through which the consolidated element set is hydrated operates out-of-band from the host platform's standard message delivery transport. That is, the channel operates independently of the message-delivery infrastructure that carried the initial communication envelope—including any simple mail transfer protocol transport in the case of electronic mail, any push-notification delivery service in the case of push notifications (such as the Apple Push Notification service or Firebase Cloud Messaging), any carrier-operated rich-communication-services network in the case of RCS messaging, and any platform-operated bot-framework webhook or graph application-programming-interface infrastructure in the case of chat-platform or collaboration-platform surfaces. The out-of-band character of the secure runtime channel ensures that the host platform's standard transport infrastructure—which may cache, log, replicate, or inspect message payloads—does not observe, store, or forward the values of the consolidated interactive elements hydrated through the secure channel. This out-of-band property is preserved even where the secure runtime channel terminates at the same host-channel client that rendered the initial envelope: the channel uses authenticated transport (for example, an authenticated hypertext transfer protocol secure request with origin verification, a mutually-authenticated transport-layer security session, or a functionally equivalent authenticated transport) directly between the host-channel client and envelope generator 101, not through the host platform's general-purpose message delivery rails.

For latency service-level agreements—where the host surface requires a response within a platform-specific time window (for example, approximately three seconds for slash-command surfaces, or ten to fifteen seconds for action-card bot interactions)—the system assembles and returns a skeletal response within the timeout window. The skeletal response is composed of typed placeholder assets: each interactive element that cannot be fully assembled within the latency budget is represented by a typed placeholder asset including a content-type identifier (for example, “diagnostic-form”, “transaction-summary”, “appointment-availability”), a condensed surrogate presenting the element's role to the recipient, and an authenticated retrieval reference enabling hydration of the full element once assembly completes. The full interactive content is then assembled asynchronously and delivered as a refreshed envelope in a subsequent turn, using the same envelope-refresh mechanism that supports multi-turn workflows (FIG. 12). In this configuration, the typed placeholder assets satisfy the latency constraint by permitting the initial envelope to be assembled and transmitted within the timeout window, with the full content hydrated asynchronously without blocking the initial response. In a representative embodiment, a customer-service bot on a slash-command surface receives a support inquiry; the system returns a skeletal acknowledgment (“Processing your request . . . ”) within two seconds, then delivers the full diagnostic form with customer history as a follow-up message within five seconds—the recipient perceives a single fluid interaction despite the internal time-split. In each such latency embodiment, the plurality of typed placeholder assets includes two or more placeholder assets, each individually carrying its own content-type identifier (for example, one typed placeholder designating “diagnostic-form” and another designating “transaction-summary”) and its own authenticated retrieval reference, thereby permitting granular per-component asynchronous hydration through the secure runtime channel, as distinguished from deferred-response patterns taught by the prior art that return either an unstructured text acknowledgment (for example, Slack slash-command “response_url” accompanied by an empty or flat-string initial response), a single Boolean user-interface-state trigger (for example, Discord's Type-5 “DEFERRED_CHANNEL_MESSAGE_WITH_SOURCE” callback whose payload is prohibited by the Discord Interactions API from carrying structured metadata other than an EPHEMERAL flag), or a single monolithic envelope-level content-type declaration applied uniformly to an entire response payload (for example, a Microsoft Teams Adaptive Card declaring “contentType”: “application/vnd.microsoft.card.adaptive” at the card wrapper level with whole-card refresh through the Bot Framework webhook). The system is not limited to any particular latency threshold; the timeout window is derived from the platform descriptor and may vary by surface type, surface version, or operator configuration.

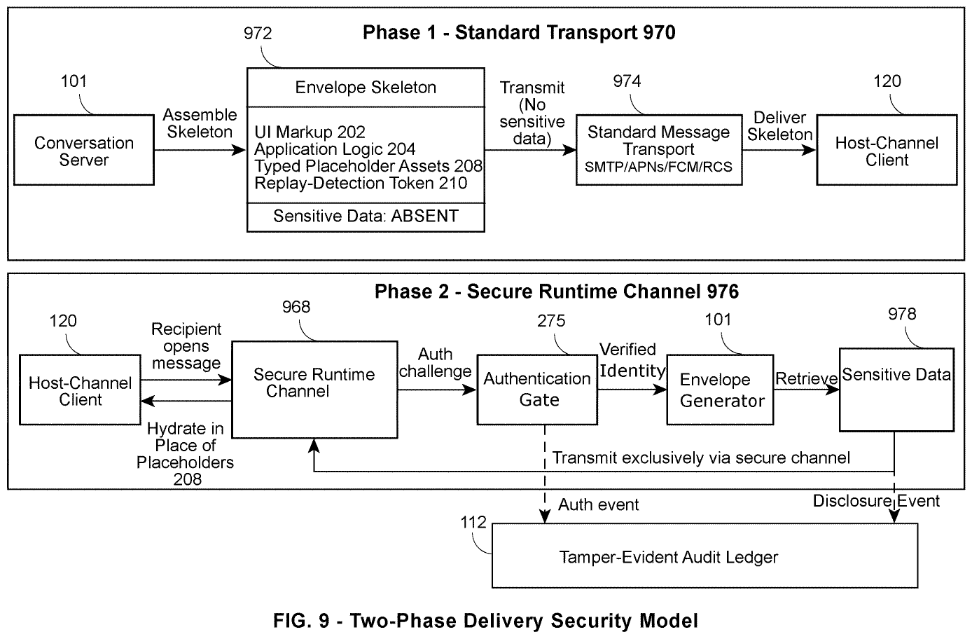

For privacy gates that suppress tracking mechanisms—where the host surface proxies remote content, blocks tracking pixels, strips query-string parameters from URLs, or prevents JavaScript-based telemetry collection—the system provides attribution and interaction telemetry through the tamper-evident audit ledger 112 and the telemetry header 216 embedded in the communication envelope, rather than through external tracking infrastructure. Each interaction event (impression, tap, form submission, payment, navigation) is recorded as a hash-linked entry in the audit ledger, providing deterministic attribution that does not depend on cookies, tracking pixels, browser fingerprinting, or any mechanism that privacy-aware surfaces block. Representative privacy gates within the scope of this disclosure include, without limitation, Apple Mail Privacy Protection, Gmail Image Proxy, Microsoft Outlook link-tracking protection, WebKit Intelligent Tracking Prevention, Firefox Enhanced Tracking Protection, enterprise gateway privacy policies such as those enforced by Microsoft Purview Data Loss Prevention and Google Cloud Sensitive Data Protection, and any current or future tracking-suppression policy imposed by a message surface, privacy regulation such as GDPR or CCPA, or enterprise privacy framework. In a representative embodiment, an advertising creative delivered via a privacy-focused email client that blocks all remote tracking receives interaction telemetry exclusively through the secure runtime channel: each product view, cart addition, and purchase completion is recorded in the audit ledger with cryptographic integrity, enabling the advertiser to attribute conversions without any third-party tracking infrastructure. In a further embodiment, typed placeholder assets satisfy the privacy-gate constraint directly: each remote-image reference that the privacy gate would otherwise suppress is substituted with a typed placeholder asset whose authenticated retrieval reference hydrates through the secure runtime channel rather than through a tracked URL, and each otherwise-trackable interactive element is substituted with a typed placeholder whose interaction is reported into the tamper-evident audit ledger rather than through suppressed telemetry. The authenticated retrieval reference of each such typed placeholder is cryptographically bound to at least the conversation identifier, a platform identifier, and a recipient identifier in the manner described at paragraphs [0071]-[0077] and FIG. 5, and is resolvable only through the secure runtime channel established at envelope render time as described at paragraphs [0134]-[0141] and FIG. 9. Because the authenticated retrieval reference is resolvable only through the recipient-initiated secure runtime channel—and not through a remote-URL fetch of the form that privacy-gate proxies intercept and eagerly execute—the privacy-gate proxy ignores the typed placeholder during transport and pre-render inspection, with the result that interaction telemetry is generated only during the deferred hydration phase following recipient render, rather than during eager-fetch pre-render inspection by the proxy. In this configuration, the typed placeholder asset itself satisfies the privacy-gate constraint by routing every interaction signal through the secure runtime channel and the audit ledger—the only paths that privacy-focused surfaces do not suppress. The system is not limited to the specific privacy-gate mechanisms described above; any tracking-suppression policy imposed by a current or future message surface or privacy regulation is addressed by routing telemetry through the audit ledger and secure runtime channel rather than through the suppressed mechanism.

The typed placeholder asset of paragraph [0102] differs structurally from gateway-level tracker-removal mechanisms that operate at an intermediate receiving gateway by identifying and replacing tracking code in an email payload with untrackable alternative content before the email is delivered to the recipient mailbox. Gateway-level tracker-removal mechanisms operate at the recipient's protective gateway and are designed to destroy the sender's attribution entirely—the alternative content that replaces the detected tracking code carries no information back to the sender. By contrast, the typed placeholder asset described at paragraph [0102] is inserted into the communication envelope at the sending system during envelope assembly by routing engine 106, not at a recipient gateway after transmission, and is specifically designed to preserve sender attribution through the authenticated retrieval reference and the tamper-evident audit ledger 112 while simultaneously complying with the privacy-gate suppression policy. The authenticated retrieval reference is not itself a trackable payload that a privacy-focused gateway would target; rather, it is an inert cryptographic binding, resolvable only through the recipient-initiated secure runtime channel, that carries no information value to pre-render proxies or gateway scanners. The typed placeholder asset is accordingly architecturally distinct from both (i) content-replacement mechanisms that destroy tracking, and (ii) conventional tracking pixels or beacons that attempt to transmit recipient metadata through the suppressed mechanism.

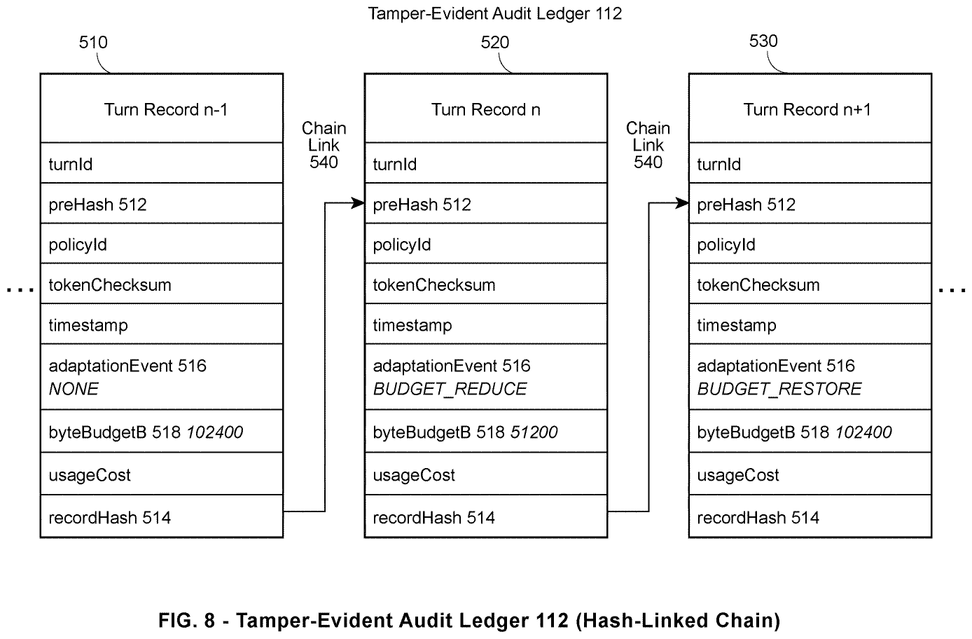

The typed placeholder asset of paragraph [0102] further differs structurally from static content-redaction placeholders produced by natural-language-processing redaction pipelines, data-loss-prevention engines, and enterprise sensitivity-label services that substitute detected sensitive values in message payloads with typed literal tokens of the form “<EMAIL_ADDRESS>”, “<PHONE_NUMBER>”, “<PERSON_NAME>”, “[CreditCard]”, “[SSN]”, or similar class-labeled masks. Such prior-art static placeholders are terminal redaction outputs: once substituted, the masked token has no further runtime behavior, cannot be resolved or rehydrated by the recipient's client, and carries no mechanism for reporting recipient interaction events. Prior-art static placeholders accordingly serve a unidirectional confidentiality purpose—preventing sensitive data from appearing in the sanitized payload—and do not participate in any telemetry, attribution, or runtime-channel function. By contrast, the typed placeholder asset described at paragraph [0102] is an active runtime routing node including the authenticated retrieval reference described above, and, upon recipient interaction with the placeholder-bearing element, causes the host-channel client to establish the secure runtime channel, retrieve the hydrated element through that channel, and record the interaction event in the tamper-evident audit ledger 112 as described at paragraphs [0106]-[0108] and FIG. 8. The typed placeholder asset accordingly performs a dual function—serving the privacy-gate constraint through routing-based tracking-suppression compliance and serving the transport-security constraint through envelope sanitization—within a single structural component, a combination that static-placeholder redaction pipelines, data-loss-prevention engines, and enterprise sensitivity-label services do not perform.

In connection with each of the constraint-satisfaction embodiments described in paragraphs [0094] through [0104], the authenticated retrieval reference embedded in the typed placeholder asset is cryptographically bound to one or more envelope-level identifiers selected from: an envelope nonce unique to the initial message delivery, a conversation identifier unique to the sender-recipient pair, a platform identifier unique to the host-channel client, a recipient identifier unique to the addressed recipient, and a turn identifier unique to the current conversational turn. In a preferred embodiment, the authenticated retrieval reference includes, or references, an ephemeral token signed or MAC-protected using a shared session key such that the token cannot be replayed across envelopes, conversations, platforms, or recipients; the secure runtime channel validates the binding before hydrating the consolidated, excluded, or deferred content element; and a retrieval reference presented from outside the bound context is rejected. The cryptographic binding is established at envelope-generation time within control pipeline 104 and verified at the secure runtime channel endpoint independently of any host-platform-native webhook infrastructure. This asset-level cryptographic binding distinguishes the claimed secure runtime channel from (a) generic hypertext-transfer-protocol URLs or unauthenticated webhook drop-boxes that any party in possession of the link can invoke (such as the 30-minute unauthenticated Slack “response_url”), (b) ephemeral bearer tokens conveyed through a host platform's generic webhook infrastructure without envelope-level or recipient-level binding (such as Discord's 15-minute “interaction_token” used in combination with an HTTP PATCH request against a generic webhook endpoint path parameterized by an application identifier and the interaction token), (c) generic authenticated application programming interface invocations that secure the channel transit without binding to the specific envelope, conversation, or recipient (such as OAuth 2.0 bearer-token exchanges, Amazon Web Services API Gateway identity-and-access-management invocations, or Bot Framework webhook calls carrying CARD-UPDATE-IN-BODY headers), and (d) static hypertext-transfer-protocol links embedded in secure-email notifications that require the recipient to authenticate through a separate web portal outside the message surface. The cryptographic binding of the authenticated retrieval reference is the mechanism by which the typed placeholder asset's dual function of constraint satisfaction and transport-security enforcement is architecturally coupled: because the retrieval reference is envelope-bound, the sensitive content element is structurally prevented from being delivered through any channel other than the authenticated secure runtime channel, even if the initial communication envelope is intercepted, proxied, pre-fetched, or replayed. The system is not limited to any particular cryptographic primitive, token format, or binding algorithm; any mechanism that provides envelope-to-retrieval-reference cryptographic coupling sufficient to prevent replay and to bind hydration to the specific recipient, conversation, and host-channel client is within the scope of the invention.

### Tamper-Evident Audit Ledger

FIG. 8 is a block diagram illustrating tamper-evident audit ledger 112 as a chain of three representative hash-linked turn records 510, 520, 530. Referring to FIG. 8, tamper-evident audit ledger 112 records each conversational turn, policy decision, constraint-adaptation event, and storage migration as a turn record. Each turn record includes a cryptographic hash of the preceding record, forming a hash-linked chain such that alteration of any record is detectable in O(1) time. This enables regulated senders to prove the complete chain of custody for every interaction conducted within the message surface. As shown in FIG. 8, three representative turn records 510, 520, 530 illustrate the hash-linked chain and the constraint-adaptation sequence: turn record 510 (denoted Turn Record n−1) shows adaptationEvent=NONE with byteBudgetB=102400, indicating normal operation at full byte-budget; turn record 520 (denoted Turn Record n) shows adaptationEvent=BUDGET_REDUCE with byteBudgetB=51200, indicating that runtime telemetry triggered a byte-budget reduction during that turn; and turn record 530 (denoted Turn Record n+1) shows adaptationEvent=BUDGET_RESTORE with byteBudgetB=102400, indicating that conditions improved and the budget was restored. The recordHash of turn record 510 (0×7B2 . . . ) appears as the prevHash of turn record 520, and the recordHash of turn record 520 (0×E4C . . . ) appears as the prevHash of turn record 530, forming the hash-linked chain via hash chain links 540. If any record were altered—for example, if an adversary attempted to retroactively change the byteBudgetB value in turn record 520—the recordHash of that record would change, breaking the prevHash link in turn record 530 and rendering the chain invalid.

In one embodiment, each ledger entry includes: turn identifier, previous-record hash, policy identifier, replay-token checksum, timestamp, constraint-adaptation event, and channel byte-budget in effect. The constraint-adaptation event field records whether the byte-budget was maintained, reduced, or restored during that turn—for example, “NONE” when the budget is unchanged, “BUDGET_REDUCE” when telemetry triggers a reduction from B to B′, or “BUDGET_RESTORE” when conditions improve and the budget is restored to B. The channel byte-budget field records the numerical value of B (or B′) in effect at the time the turn was recorded. When the conversation includes an economic transaction, agent-mediated negotiation, or any other interaction having a measurable economic outcome, each ledger entry corresponding to such an interaction further includes at least one of (i) a per-turn usage-cost field recording the cost incurred for the corresponding interaction turn (for example, an agent invocation cost, a tool-call cost, or a token-consumption cost), (ii) a success-fee field recording a fee tied to a measurable outcome of the interaction (for example, a completed purchase, a resolved support ticket, or a signed document), and (iii) a cumulative-cost or cumulative-fee field recording the aggregate cost or fee across the conversation. The economic-transaction fields are bound to the same hash-linked record as the conversational state and constraint-adaptation event, enabling regulated billing reconciliation and downstream economic settlement without requiring a separate billing infrastructure or trusting any single party's accounting.

These constraint-specific fields distinguish tamper-evident audit ledger 112 from general-purpose hash-chain structures. While hash-linked append-only ledgers are known in the art for per-file-block integrity verification, ledger 112 records per-conversational-turn policy decisions, constraint-adaptation events, and byte-budget values specific to the context of resource-constrained message surface interactions. An auditor reviewing the ledger can determine not only what content was delivered in each turn but also what byte-budget was in effect and whether the system adapted the budget in response to runtime conditions.

As shown in FIG. 8, turn records 510, 520, 530 each represent a single conversational turn's audit entry. Previous-record hash field 512 (prevHash) stores the cryptographic hash of the preceding turn record. Record hash field 514 (recordHash) stores the cryptographic hash of the current turn record. Constraint-adaptation event field 516 (adaptationEvent) records whether the byte-budget was maintained, reduced, or restored. Byte-budget field 518 (byteBudgetB) records the numerical value of the channel byte-budget in effect. Hash chain links 540 connect consecutive turn records through the prevHash/recordHash relationship.

### Audit Event Type Definitions

Tamper-evident audit ledger 112 records a plurality of named event types in addition to the per-turn record described above. Each named event is appended as a hash-linked entry in the same chain and carries event-specific metadata sufficient to reconstruct the originating action without requiring access to the underlying conversational data. The named event types described in this specification include the following.

A FreezeMarker event is appended to ledger 112 each time a lifecycle controller transitions a conversation identifier into the frozen state, the archived state, the deleted state, or the legal-hold state. The FreezeMarker event carries at least a predecessor-state indicator, a successor-state indicator, the originating trigger (selected from completion of a financial transaction workflow, expiration of a configured retention window, sender retirement, or a signed lifecycle-transition request), an authority identifier, and a cryptographic signature over the transition metadata.

An ErasureEvent is appended to ledger 112 when a data-subject erasure request results in cryptographic-tombstone overwrite of a cold-tier object. The ErasureEvent carries at least a conversation identifier, an item identifier, a hash of the deterministic filler pattern written over the original payload, an erasure timestamp, and an indicator that the original payload length L has been preserved.

A KeyRotate event is appended to ledger 112 each time a signing or encryption key managed by the hardware security module cluster is rotated on its configured schedule. The KeyRotate event carries at least a predecessor-key identifier, a successor-key identifier, a rotation timestamp, and the cluster topology in effect at rotation.

A DigestChange event is appended to ledger 112 each time the cryptographic-agility framework completes a transition from a predecessor signature or digest algorithm to a successor algorithm. The DigestChange event carries at least the predecessor-algorithm identifier, the successor-algorithm identifier, the transition-completion timestamp, and a cryptographic hash of the operator-approved transition policy artifact that authorized the transition, the entire DigestChange event being chained into ledger 112 such that retroactive forgery of the cryptographic-transition timeline is detectable.

A CanaryAdvance event is appended to ledger 112 each time a canary-deployment epoch is promoted to a higher inclusion-range upper bound during a cryptographic-agility rollout. The CanaryAdvance event carries at least a predecessor-epoch identifier, a successor-epoch identifier, the inclusion-range upper bound for each epoch, the canary-selector formula in effect, and the telemetry-derived metrics that authorized advancement.

A CAS_FAILURE event is appended to ledger 112 each time a compare-and-swap adjudication rejects a proposed mutation because the field set proposed for mutation intersects with a field set already mutated by a concurrent interaction. The CAS_FAILURE event carries at least the rejected-sequence indicator, a description of the field-set intersection, a recipient identifier, and the back-off retry schedule emitted to the proposing recipient.

A CAS_REBASE event is appended to ledger 112 each time a compare-and-swap adjudication automatically merges two non-conflicting concurrent mutations through a semantic-rebase merge operation. The CAS_REBASE event carries at least an identifier of the disjoint-field set merged, a predecessor-sequence indicator, a successor-sequence indicator, and a cryptographic digest computed over the merged conversational state.

A SaltRotate event is appended to ledger 112 each time the tenant-specific salt used by replay-token service 114 or by the deterministic-pseudonymisation function is rotated on the regulatory cadence dictated by the active compliance profile. The SaltRotate event carries at least a digest of the predecessor salt, a digest of the successor salt, a rotation timestamp, and the regulatory cadence identifier (for example, GDPR lawful-basis cycle, HIPAA retention-audit cycle, PCI DSS cryptographic-period cycle, or FINRA communication-retention cycle), without writing either salt value itself to the ledger.

A DeferredErasureEvent is appended to ledger 112 each time a legal-hold release results in batch processing of erasure requests that had been queued during the hold. The DeferredErasureEvent carries at least the legal-hold-clear timestamp, a count of deferred erasures processed in the batch, and a cumulative cryptographic digest computed over the ordered set of erasure-queue entries flushed in the batch, such that an auditor can verify the complete content of the processed queue without per-erasure ledger entries.

A ChunkDeliveryFailure event is appended to ledger 112 each time a multi-part envelope chunk fails hash verification after the configured maximum retry count and is diverted to the dead-letter queue. The ChunkDeliveryFailure event carries at least an envelope identifier, a chunk identifier, a total-chunks count for the envelope, the retry attempts performed, and a final-failure timestamp, providing the audit basis for delivery-completeness analysis under the streamed-chunk delivery mechanism of paragraph [0087].

### Multi-Surface Formatting

Routing engine 106 automatically formats the communication envelope into a surface-native representation compatible with the detected message surface. A single conversational application is deliverable across heterogeneous message surfaces—including AMP for Email markup, Adaptive Card JSON, RCS AgentMessage format, push notification payloads, and chat-platform structured messages—without requiring surface-specific application logic.

Routing engine 106 discovers serializer plug-ins through a table-driven configuration. A new message surface can be supported by registering a new serializer without modifying the core envelope assembly logic. Channel adapter set 105 receives the formatted envelope from routing engine 106 and serializes it for the active transport—including Web Push, Apple Push Notification Service, Firebase Cloud Messaging, WebSocket, MQTT, RCS AgentEvent, SMTP for email, or any functionally equivalent transport. As shown in FIG. 1, channel adapter set 105 is positioned at the left of the gating row, receiving the formatted envelope from routing engine 106 and delivering it upward to host-channel client 120, completing the U-shaped main flow. Each adapter in channel adapter set 105 implements the transport-specific framing, authentication headers, and delivery semantics required by its respective channel, enabling a single formatted envelope to be transmitted through any supported transport without modification to the upstream pipeline components. In resolving the sandbox-restriction constraint, routing engine 106 applies a surface-specific adaptation strategy determined by the platform descriptor: for surfaces that prohibit arbitrary JavaScript execution (such as AMP for Email), the serializer transforms client-side interactive logic into declarative markup constructs (amp-form, amp-bind, amp-list) combined with server-side state management through the secure runtime channel—for example, converting a client-side payment SDK call into an amp-form POST that invokes a server-mediated tokenization endpoint within an isolated iframe; for surfaces that restrict executable logic to a predefined set of UI components (such as Adaptive Cards), the serializer maps interactive workflow steps to the surface's native action schema (Action.Execute, Action.Submit) with server-side processing of each action's payload; and for surfaces with custom sandbox models, the serializer consults the platform descriptor's permitted-operations manifest and adapts the application logic accordingly. This table-driven sandbox adaptation operates transparently to the upstream envelope assembly—the allocator, placeholder engine, and control pipeline produce surface-agnostic interactive content, and routing engine 106's serializer plug-in transforms it into the sandbox-compliant form for the target surface.

### Storage System

Storage system 110 manages conversational state across multiple tiers: the message-surface tier (client surface 110a) handles on-device content within byte-budget constraints; the hot tier (hot queue 110b) maintains recent state with low-latency access for active conversations; the cold tier (cold store 110c) stores aged state elements with reduced cost; and the migration index (110d) tracks elements scheduled for relocation between the hot tier and the cold tier. A migration process automatically relocates elements from hot queue 110b to cold store 110c based on a retention interval while replacing each migrated element with a retrievable reference that preserves the element's position in audit ledger 112 and enables on-demand hydration without breaking hash-chain integrity.

In the claims and throughout this specification, the term “hot tier” refers to hot queue 110b, the term “cold tier” refers to cold store 110c, and the term “message-surface tier” refers to client surface 110a. In one embodiment, hot queue 110b is implemented as a low-latency key-value database keyed by conversation identifier with median read latency of approximately five milliseconds or less. Each record in hot queue 110b carries a sixty-four-byte header including at least a digest of the record contents, a content-type indicator, a creation timestamp, and a pin-flag indicating whether the record is subject to unconditional retention. Cold store 110c is a versioned, immutable object store in which each object is encrypted under a tier-specific symmetric key (for example, AES-256-GCM) with per-object key rotation on a configurable schedule (for example, every ninety days). Migration index 110d records, for each element relocated between tiers, at least the element identifier, the predecessor tier, the successor tier, the migration timestamp, and a MigrationEvent digest appended to tamper-evident audit ledger 112. The retention interval R that drives hot-to-cold migration is configurable per tenant and per conversation category (for example, thirty days as a default for general conversations, with longer defaults for regulated categories). The specific latencies, encryption algorithms, key rotation periods, and retention intervals recited in this paragraph are illustrative embodiments; the system is not limited to any particular value.

In one embodiment, when an element is migrated from the hot tier to the cold tier, the migrated element is replaced in the message-surface tier and within any active sliding-window shard with a small-byte tombstone (for example, a serialized record of approximately 200 bytes or fewer) that includes at least an element identifier and a pre-signed locator. The pre-signed locator is a cryptographically signed retrieval reference valid for a configurable expiration period (for example, the surface's refresh timeout or a per-tenant retention window) that authorizes the host-channel client, upon recipient interaction with the placeholder representing the migrated element, to retrieve the full element from the cold tier through the secure runtime channel without an additional authentication round-trip. The pre-signed locator and the small-byte tombstone together preserve the placeholder's structural position within the byte-budget-constrained envelope while delegating actual element retrieval to a separately authorized cold-tier read; the locator's expiration enforces a temporal bound on the authorization, and any expired locator triggers re-issuance through envelope generator 101 before retrieval is permitted. This pre-signed locator mechanism is structurally distinct from the cryptographic-tombstone erasure record described in paragraph [0127], which records the post-erasure state of an erased object, whereas the pre-signed locator and small-byte tombstone described in this paragraph operate on a live, retrievable element that has been migrated to the cold tier.

When a data-subject erasure request is received, storage system 110 overwrites the relevant elements with cryptographic tombstones while leaving shard pointers and hash links intact, satisfying privacy regulations without corrupting the audit chain.

In one embodiment, the cryptographic-tombstone procedure executes the following steps upon receipt of a data-subject erasure request: (a) locate the cold-tier object corresponding to the subject by its stored cryptographic digest; (b) overwrite the encrypted payload of the object with a deterministic filler pattern of length equal to the original payload length L—for example, the two-byte pattern “0×CD1E” repeated L/2 times; (c) flip the object's “erased” flag to true while preserving the digest field unchanged; (d) append to audit ledger 112 an ErasureEvent including at least a conversation identifier, an item identifier, a hash of the filler, and a timestamp. The deterministic-filler pattern ensures that the erased object occupies the same byte footprint as the original, preserving the integrity of cold-store offsets and index structures without requiring reorganization. Preserving the digest field enables subsequent audit queries to prove that an object of a specific digest was erased at a specific time, which is a cryptographic proof of compliance with data-subject erasure obligations. The two-byte sequence “0×CD1E” is selected as the deterministic-filler repeat unit in preference to single-byte patterns (for example, “0×00” zero-padding or “0×FF”) because the latter single-byte patterns are structurally indistinguishable from storage-medium sector failures, zero-padded storage allocations, or firmware-reported uninitialized regions. A repeating two-byte non-zero non-uniform hexadecimal pattern unambiguously signals an intentional cryptographic-tombstone overwrite—distinct from hardware failure modes or default zero-initialization—and thereby preserves evidentiary integrity when the tombstone record is later audited for regulatory compliance. If a legal hold is active on the conversation including the erasure target, the erasure operation is deferred: the request is queued with an “erasureQueued=true” indicator and a LEGAL_HOLD_SET event is referenced in the queue record. Upon clearing of the legal hold (LEGAL_HOLD_CLEAR event), the system processes the deferred-erasure queue as a singular atomic batch operation, producing a single DeferredErasureEvent appended to the audit ledger that includes at least the legal-hold-clear timestamp, a count of deferred erasures processed in the batch, and a cumulative cryptographic digest computed over the ordered set of erasure-queue entries flushed in the batch—the batched representation documents the compliance latency attributable to the hold while producing exactly one audit-ledger entry per hold-clear event regardless of the number of deferred erasures aggregated therein, and the cumulative digest enables a later auditor to verify the complete content of the processed queue without requiring per-erasure ledger entries that would inflate the ledger's size for long-running holds. Signed legal-hold endpoints (for example, “POST/conversations/{id}/legal-hold” and “DELETE/conversations/{id}/legal-hold”, each authenticated with a JSON Web Signature executed using an asymmetric elliptic-curve signature algorithm such as ES384, and bearing at least an issuer claim identifying a requesting legal authority and a subject claim identifying the conversation identifier subject to the hold) enable authorized parties to set and clear holds while generating audit-ledger entries including at least the legal-hold authority identifier, the requested action, and a cryptographic signature over the request.

### Telemetry and Observability

In one embodiment, telemetry engine 118 collects interaction events from each conversational turn—including screen navigation, element selection, form submissions, payment events, and timing metrics—compresses them into a delta frame representing only state changes since the prior turn, and transmits the compressed telemetry within the communication envelope or as a companion telemetry-only envelope without consuming the interactive application's byte-budget allocation. In a preferred embodiment, the telemetry data is encrypted using the same session key as the replay-detection token, ensuring that telemetry is protected by the same trust boundary as the conversational data. The compressed telemetry is ingested by a server-side aggregation pipeline that produces streaming windowed metrics (opens, interactions, conversions, latency percentiles) across configurable dimensions (conversation, campaign, time window). In one embodiment, the aggregated metrics feed back to the constraint-adaptive system as a real-time optimization signal—for example, detecting that a particular surface type consistently produces high placeholder-hydration failure rates and proactively adjusting the content selection strategy for that surface.

In one embodiment, the telemetry engine includes a ring buffer of twenty to fifty events in which each event is represented as a delta-encoded frame (ΔEv) recording only the state changes since the immediately preceding event. The ring buffer is periodically compressed (for example, using Brotli) and encrypted (for example, AES-GCM with the session key) before being transmitted either embedded in the communication envelope's telemetry header or as a companion telemetry-only envelope separate from the interactive envelope. A streaming aggregator consumes the received telemetry across all active conversations and produces materialized views over one-minute tumbling windows, which are served to operator dashboards via a GraphQL endpoint and to real-time subscribers via a WebSocket feed with staleness bounded to approximately three seconds. A real-time optimizer computes five-second moving averages of latency, packet loss, and placeholder-hydration-failure rates across the materialized views and feeds back format-hint signals to budget-aware allocator 102 within a feedback-loop latency bound of approximately two hundred fifty milliseconds. Reference performance envelopes observed in representative deployments include approximately one hundred fifty thousand events per second and approximately twelve terabytes of raw telemetry per day; the system is not limited to any particular performance envelope.

### Concurrency Control

In one embodiment, concurrency control over the conversational state carried by a communication envelope is enforced by a compare-and-swap (CAS) adjudication executed by envelope generator 101 against a monotonically increasing turn-sequence number (turnSeq) maintained per conversation identifier. Upon receipt of a recipient interaction or autonomous-agent action that proposes to mutate the authoritative conversational state, envelope generator 101 attempts an atomic CAS against the stored turnSeq: on success the mutation is applied and a CAS_SUCCESS entry is appended to tamper-evident audit ledger 112. On failure, envelope generator 101 inspects the set of fields mutated by the proposing interaction against the set of fields mutated by the concurrent interaction having caused the authoritative sequence to advance; when the two field sets are disjoint—that is, the proposing interaction does not touch any field already mutated by the concurrent interaction—envelope generator 101 performs a semantic-rebase merge operation that automatically combines the two non-conflicting deltas, applies the merged state, and appends a CAS_REBASE event to audit ledger 112 including at least an identifier of the disjoint-field set, a predecessor-sequence indicator, a successor-sequence indicator, and a cryptographic digest over the merged conversational state. When the field sets intersect, the mutation is rejected and envelope generator 101 emits a structured HTTP 409 Conflict response including at least (i) a retry-after indicator expressed as a back-off schedule in units of time, (ii) a current-sequence indicator conveying the authoritative turnSeq at the time of rejection, and (iii) a condensed surrogate of the authoritative conversational state sized by budget-aware allocator 102 such that the entire structured conflict response does not exceed a byte-budget derived from the remaining byte-budget of the resource-constrained electronic message surface. The condensed surrogate is produced by reducing an authoritative-state representation to a surrogate representation—for example, retaining only the minimum field-key and field-digest pairs required for the host-channel client to re-render the surface consistently—such that no rejection payload causes the recipient message surface to exceed its surface-ceiling byte limit. Each rejection is appended to audit ledger 112 as a CAS_FAILURE event including at least the rejected-sequence indicator, the field-set intersection description, a recipient identifier, and a retry-schedule emitted. The CAS_FAILURE and CAS_REBASE events are structurally distinct entries enabling the audit ledger to reconstruct an immutable chronological record of automatic semantic-rebase outcomes versus irreconcilable-conflict outcomes across a plurality of recipient-initiated and autonomous-agent-initiated interactions operating against a shared authoritative conversational state. Because autonomous agents operating through an agent-orchestration bridge that maintains stateful session context with the message surface and human recipients operating through the resource-constrained electronic message surface (using the multi-recipient envelope-assembly mechanisms described in paragraphs [0071]-[0077]) submit their interactions through the same turn-sequence-adjudicated path, the audit ledger constructs a unified, chronologically precise reconstruction of all competing multi-party negotiations regardless of whether the interacting actor was a human recipient or an autonomous software agent. The CAS-adjudicated turn-sequence architecture provides the concrete algorithmic mechanism by which concurrent recipient-initiated and agent-initiated interactions are ordered without data corruption. The semantic-rebase merge operation is distinct from operational-transformation schemes that asynchronously merge all concurrent operations without issuing conflict rejections, and from standard HTTP optimistic-concurrency implementations that return opaque 409 or 412 error responses whose serialization is unconstrained by the byte-budget of the downstream rendering surface.

In one embodiment, the conditions under which a CAS_REBASE merge is attempted versus rejected are determined by an operational definition of “disjoint field set.” For purposes of CAS adjudication, two concurrent interactions touch a disjoint field set when, with respect to the authoritative conversational state representation, the JSON Pointer paths (RFC 6901) addressed by the proposing interaction's mutation delta do not intersect with the JSON Pointer paths addressed by the previously committed concurrent interaction's mutation delta. The disjointness test is computed by extracting the ordered set of pointer paths from each interaction's delta, sorting each set lexicographically, and applying a linear-scan intersection test; the operation completes in O(n+m) time where n and m are the cardinalities of the two pointer sets. When the intersection set is empty, envelope generator 101 attempts the semantic-rebase merge described in paragraph [0130]; when the intersection set is non-empty, the rebase is rejected and the CAS_FAILURE event is appended. A pointer addressing a parent of a path mutated by a concurrent interaction is treated as intersecting under the standard JSON Pointer subsumption rule—for example, a mutation that replaces the entire “/cart” object intersects with a mutation that updates “/cart/items/0/qty”. This pointer-based disjointness criterion is the operational basis on which CAS_REBASE is reliably attempted only for genuinely independent concurrent updates, and is the criterion enforced by envelope generator 101's CAS adjudication path.

In one embodiment, the merged conversational state produced by the CAS_REBASE operation is constructed by a deterministic field-by-field merge algorithm. The merge algorithm proceeds as follows: at step (a), the authoritative conversational state at the predecessor turnSeq is loaded into a working buffer; at step (b), the mutation delta from the previously committed concurrent interaction is applied to the working buffer in field-set order; at step (c), the mutation delta from the proposing interaction is applied to the working buffer; at step (d), the cryptographic digest of the working buffer is computed using the system digest algorithm (for example, SHA-256); at step (e), the working buffer becomes the new authoritative conversational state at the successor turnSeq, and the digest is recorded in the CAS_REBASE event appended to audit ledger 112. Because steps (b) and (c) operate on disjoint field sets as established by the disjointness test of paragraph [0131], the order in which the two deltas are applied does not affect the resulting state, and the merge algorithm is therefore order-independent. If during steps (b) or (c) a field-write encounters a conflict that was not surfaced by the disjointness test (for example, due to a race condition in which a concurrent third interaction commits between the disjointness test and the field-write), the merge is aborted, the working buffer is discarded, and a CAS_FAILURE event is appended in lieu of CAS_REBASE; the proposing interaction is then notified through the structured HTTP 409 Conflict response of paragraph [0130]. This abort-and-retry safety property prevents the CAS_REBASE operation from producing a partially-merged state that would be neither the predecessor state nor a complete successor state.

In one embodiment, each per-turn interaction event captured by the telemetry engine and appended to the delta-encoded telemetry frame carries a per-event cryptographic hash computed over a concatenation of at least an event identifier (evId), a timestamp (t), a payload delta (ΔEv) representing the state change recorded by the event, and the per-event cryptographic hash of the immediately preceding per-turn interaction event in the telemetry frame—that is, “hᵢ=SHA-256(evIdᵢ∥tᵢ∥ΔEvᵢ∥hᵢ₋_{₁}”—such that the telemetry frame carries an embedded hash-chained audit sequence whose integrity can be verified by any auditor in possession of the final event's hash without any dependence on the head digest of the tamper-evident audit ledger 112. The tamper-evident embedded telemetry sequence is structurally equivalent to the hash-chain mechanism employed by audit ledger 112 (paragraphs [0127], [0142]) and is cryptographically consistent with it in the sense that telemetry events that are ultimately promoted to the audit ledger retain their per-event hash as the leaf value committed to the ledger. The delta-encoded telemetry frame further distinguishes, for each captured event, between a monotonic-cumulative temporality—corresponding to a cumulative counter that is non-decreasing across the interaction-turn sequence (for example, cumulative-bytes-rendered or cumulative-placeholder-hydrations)—and a point-in-time-instantaneous temporality—corresponding to an instantaneous value that may increase or decrease across interaction turns (for example, current latency, current packet-loss rate, or current placeholder-hydration-failure-rate). Each event is tagged with a per-event temporality indicator identifying which of the two temporality semantics applies to the event's payload, such that the streaming aggregator of paragraph [0129] can compute materialized views directly from the delta-encoded telemetry frame without requiring either the host-channel client or envelope generator 101 to retain a full cumulative per-turn state representation—the server-side materialized view applies the appropriate arithmetic (cumulative sum for monotonic events; point-in-time overwrite for non-monotonic events) based on the temporality indicator carried within the telemetry frame itself.

### Two-Phase Delivery Security Model

FIG. 9 is a two-phase diagram illustrating a two-phase delivery security model. Referring to FIG. 9, the constraint-adaptive architecture employs a two-phase delivery security model that separates the initial message transport from the runtime data channel. As shown in FIG. 9, Phase 1 (standard transport 970) operates as follows: envelope generator 101 assembles an envelope skeleton 972 and transmits envelope skeleton 972 through standard message transport 974 to host-channel client 120. In the first phase, the communication envelope is transmitted to the host-channel client through standard message transport 974—such as SMTP for email, Apple Push Notification Service or Firebase Cloud Messaging for push notifications, the RCS platform for Rich Communication Services messages, or the Apple Messages for Business encrypted infrastructure. Envelope skeleton 972 carries only the skeleton of the interactive application: UI markup 202, application logic 204, typed placeholder assets 208, replay-detection token 210, and turn header 214. Sensitive data elements—including, without limitation, protected health information, personally identifiable information, financial account details, legal document contents, insurance claim specifics, employment records, and any data subject to a regulatory protection mandate—are represented solely as typed placeholder assets in envelope skeleton 972 and are never transmitted through standard message transport 974.

The two-phase delivery security model set forth in paragraph [0134] is inherently supported by the placeholder-substitution and authenticated-hydration mechanisms disclosed herein. The placeholder engine (paragraph [0068]) replaces every excluded or sensitive element with a typed placeholder asset whose hydration is gated by a manifest cursor (paragraph [0069]) that is a server-signed, opaque, time-limited credential verifiable only by the envelope generator through an authenticated runtime channel. Because the manifest cursor is invalid outside the authenticated channel, no intermediate node on the standard message delivery transport can resolve the placeholder to the underlying sensitive element. Combined with the placeholder-as-mandatory-substitution behavior—that is, no sensitive element appears in the initial envelope unless an explicit non-sensitive classification has been applied—the placeholder mechanism operates as a phase-1 transport-layer substitution while the manifest-cursor-gated hydration operates as the phase-2 secure-runtime delivery. The two-phase characterization of paragraph [0134] is therefore not a new mechanism relative to the placeholder-plus-cursor architecture described throughout this specification, but rather a naming of the architectural consequence that follows necessarily from the placeholder-plus-cursor composition. The phase-1 transport carries only structural surrogates, and the phase-2 secure runtime channel carries the sensitive content.

In one embodiment, tamper-evident audit ledger 112 is replicated across multiple geographically distributed storage regions and each ledger write is committed by a quorum of at least two of three replicas by default, the quorum size being configurable. Upon quorum-failure (for example, due to network partition), the ledger write is retried with exponential back-off up to a configurable retry maximum, and a QUORUM_FAILURE event is appended to a local ledger copy indicating the retry attempt and eventual outcome. The envelope transmission itself is not blocked on ledger quorum completion—the envelope proceeds through control pipeline 104 and routing engine 106 subject to eventual-consistency guarantees on the ledger, which is the correct design for latency-sensitive messaging while preserving the strong-consistency guarantees on the audit-trail that regulated workflows require.

In one embodiment, the cryptographic-agility migration of paragraph [0075] is executed through a configurable transition period during which each communication envelope produced by the system carries both a predecessor-algorithm signature and a successor-algorithm signature. The transition period is applied as a canary rollout, progressively extending dual-signing from a small initial percentage of communication envelopes (for example, approximately five percent) to the full verifier population, with the rollout advanced through a sequence of canary epochs each recorded in tamper-evident audit ledger 112 as a CanaryAdvance event including a predecessor-epoch identifier, a successor-epoch identifier, and the inclusion-range upper bounds for each epoch. The canary selector determining whether a particular envelope receives dual-signing is computed deterministically from a recipient identifier rather than from a random number, ensuring that a consistent subset of verifiers observes dual-signed envelopes in each epoch so that telemetry can reliably detect verification regressions introduced by the successor algorithm. Representative canary-selector formulas include: (i) “selector=numericRecipientId mod 1000”, with inclusion-range upper bound expressed as a decimal percentage of the 1000-bucket space (for example, upper bound 50 corresponds to 5.0%); (ii) “selector=first 64bits(SHA-256(recipientIdString)) mod 1000,” suitable when recipient identifiers are non-numeric email addresses or DIDs; and (iii) “selector=envelopeId mod 1000”, applying canary selection per-envelope rather than per-recipient when deployment tests envelope-level rather than recipient-level regressions. The canary epochs advance on a telemetry-driven schedule rather than a fixed chronological schedule: the system monitors predecessor-signature-verification-success rate, successor-signature-verification-success rate, and dual-signing-envelope-assembly-latency metrics derived from the streaming aggregator of paragraph [0129], and advances to the next canary-epoch inclusion-range upper bound only when the successor-signature metrics meet configured thresholds over a configurable observation window.

In one embodiment, the DigestChange event of paragraph [0075] is cryptographically bound to the audit ledger's preceding entry through a hash-chain link computed over at least the DigestChange event's predecessor-algorithm identifier, successor-algorithm identifier, transition-completion timestamp, and a cryptographic hash of an operator-approved transition policy artifact that authorized the transition (for example, a signed policy document specifying which successor algorithm was approved, by which approver, under which authority, and for which deployment scope). The hash-chain-link computation is “hDigestChange=SHA-256(predAlgId∥succAlgId∥transitionTimestamp∥hash(policy)∥hPrev)” where “hPrev” is the hash-chain link of the immediately preceding ledger entry. Because the DigestChange event's hash-chain link incorporates both the transition-completion timestamp and the policy digest, any post-hoc alteration of either element causes the hash-chain link to fail verification against the preceding entry, rendering retroactive forgery of the cryptographic-transition timeline detectable by any auditor with access to the ledger. The DigestChange event's hash-chain binding is structurally distinct from generic operational transparency logs (for example, Sigstore Rekor's append-only log of software-artifact signatures) because the binding explicitly incorporates the transition policy artifact: the ledger proves not merely *that* a transition occurred at a time but also *under what policy authority* the transition was approved—an element necessary for regulatory audits (for example, PCI DSS 3.6.4 cryptographic-period transitions or FIPS 140-3 validation-period transitions) that require the auditor to verify both the transition timing and the authorization basis.

As shown in FIG. 9, Phase 2 (secure runtime channel 976) operates as follows: upon host-channel client 120 rendering envelope skeleton 972, the host-channel client establishes secure runtime channel 976 directly to envelope generator 101, passes through authentication gate 275, and receives sensitive data 978 (including, without limitation, protected health information, personally identifiable information, financial account details, and legal document contents) exclusively through secure runtime channel 976 for hydration in place of the typed placeholder assets 208 carried by envelope skeleton 972. In the second phase, when the recipient opens the message and the host-channel client renders the interactive application, the application establishes secure runtime channel 976 directly between host-channel client 120 and envelope generator 101. Secure runtime channel 976 operates via authenticated, encrypted connections using mechanisms native to the host surface or any functionally equivalent secure transport. Representative surface-specific mechanisms include, without limitation: in AMP for Email, interactive elements initiate authenticated HTTPS requests with origin verification; in Microsoft Adaptive Cards, action triggers invoke authenticated HTTPS callbacks; in Rich Communication Services, agent events flow through the platform's authenticated APIs; in Apple Messages for Business, the runtime channel operates through Apple's encrypted messaging infrastructure; and in push notification surfaces, interactive callbacks use authenticated HTTPS endpoints. The system is not limited to any particular secure transport mechanism—any current or future surface-native protocol that provides authenticated, encrypted communication between the host-channel client and the envelope generator is compatible with the two-phase architecture. In a representative AMP for Email embodiment, the application logic embedded in the initial communication envelope includes an amp-form element whose action attribute specifies an authenticated HTTPS endpoint on the envelope generator; when the recipient interacts with the form element, the AMP runtime in the host-channel client initiates an authenticated HTTPS POST request to the specified endpoint, thereby establishing the secure runtime channel. In a representative Adaptive Card embodiment, an Action. Execute element embedded in the card payload specifies a callback URL; when the recipient triggers the action, the host application invokes the URL with an authentication token, establishing the channel. In each case, the secure channel ensures that sensitive data disclosed during the interactive session does not traverse the initial message delivery transport.

In one embodiment, the content-classification stage of paragraph [0080] computes the filter-hash value recorded in the policy receipt over a canonicalized representation of the evaluated content *subsequent to* application of the filter-action value, such that the filter-hash serves as a verifiable commitment to the content as it exits the content-classification stage rather than as it entered. For a “block” filter-action the evaluated content is replaced with a block-indicator placeholder prior to filter-hash computation; for a “redact” filter-action the selected fields of the evaluated content are replaced with redaction placeholders prior to filter-hash computation; for an “allow” filter-action the evaluated content is passed through unchanged prior to filter-hash computation. In each case the canonicalization function applied before the cryptographic digest computation includes deterministic normalization operations—for example, JSON Canonicalization Scheme (RFC 8785) for structured content, Unicode NFC normalization for text content, and removal of format-agnostic whitespace—such that semantically equivalent representations of the evaluated content yield an identical filter-hash. The cryptographic digest length is at least sixty-four bits, which is sufficient to render undetected forgery of the redaction computationally infeasible while minimizing the policy-receipt byte overhead within the channel byte-budget. The policy receipt additionally includes the filter-action value, the classifier identifier, the classifier version, and the filter-hash, collectively forming a compact verifiable attestation of the content-classification decision. The policy receipt is cryptographically bound to the communication envelope itself by computing the Message Authentication Code (MAC) of paragraph [0074] over a concatenated byte sequence including the communication envelope followed by the policy receipt—“MAC=HMAC-SHA-256(key, envelope∥policyReceipt)”—rather than over the envelope alone. A downstream recipient or auditor verifying the MAC must therefore present both the envelope and the policy receipt in the form originally bound; any modification to the envelope after content-classification, substitution of the policy receipt with a different receipt, or omission of the policy receipt causes the MAC to fail to verify, rendering the dissociation cryptographically detectable. This pre-MAC-binding ordering of the content-classification stage is architecturally distinct from prior-art asynchronous Data Loss Prevention (DLP) logging—in which classification decisions are recorded to a detached audit log *after* the Message Transfer Agent has applied DKIM or similar transport signatures—because pre-MAC binding makes the classification decision part of the cryptographically verified envelope state rather than a separable log record.

The two-phase delivery security model is architecturally distinct from conventional secure messaging approaches. Conventional end-to-end encryption systems (such as S/MIME, PGP, or ProtonMail) encrypt the entire message payload during transport but still require both sender and recipient to share a cryptographic framework, and the encrypted payload remains a single monolithic unit—the recipient either decrypts all of it or none. Conventional portal-redirect systems (such as Virtru, Zix, or Microsoft Office Message Encryption) deliver a benign notification with a link, requiring the recipient to leave the message surface entirely and authenticate on an external web portal. The two-phase model differs from both: it transmits a fully interactive application skeleton (not an encrypted blob, and not a redirect link) through the insecure transport, and then hydrates individual data elements selectively through the secure channel based on the recipient's authentication level—enabling progressive disclosure of different data elements at different assurance levels within the same message, which neither end-to-end encryption nor portal redirect can achieve.

The tamper-evident audit ledger 112 records not merely server-side data access events (which is the standard practice for HIPAA and GDPR compliance logging) but specifically the client-side rendering event—the precise moment at which each sensitive data element is hydrated into the message surface DOM in place of its corresponding typed placeholder asset 208. This distinction is architecturally significant: a conventional server-side access log records only that the server delivered data to a requesting client, which does not prove that the data was actually rendered to the authenticated recipient within the message surface. The two-phase model's audit ledger records the specific transition event—identifying the placeholder that was replaced, the sensitive data element that was hydrated, the authentication method and assurance level that gated the disclosure, and the message surface context in which the hydration occurred—creating a cryptographic proof that the sensitive data was disclosed to a specific recipient, after specific authentication, within a specific message surface, at a specific time.

The envelope generator dynamically translates the sensitive data payload into the specific formatting required by the target message surface before transmitting through the secure channel. For an AMP for Email surface, the server formats the payload as a JSON response compatible with amp-list data binding; for a Microsoft Adaptive Card surface, the server formats the payload as an Action. Execute response conforming to the Adaptive Card schema; for a Rich Communication Services surface, the server formats the payload as an AgentEvent update compatible with the RCS platform's API. This surface-native protocol translation ensures that the same sensitive data, protected by the same two-phase model, is deliverable through any current or future message surface without requiring the data source to implement surface-specific formatting—the envelope generator handles the translation based on the platform descriptor. This capability distinguishes the two-phase model from systems that are engineered for a single messaging platform and cannot adapt to heterogeneous message surfaces.

Because sensitive data flows exclusively through the secure runtime channel and never appears in the initial message payload, the placeholder mechanism serves a dual purpose: it enforces byte-budget compliance (as described in connection with FIG. 2 and FIG. 3) AND it enforces data-security compliance by ensuring that regulated, sensitive, or personally identifiable information is delivered only through the authenticated, encrypted runtime channel—not through the standard message transport, which may traverse intermediate servers, be cached by proxy infrastructure, or be stored in plaintext by the message delivery platform. This two-phase architecture enables the system to deliver interactive applications including sensitive data through message surfaces that were previously considered unsuitable for regulated content precisely because their delivery transports lack end-to-end encryption.

### Sensitive Data Display Modes

In one embodiment, the system supports multiple display modes for sensitive data within the message surface, ranging from fully obscured to fully visible, with intermediate partial-masking states. When a data element is classified as sensitive by compliance-profile selector 410, the system applies one of the following display modes based on the applicable regulatory mandate and the current authentication state of the recipient:
(a) Fully obscured—the data element is represented as a typed placeholder asset 208 showing only the content-type identifier and condensed surrogate (for example, “Medical record available” or “Financial statement ready”). No portion of the underlying data is visible. This mode is applied prior to recipient authentication for data subject to regulatory protection mandates—including but not limited to HIPAA, GLBA, and any current or future jurisdictional data-protection requirement that mandates identity verification before disclosure.
(b) Partially masked—the data element is displayed with selective redaction, revealing enough structure for the recipient to identify the record without exposing the full sensitive content. Examples include, without limitation: account numbers displayed as “xx4532,” Social Security numbers displayed as “x-xx-6789,” diagnostic codes displayed with the category visible but the specific code redacted, billing amounts displayed with the total visible but line-item details redacted, and travel itineraries displayed with destinations visible but booking references redacted. Partial masking is applied when the regulatory regime permits summary-level disclosure without full authentication, or when the recipient has completed a lower-assurance authentication step.
(c) Fully visible—the complete data element is rendered within the message surface after the recipient satisfies the authentication requirements specified by the applicable compliance profile. The transition from obscured or masked to fully visible is recorded in tamper-evident audit ledger 112, creating a verifiable chain of custody for every sensitive data disclosure event.

The three-state display-mode progression of paragraph [0145]—fully obscured, partially masked, and fully visible—and the transitions among those states through successive authentication steps described in paragraph [0147] are supported by the compliance-profile-driven masking, omission, hashing, retention, and pseudonymisation actions natively provided by the architecture. Specifically, compliance-profile selector 410 applies per-data-element actions selected from: (i) omit (the data element is represented solely as a typed placeholder asset in the envelope—corresponding to the fully-obscured mode); (ii) mask (the data element is represented with only a non-sensitive indicator rendered inline, such as last-four-digits-only of an account number, while the full value remains hydratable through the secure runtime channel—corresponding to the partially-masked mode); (iii) hash or pseudonymise (the data element is represented by a deterministic surrogate); and (iv) retain in cleartext (the data element is fully rendered—corresponding to the fully-visible mode). The three display-mode states are a mapping of these four compliance-profile actions onto a recipient-visible progression gated by successive authentication challenges. A recipient initially observes the fully-obscured state because the communication envelope transmitted through the standard message delivery transport includes only typed placeholder assets for the sensitive elements (paragraphs [0068]-[0070], [0134]). Upon a first authentication challenge of an assurance level commensurate with partial disclosure, the authenticated hydration delivers through the secure runtime channel the masked representation of the sensitive element, which is rendered in place of the placeholder. Upon a second, higher-assurance authentication challenge, the full sensitive element is delivered through the secure runtime channel and rendered. Each transition is recorded in tamper-evident audit ledger 112 per paragraph [0142], providing the cryptographic proof of progressive disclosure required by HIPAA minimum-necessary and GDPR data-minimization regimes. The three-state progression is therefore a natural consequence of the compliance-profile-driven architecture combined with the authenticated-hydration mechanism; the system is not limited to three states, and any number of progressive authentication assurance levels may be mapped to any number of correspondingly increasing disclosure fidelities, subject to the compliance profile applicable to the conversation.

The display mode may transition dynamically within a single interactive session through one or more authentication steps, where the authentication method is determined by the applicable compliance profile and is not limited to any particular verification mechanism. Authentication methods include, without limitation: biometric verification (fingerprint, face recognition, voice recognition), knowledge-based authentication (date of birth, last four digits of a government identifier, mother's maiden name, security questions), possession-based verification (confirmation of a telephone number via SMS or voice callback, entry of a one-time code sent to a registered device), magic-link nonce verification, OAuth 2.0 or OpenID Connect challenge, PIN or passphrase entry, document-based verification (uploading a photo of a government-issued identifier), or any combination thereof as required by the applicable regulatory regime. Different regulatory regimes may require different authentication assurance levels—for example, a healthcare billing notification under HIPAA may require date-of-birth confirmation plus last four digits of a patient identifier, while a financial statement under GLBA may require multi-factor authentication combining a PIN with a telephone confirmation, and a low-sensitivity notification may require only email-address verification. The system supports any authentication method or combination that can be rendered within the constraints of the host message surface. For example, a recipient opening a healthcare billing notification initially sees fully obscured placeholders for all PHI-bearing fields; upon confirming their date of birth and the last four digits of their patient identifier within the message surface, the system transitions the billing amount to fully visible while keeping diagnostic details partially masked; upon completing a secondary step (such as biometric verification), the system transitions the diagnostic details to fully visible. Each transition is recorded in tamper-evident audit ledger 112 with the authentication method, the assurance level achieved, the data elements transitioned, and the display mode change. This progressive disclosure approach enables the system to comply with minimum-necessary-disclosure principles under HIPAA, data-minimization requirements under GDPR, and any current or future graduated-access regulatory framework.

### Generalized Regulatory Data Protection

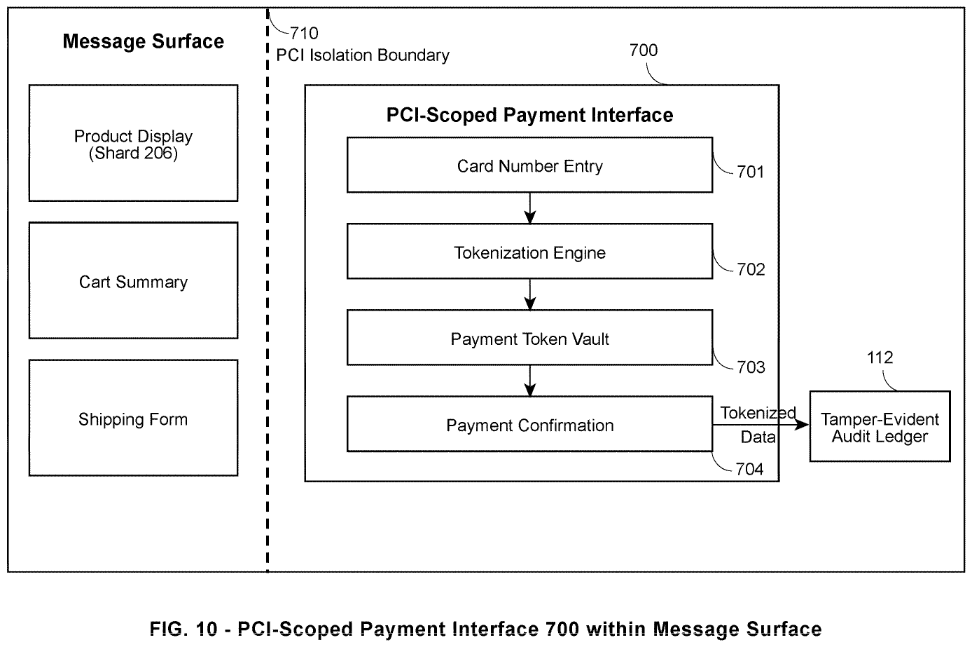

The regulated-data placeholder mechanism described below for healthcare data (paragraphs [0169]-[0170]) generalizes to any data subject to a regulatory protection mandate, industry standard, contractual obligation, or organizational policy—whether currently enacted or enacted in the future. The compliance-profile selector 410 determines the applicable regulatory regime and applies the corresponding data-protection rules. In one embodiment, compliance-profile selector 410 determines the applicable regulatory regime based on metadata associated with the data source—for example, a healthcare data source is tagged with a HIPAA compliance profile, a financial data source is tagged with a GLBA profile, and a personal-data source is tagged with a GDPR profile—enabling automatic profile selection without per-conversation configuration. In another embodiment, the compliance profile is specified explicitly by the data source through an API parameter. The system is not limited to any particular regulatory framework; new compliance profiles can be added through configuration without modification to the envelope assembly or control pipeline logic. Representative regulatory regimes and their corresponding data-protection behaviors include, without limitation:
(a) Healthcare (including but not limited to HIPAA, HITECH, and equivalent jurisdictional health-data regimes enacted in any jurisdiction)—protected health information including diagnoses, medications, lab results, billing amounts, appointment details, and provider communications are represented as typed placeholders until the recipient satisfies identity verification requirements specified by the applicable compliance program. The identity verification method is determined by the compliance profile and may include any mechanism described in paragraph [0147] or any other method that satisfies the applicable regulatory standard.
(b) Financial services (including but not limited to GLBA, SOX, FINRA, PCI DSS, MiFID, and equivalent jurisdictional financial-data regimes)—account numbers, balances, transaction histories, investment positions, loan terms, insurance policy details, and credit information are represented as typed placeholders or partially masked elements. PCI-scoped payment data is further isolated within payment interface 700 as described in FIG. 10. The authentication method and assurance level are determined by the applicable financial regulatory standard.
(c) Personal information protection (including but not limited to GDPR, CCPA, LGPD, POPIA, PIPL, state-level PII regimes, and any current or future jurisdictional privacy framework)—personally identifiable information including names, addresses, government identifiers, biometric data, location data, and behavioral profiles are represented as typed placeholders or partially masked elements. The system supports consent management workflows in which the recipient grants or revokes consent for specific data categories within the message surface, with each consent event recorded in tamper-evident audit ledger 112. The system adapts to the specific requirements of each jurisdiction's privacy framework through the compliance-profile configuration.
(d) Legal and professional (attorney-client privilege, trade secrets, employment records, non-disclosure agreements)—privileged or confidential communications are represented as typed placeholders requiring authentication appropriate to the professional relationship.
(e) Government and public sector (including but not limited to tax return data, benefits information, regulatory filing contents, classified or controlled unclassified information)—government-mandated data protection requirements are applied based on the jurisdiction and data classification level.
(f) Any other current or future regulatory regime, industry standard, or organizational policy that mandates data protection for specific categories of information—the compliance-profile selector 410 is extensible by configuration, enabling the system to support new regulatory frameworks as they are enacted without modification to the envelope assembly, control pipeline, or placeholder mechanisms.

In one embodiment, compliance-profile selector 410 loads the selected compliance profile as a declarative, machine-readable configuration object (for example, a YAML or JSON document conforming to a published compliance-profile schema) that specifies, for the named regulatory regime, three categories of operational rules: (i) rate-limiter rules governing the permissible interaction throughput, including per-tenant and per-endpoint throttle limits and back-off constants, for the named regime; (ii) policy-evaluator rules governing masking, redaction, and pseudonymisation transformations to be applied to specific data-element categories encountered in the envelope; and (iii) severity-classifier rules governing the severity level and audit-ledger classification assigned to compliance-affecting events produced during envelope assembly. At profile-load time, compliance-profile selector 410 injects the three categories of rules atomically into the three corresponding pipeline stages—the rate limiter, the policy evaluator, and the severity classifier—of envelope-assembly engine 101. The injection is atomic in the transactional sense: the profile loader first validates that each of the three rule sets binds successfully to its corresponding stage (that is, the rate-limiter rule set parses and commits into the rate-limiter configuration; the policy-evaluator rule set parses and commits into the policy-evaluator configuration; and the severity-classifier rule set parses and commits into the severity-classifier configuration) and only then publishes the three bound configurations for subsequent envelope-assembly operations. If any single stage's binding fails—for example, due to a schema-validation error on the rate-limiter rule set, an unresolvable pseudonymisation algorithm identifier in the policy-evaluator rule set, or an unknown severity-level name in the severity-classifier rule set—the profile loader rolls back all three stage bindings (returning the rate limiter, policy evaluator, and severity classifier to their respective pre-load configurations) and aborts the corresponding envelope assembly with a profile-load-failure event appended to tamper-evident audit ledger 112. The three-stage atomic injection thereby guarantees that envelope-assembly operations under a named regime either observe the complete regime configuration across all three stages or do not proceed at all, avoiding any transient state in which only one or two of the three stages reflect the selected regime. This atomicity distinguishes the disclosed architecture from prior-art compliance platforms that enforce regulatory rules at a single inline-gateway choke point (for example, a network-layer Data Loss Prevention proxy operating out-of-band of the application), and from prior-art policy-as-code frameworks that evaluate policies at discrete decision points (for example, a Kubernetes admission webhook) without orchestrating coordinated cross-stage rule configuration.

In one embodiment, compliance-profile selector 410 and budget-aware allocator 102 coordinate their execution order such that the policy-evaluator stage executes data redaction, masking, and pseudonymisation transformations specified by the loaded compliance profile strictly prior to budget-aware allocator 102 allocating bytes within the channel byte-budget. The execution sequence proceeds as follows: (1) compliance-profile selector 410 determines the applicable regulatory regime from metadata associated with the data source or from an explicit profile identifier supplied by an API caller; (2) the selected profile is loaded and injected atomically into the three pipeline stages as described in paragraph [0149]; (3) the policy-evaluator stage iterates over each data element of the envelope payload and applies the transformation (omit, mask, hash, pseudonymise, or retain) specified by the profile for the data element's classification, producing a post-compliance payload in which each regulated element appears only in its transformed form or not at all; and (4) budget-aware allocator 102 receives the post-compliance payload and allocates bytes within the channel byte-budget to the elements of the post-compliance payload according to the budget-aware allocation mechanism. Because the policy-evaluator stage completes its transformations before budget-aware allocator 102 allocates bytes, the system does not allocate constrained envelope bytes to regulated data elements designated for redaction and cannot produce a partial truncation of a regulated data element that would reveal structural fragments of the element within the message surface. This pipeline ordering is distinct from prior-art inline Data Loss Prevention architectures in which DLP inspection is performed reactively on a fully assembled payload after all byte allocations are finalized, and from prior-art architectures in which redaction can be applied to a truncated payload only after the payload exceeds a size budget and cannot be reconstituted to ensure that the truncation does not disclose a structural fragment of a regulated element.

In one embodiment, a cryptographic salt utilized by replay-token service 114 for token generation and verification is rotated on a temporal schedule dictated by a regulatory cadence associated with the dynamically selected compliance profile. The regulatory cadence is defined by the profile and includes, without limitation: for a GDPR profile, a lawful-basis reaffirmation cycle corresponding to the period after which a tenant must re-confirm the lawful basis for processing under Article 6; for a HIPAA profile, a retention-audit cycle corresponding to the six-year retention period imposed on designated record sets by 45 CFR 164.530(j); for a PCI DSS profile, a cryptographic-period cycle corresponding to the profile-defined maximum cryptographic period of the replay-detection key material under PCI DSS Requirement 3.6.4; and for a FINRA profile, a communication-retention cycle corresponding to the three-year retention period imposed on electronic communications by FINRA Rule 4511 and Rule 3110. Each salt rotation is appended to tamper-evident audit ledger 112 as a SaltRotate event including at least a predecessor-salt digest (computed as a cryptographic hash of the predecessor salt), a successor-salt digest (computed as a cryptographic hash of the successor salt), and a rotation-timestamp, without writing either salt value itself to the ledger. This regime-coupled rotation differs from prior-art anonymization schemes that rotate salts on arbitrary chronological schedules (for example, a daily rotation unrelated to any specific regulatory cadence) by cryptographically coupling the temporal validity of the replay-detection structure to the legal mandate of the selected regulatory regime, such that a replay-detection token emitted under a GDPR profile has temporal validity aligned with the lawful-basis reaffirmation cycle of that regime rather than with an implementation-specified chronology.

In each case, the two-phase delivery security model ensures that protected data is transmitted exclusively through the secure runtime channel, the display mode (fully obscured, partially masked, or fully visible) is governed by compliance-profile selector 410, the authentication method and assurance level are determined by the applicable compliance profile, and every data-access event is recorded in tamper-evident audit ledger 112 with sufficient detail for regulatory audit. The system is not limited to the regulatory regimes enumerated above; the architecture supports any data-protection requirement that can be expressed as a compliance profile governing which data elements are obscured, masked, or disclosed, what authentication is required before each disclosure level, and what audit records must be generated.

The compliance-profile architecture described in paragraphs [0145]-[0151] is regime-agnostic: the compliance-profile selector 410 is table-driven and loads a machine-readable declarative configuration for each named regulatory regime at profile-load time. The specific regulatory regimes enumerated herein—including HIPAA, GDPR, PCI DSS, FINRA, CCPA, CPRA, LGPD, APPI, and DPDP—are representative examples of data-protection mandates that may be expressed as compliance profiles within this architecture; they are not exhaustive, and the architecture is equally capable of accommodating any other current or future data-protection mandate by registering a corresponding compliance profile with its rate-limiter rules, policy-evaluator rules, and severity-classifier rules as described in paragraph [0149]. In particular, for consumer-privacy mandates including the California Consumer Privacy Act as amended by the California Privacy Rights Act, the Brazil Lei Geral de Proteção de Dados Pessoais, the Japan Act on the Protection of Personal Information, and the India Digital Personal Data Protection Act, the system adapts (i) authentication requirements to each regime's rights-exercise verification standard (for example, CCPA/CPRA right-to-know/deletion verification thresholds, LGPD data-subject-rights Article 18 verification, APPI consent-verification under Article 15, DPDP data-principal-notice verification under Section 11); (ii) masking actions to each regime's defined categories of personal or sensitive data (for example, CCPA/CPRA personal information categories enumerated in Cal. Civ. Code § 1798.140(v), LGPD sensitive personal data under Article 5(II), APPI personal information under Article 2, DPDP personal data under Section 2(t)); and (iii) audit-ledger severity classifications coupled to each regime's breach-notification thresholds (for example, CCPA/CPRA breach disclosure under Cal. Civ. Code § 1798.82, LGPD notification to ANPD under Article 48, APPI reporting to PPC under Article 22-2, DPDP reporting to the Data Protection Board under Section 8). The architecture does not require per-regime modifications to the core envelope-assembly pipeline; the pipeline treats the compliance profile as opaque configuration data.

The two-phase delivery security model, combined with authentication-gated placeholder disclosure and the tamper-evident audit ledger, enables categories of secure interaction within message surfaces that are not achievable with conventional messaging technologies due to the absence of authenticated data channels, identity verification capabilities, and auditable disclosure records. These categories include, without limitation: identity verification and know-your-customer workflows (document upload, selfie capture, and identity proofing conducted entirely within the message surface via the secure runtime channel); prescription management and medication adherence workflows compliant with healthcare data protection mandates (refill authorization, dosage confirmation, and drug-interaction alerts with authentication-gated patient identification); authenticated voting and resolution workflows (shareholder proxy votes, homeowner association ballots, board resolutions, and organizational polls with verified voter identity and auditable ballot records); multi-party approval chains (sequential or parallel approval workflows such as expense authorization, purchase order sign-off, and contract countersignature in which each approver authenticates independently within the same message surface and each approval event is recorded in the audit ledger); age-verification-gated interactions (delivery confirmation for age-restricted products, access to age-restricted content, and gambling-compliance verification); emergency notification with verified response (evacuation acknowledgments, safety check-ins, and critical-infrastructure status reports requiring authenticated confirmation from identified recipients); regulatory compliance attestations (annual certifications, conflict-of-interest disclosures, anti-money-laundering acknowledgments, and training completion confirmations with digital signature capture); delegated authority and power-of-attorney workflows (in-message authorization granting or revoking authority for another party to act on the principal's behalf, with identity verification and audit trail); warranty claims and product recall workflows (serial-number verification, photographic evidence submission, and replacement scheduling via the secure channel); benefits enrollment and human-resources onboarding (open-enrollment selections, tax-form completion, and direct-deposit authorization with personally identifiable information protected by authentication-gated disclosure); secure inter-party communications subject to professional privilege (attorney-client, physician-patient, financial-advisor-client, and clergy-penitent communications conducted within the message surface with privilege-appropriate authentication and per-message audit records); and educational-record workflows subject to student-privacy mandates such as FERPA (grade access, transcript requests, financial-aid applications, and course registration with student-identity verification). In each case, the capability depends on the combination of the secure runtime channel (which conventional message surfaces lack), the authentication-gated disclosure mechanism (which ensures sensitive data is visible only to verified recipients), and the tamper-evident audit ledger (which provides the regulatory audit trail). The enumerated categories are representative and non-exhaustive; any secure interaction that requires authenticated identity, protected data transmission, and auditable disclosure within a resource-constrained message surface is enabled by the disclosed architecture.

### In-Message Payment Processing

FIG. 10 is a diagram illustrating PCI-scoped payment interface 700 rendered within a message surface. Referring to FIG. 10, in one embodiment the communication envelope includes a PCI-scoped secure interface (payment interface 700) rendered within the message surface. PCI isolation boundary 710 separates payment interface 700 from surrounding envelope content. As shown in FIG. 10, the message surface is divided into two zones separated by PCI isolation boundary 710. The left zone includes surrounding envelope content outside PCI scope—product display rendered from sliding-window shard 206, cart summary, and shipping form—representing the interactive shopping experience described in FIG. 12. The right zone includes PCI-scoped payment interface 700, isolated from surrounding envelope content, with four vertically stacked sub-components connected by downward solid arrows forming the tokenization flow: card number entry 701 at the top, where the recipient enters raw card credentials (card number, expiration, CVV) that never leave PCI scope; tokenization engine 702, which transmits the raw credentials directly to a PCI DSS certified payment service provider's tokenization endpoint; payment token vault 703, which receives and stores the payment token representing the card; and payment confirmation 704 at the bottom, which displays the confirmation using only the payment token without raw card data. A single outbound arrow exits the PCI zone from payment confirmation 704 to tamper-evident audit ledger 112, carrying only tokenized data—never raw credentials. Payment interface 700 is isolated from surrounding envelope content so that raw payment credentials are entered and tokenized entirely within the message surface without the recipient being redirected to an external payment page, checkout flow, or browser session.

In various embodiments, payment interface 700 may support, without limitation: tokenized-wallet sessions such as Apple Pay and Google Pay, 3-D Secure step-up verification, direct card-number tokenization, external payment-authorization URL redirect, hosted fields from a PCI-certified payment service provider, or other payment methods and protocols. The tokenized payment data flows through the same tamper-evident audit chain as other conversational turns.

Referring to FIG. 10, PCI-scoped payment interface 700 is rendered within an isolation boundary inside the message surface. The isolation boundary prevents surrounding envelope content from accessing raw payment credentials. In one embodiment, the isolation is achieved through an iframe element rendered within the AMP for Email sandbox, the iframe being sourced from a PCI DSS Level 1 certified payment service provider. In another embodiment, hosted fields from the payment provider are embedded directly, with each field rendered in a separate secure context. The tokenization flow, corresponding to the four sub-components of payment interface 700 shown in FIG. 10, operates as follows: (1) at card number entry 701, the recipient enters raw card credentials (card number, expiration, CVV) within the PCI-scoped interface; (2) at tokenization engine 702, the credentials are transmitted directly from the secure context to the payment provider's tokenization endpoint—never passing through the envelope generator or touching the envelope's general data space; (3) at payment token vault 703, the payment provider returns a payment token representing the card; (4) at payment confirmation 704, only the payment token (not raw credentials) is incorporated into the conversation state and recorded in audit ledger 112. This architecture enables in-message payment processing that satisfies PCI DSS requirements without requiring the envelope generator to handle or store raw cardholder data.

In various embodiments, payment interface 700 may support: tokenized-wallet sessions (Apple Pay, Google Pay) via wallet SDK integration within the secure context; 3-D Secure step-up verification triggered within the same iframe when the issuing bank requires additional authentication; direct card-number tokenization for payment providers that offer JavaScript tokenization libraries; and external payment-authorization URL redirect for payment flows that require redirect-based authentication. The payment result and confirmation are rendered within the original message surface, completing the entire checkout lifecycle without redirection.

In one embodiment supporting returning recipients who have previously transacted through a given conversation, the payment token generated by tokenization engine 702 and stored in payment token vault 703 as described in paragraph [0157] may persist across conversational sessions as a stored payment method associated with the recipient identifier. When the same recipient initiates a subsequent payment in a subsequent conversational turn, envelope generator 101 may assemble a refreshed envelope presenting the stored payment method as a pre-selected payment option identified by a non-sensitive surrogate (for example, a card-network indicator and the last four digits of the tokenized primary account number)—the raw card credentials are not re-presented and are not present in the envelope. The recipient confirms the charge through an interaction with the message surface (for example, a “Pay” or “Confirm” button rendered within the surface), and upon recipient confirmation the stored payment token is retrieved from payment token vault 703 through the authenticated secure runtime channel (paragraphs [0139]-[0141]) and used to initiate the transaction without re-entry of raw credentials by the recipient. The stored payment method architecture is cryptographically bound to the replay-detection token (paragraphs [0071]-[0077]) such that only the intended recipient, on the originally authorized platform, may charge the stored token—ensuring that the stored credential cannot be exercised by a third party to whom the envelope has been forwarded. Each stored-payment-method charge event is recorded in tamper-evident audit ledger 112 as a discrete entry including at least a recipient identifier, a tokenized primary account number reference, a charged amount, a conversation identifier, and a confirmation timestamp, such that the ledger cryptographically proves the recipient's confirmation of the stored-method charge.

### Reopen-and-Resume State Resolution

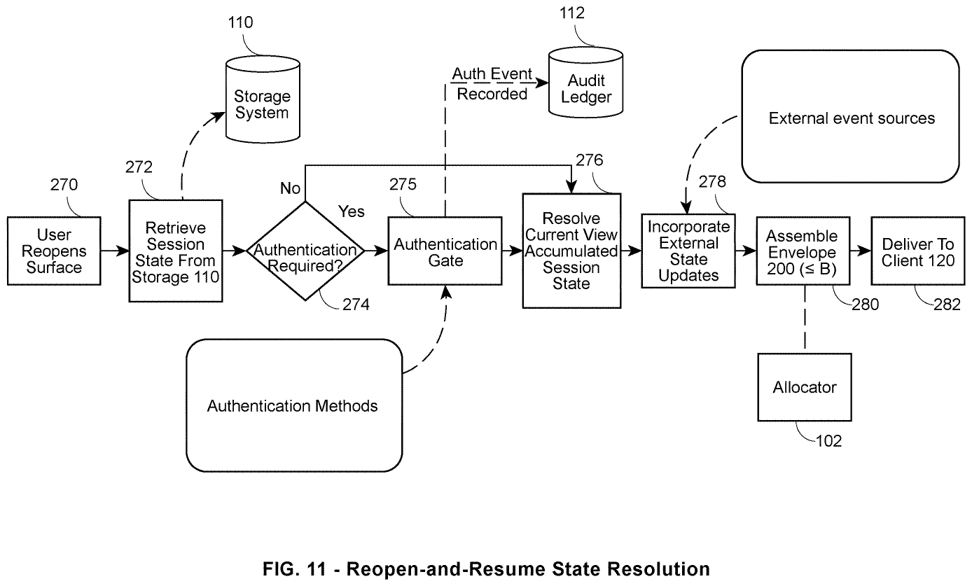

FIG. 11 is a decision-flow diagram illustrating a reopen-and-resume state resolution process showing steps 270 through 282. Referring to FIG. 11, when a recipient reopens a message surface after a period of inactivity—which may range from seconds to days or weeks—the host-channel client 120 transmits an interaction request that triggers envelope generator 101 to assemble a refreshed communication envelope reflecting the current server-side state. Unlike web applications that maintain client-side sessions in browser storage, message surfaces provide no client-side persistence; all session state resides server-side in storage system 110. Accordingly, every reopen is functionally equivalent to a new conversational turn in which the server determines what to display.

As shown in FIG. 11, the reopen-and-resume flow proceeds through the following steps. At step 270, the user reopens the message surface, triggering an interaction request. At step 272, envelope generator 101 retrieves the accumulated session state from storage system 110, including the current workflow position, accumulated data, and the most recent turn sequence. At decision step 274, the system evaluates whether re-authentication is required—for example, because the session has exceeded a configurable inactivity timeout, or because the current workflow position involves sensitive content subject to a regulatory protection mandate (such as PHI under HIPAA, financial data under PCI DSS, or personally identifiable information under GDPR or CCPA). If re-authentication is required (Yes branch), the system presents an authentication gate 275 within the message surface—using, without limitation, biometric verification, a magic-link nonce, an OAuth 2.0 challenge, a PIN, or other authentication mechanism—before proceeding; the authentication event is recorded in tamper-evident audit ledger 112. If re-authentication is not required (No branch), the system proceeds directly.

At step 276, the system resolves the current view—that is, determines which screen, form, or workflow step to present to the recipient. The current view is derived from the accumulated session state: if the recipient was last on the shipping form (step 908 in FIG. 12), the system renders the shipping form with any previously entered data restored. If the recipient completed checkout and is now in the post-purchase lifecycle, the system renders the most relevant post-purchase view—such as order tracking (step 914) with updated fulfillment status. The view resolution is not limited to restoring the last-seen screen; the system may advance the view to reflect events that occurred during the inactivity period.

At step 278, the system incorporates external state updates that occurred between the prior turn and the current reopen. External events—such as, without limitation, order fulfillment updates, carrier tracking events, flight or travel status changes, invoice adjustments, appointment rescheduling, regulatory status changes, or any other state change originating from a source external to the message surface—are merged into the session state. Budget-aware allocator 102 selects the most relevant content for the refreshed envelope, ensuring that the recipient sees current information rather than stale data from the prior turn. In one embodiment, an airline sends an initial booking confirmation as an interactive mini-application within an email; when the recipient reopens the email days later, the system resolves the current view to a travel dashboard showing updated flight status, gate assignments, boarding passes, and any itinerary changes—all within the same message surface, without the recipient navigating to an airline website or mobile application.

At step 280, envelope generator 101 assembles the refreshed communication envelope constrained to byte-budget B, incorporating the resolved view, updated external state, and any newly hydrated content. At step 282, the refreshed envelope is delivered to host-channel client 120. The recipient perceives a seamless continuation of the interactive experience—the mini-application displays the current, relevant screen with up-to-date data, regardless of how much time has elapsed since the prior interaction.

In one embodiment, tamper-evident audit ledger 112 is extended to support cross-border regulatory export. Each ledger entry is annotated with a “geoCode” value identifying the jurisdiction of at least one of data creation, processing, or storage associated with that entry. When a set of ledger entries represents a cross-border personal-data transfer between two enumerated jurisdictions (for example, a transfer from an EU data subject's mailbox to a United-States-based processor), the system generates a Standard Contractual Clause annex document from the ledger set, enumerating the data categories, transfer purposes, recipient categories, and technical safeguards applicable to the set of transfers. A cryptographic timestamp is appended to the annex from an RFC 3161 timestamping authority. The annex is encrypted under a public key associated with the regulatory authority of the destination jurisdiction (for example, the European Data Protection Board public key for transfers subject to EU GDPR) and made available as a regulator-key-encrypted export bundle for submission upon request. Upon subsequent receipt of a consent-revocation event applicable to any data subject represented in the annex, the system propagates a revocation notice to each downstream recipient enumerated in the annex and appends a ConsentRevocation event to the audit ledger. This cross-border export mechanism operates atop the same tamper-evident audit ledger that records all other interaction and compliance events, requiring no separate cross-border system; it therefore produces a unified chain of custody across domestic and cross-border data transfers.

This reopen-and-resume capability distinguishes the disclosed system from conventional messaging, where reopening an email displays the same static content that was originally delivered. In the disclosed system, each reopen triggers a server-side state evaluation that may produce a different view, different data, and different authentication requirements than the prior turn—enabling a single message surface to serve as a persistent, evolving application interface across an arbitrarily long lifecycle.

### Commerce Workflow Example

FIG. 12 is a workflow diagram illustrating one representative multi-step interactive workflow conducted entirely within resource-constrained message surface container 940. Referring to FIG. 12, in a representative commerce embodiment—provided as one non-limiting example of a multi-step interactive workflow supported by the architecture—a recipient opens an email and, without leaving the email client, browses a multi-product catalog with visual product images, selects color and size variants via interactive swatches, adds items to a persistent shopping cart that accumulates across interaction turns, enters shipping information via form fields rendered within the message surface, completes payment via a PCI-scoped interface isolated within the message surface, and receives an order confirmation. The six pre-purchase steps illustrated in FIG. 12 are a minimum; the workflow may extend through the full post-purchase order lifecycle after confirmation. Within the same interactive message surface, using the same persistent session state maintained by budget-aware allocator 102 across an arbitrary number of subsequent turns, the recipient may track the order through fulfillment and delivery, view both the current invoice and historical invoices for prior orders, view interactive shipping history with carrier status updates as they arrive, submit post-delivery product reviews, and interact with an embedded customer-support chat interface—which in some embodiments is mediated by an autonomous software agent through an agent-orchestration bridge maintaining stateful session context for the agent within the message surface. The entire pre-purchase through post-purchase lifecycle, which may span dozens of interaction turns over days or weeks, is conducted within the single interactive message or card without the recipient being redirected to an external interface at any step, and without a separate transactional email being sent for each lifecycle event. This unified single-surface lifecycle is enabled by the budget-aware allocator 102 pruning aged context into typed placeholder assets 208 that the recipient can hydrate on demand (so that historical turns remain retrievable without exceeding the channel byte-budget), the tamper-evident audit ledger 112 maintaining a verifiable chain of custody across the full lifecycle (so that every pre-purchase and post-purchase event is recorded and reconcilable), and the replay-detection token 210 preventing unauthorized access to any lifecycle turn by a recipient other than the intended party. FIG. 12 is provided solely as one representative example of such a workflow; the architecture supports significantly longer and more complex workflows—and workflows in any other domain (healthcare, financial services, legal, real estate, insurance, advertising, government, and others)—wherein any multi-step interaction can be modeled as a sequence of conversational turns with persistent state, and the number of steps, the specific step content, and the lifecycle duration are not limited by the example shown.

As shown in FIG. 12, the workflow steps are identified as follows. Browse step 902 presents a product catalog. Select step 904 provides variant selection. Cart step 906 manages cart items. Shipping step 908 collects address and method. Payment step 910 renders PCI-scoped payment interface 700. Confirm step 912 displays order confirmation. Track step 914 shows fulfillment status. Invoice step 916 presents billing records. Shipping History step 918 shows delivery events. Review step 920 collects product ratings. Support Chat step 922 provides AI-mediated customer support. Session state bar 930 represents the accumulated conversational state persisting across all workflow turns. Resource-constrained message surface container 940 represents the single persistent surface within which all workflow steps execute.

### Healthcare Embodiment

In one embodiment, the placeholder mechanism described above operates as a security gate for regulated data. When the communication envelope includes data elements subject to a healthcare data protection mandate—such as protected health information (PHI) governed by HIPAA—the system replaces those elements with typed placeholder assets prior to recipient authentication. Each PHI placeholder includes a content-type identifier indicating the category of health information replaced (for example, diagnosis, medication, or billing amount), a condensed surrogate that conveys the general nature of the content without revealing the protected information (for example, “Billing statement available” or “Lab result ready”), and an authenticated retrieval reference.

Upon successful recipient authentication within the message surface—for example, through a biometric verification, a magic-link nonce embedded in the envelope, or an OAuth 2.0 challenge—the system hydrates the PHI placeholder assets with the actual protected health information, rendering the full content within the message surface without redirecting the recipient to an external patient portal or web application. The authentication event, the hydration event, and the PHI data elements accessed are each recorded as separate entries in tamper-evident audit ledger 112, creating a verifiable chain of custody demonstrating that protected information was disclosed only to an authenticated recipient. This approach enables health systems to deliver interactive bill-payment communications, appointment reminders, and clinical results entirely within the message surface while maintaining HIPAA-compliant access controls.

In a representative healthcare embodiment, a recipient receives a billing notification in which PHI-bearing fields are replaced with typed placeholders, authenticates within the message surface, views the actual billing details hydrated in-place, and completes bill payment—all without being redirected to a patient portal or external web application.

### Financial Services Embodiment

In a representative financial services embodiment, a recipient receives a loan pre-qualification offer via RCS and, within the message surface, reviews terms, uploads identification documents via placeholder-mediated file references, provides income information, accepts the offer with a digital signature captured within the message—where the digital signature is implemented through an electronic signature including the recipient's typed name or checkbox confirmation rendered within the sandbox's permitted interactive elements, transmitted to the envelope generator through the secure runtime channel, and recorded with authentication metadata in tamper-evident audit ledger 112—and receives confirmation, all within the RCS byte-budget constraint. In a representative customer service embodiment, a multi-turn support case progresses through problem description, diagnostic questions, solution presentation, and satisfaction confirmation across sequential interaction turns within a push notification interface, the growing case history managed by the budget-aware allocator with older turns replaced by typed placeholders that the recipient can hydrate on demand. In a representative insurance embodiment, a claims filing workflow within an Adaptive Card includes incident description, photo evidence submission, coverage verification, and settlement acceptance—all within the 28,000-byte Adaptive Card constraint.

### Advertising Applications

In one embodiment, the communication envelope delivers interactive advertising content within a byte-constrained message surface such as a mobile advertising slot, a connected-television overlay, or an in-email promotional placement. Budget-aware allocator 102 applies the relevance criterion to advertising creative elements—including product images, call-to-action buttons, promotional copy, and checkout components—selecting the combination that maximizes a value-density metric (estimated engagement probability divided by serialized byte cost) while fitting within the channel byte-budget B. When the advertising creative exceeds B, lower-value-density elements are replaced with typed placeholder assets that can be hydrated on recipient interaction.

Each advertising interaction—including impression delivery, recipient tap, product selection, and in-message purchase completion—is recorded as a turn in tamper-evident audit ledger 112. Because the audit ledger provides a hash-linked, cryptographically verifiable chain of every interaction event, advertisers can prove that a specific recipient viewed a specific creative, interacted with a specific product, and completed a specific conversion, all within the message surface and without reliance on third-party cookies, tracking pixels, or external attribution services. In one embodiment, the advertising creative includes an in-message checkout component using PCI-scoped payment interface 700, enabling the recipient to complete a purchase directly from the advertising impression without redirection—reducing the conversion funnel from impression to payment to a single interaction surface.

### Intent-Based Content Matching Within Constrained Surfaces

In one embodiment, the system identifies an intent signal associated with a viewer of a resource-constrained message surface—the viewer being a human user, an autonomous software agent acting on behalf of a user, or a system process—and matches the identified intent to available interactive content from one or more content providers. Unlike keyword-based matching systems that match search terms to static advertisements, the intent-based matching system matches the viewer's identified need or desire to interactive, transactable content that can be rendered as a complete multi-step workflow within the constrained surface. The matched content is assembled into a communication envelope constrained to the surface's byte-budget, enabling the viewer to browse, evaluate, negotiate, and complete a transaction entirely within the constrained surface without redirection.

In one embodiment, the content providers participate in an auction for constrained-surface placement, where each provider submits a bid including at least a bid price, an interactive content payload, and a serialized byte cost. The system evaluates bids based on a composite score incorporating bid price, content relevance to the identified intent, and feasibility of rendering the content within the target surface's byte-budget and sandbox constraints. A content payload that exceeds the surface's byte-budget is automatically adapted by budget-aware allocator 102 before delivery, ensuring that the winning bid's content fits within the constrained surface regardless of the original payload size. In one embodiment, the auction participants are autonomous software agents bidding on behalf of brands, merchants, or service providers, the auction itself being conducted through an agent-orchestration bridge that exchanges bid payloads constrained to the message surface's byte-budget.

In one embodiment, the viewer of the constrained surface is an autonomous software agent browsing on behalf of a human user—for example, a shopping agent evaluating product options, a procurement agent comparing supplier offers, or a research agent gathering information. When such an agent encounters interactive content within a constrained surface, the agent can evaluate the content, interact with it across multiple turns, and complete a transaction within the surface on behalf of its principal. The interaction between the viewing agent and the content-providing agent (or system) proceeds through the constraint-adaptive architecture: each turn is constrained to the surface's byte-budget, session state persists across turns, and every interaction is recorded in the tamper-evident audit ledger. In this embodiment, both the content placement and the content consumption are agent-mediated, with the constrained surface serving as the transactional intermediary between agents operating on behalf of different principals.

In one embodiment, the constrained surface presents both paid content and organically matched content within the same byte-budget. The system allocates a portion of the byte-budget to paid placements (content from providers who have bid through the auction) and a remaining portion to organically matched content (content selected by the system based solely on relevance to the identified intent, without a paid bid). For both paid and organic content, the system applies a quality threshold including at least a minimum relevance score to the viewer's identified intent, such that paid content that does not meet the quality threshold is rejected regardless of bid price. This ensures that the constrained surface maintains recommendation quality across both paid and organic slots—a property enforced in part by the byte-budget itself, because every byte consumed by low-relevance content reduces the space available for high-relevance content. In a preferred embodiment, the quality threshold is a composite score incorporating at least the relevance of the content to the identified intent, the historical transaction completion rate of the content provider, and a viewer-satisfaction signal derived from prior interaction data. Paid content that meets the quality threshold is ranked by a composite of bid price and quality score, such that a lower bid with higher relevance can outrank a higher bid with lower relevance. The allocation between paid and organic portions of the byte-budget is configurable by the surface operator, enabling operators to balance monetization against recommendation quality.

In one embodiment, the same interactive content is simultaneously available across multiple resource-constrained message surfaces with different byte-budgets and sandbox restrictions. The system adapts the content for each surface—rendering a full product catalog with variant selection within a 102,400-byte AMP email, a condensed product card with one-tap purchase within a 28,000-byte Adaptive Card, a summary notification with purchase confirmation within a 4,096-byte push notification, and a shoppable overlay within a connected-television display—all from a single content definition, with the budget-aware allocator selecting the appropriate subset of content elements for each surface's constraints. The content provider defines the interactive experience once; the constraint-adaptive architecture delivers it through every surface the viewer uses.

### Embedded Constrained Surfaces as Interactive Service Endpoints

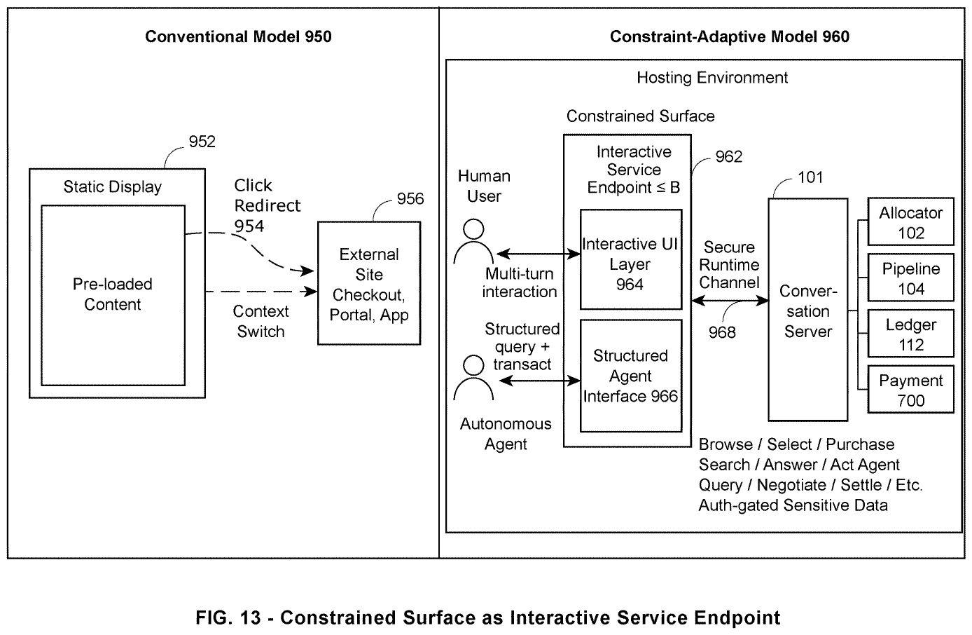

FIG. 13 is a comparison diagram illustrating transformation of a constrained message surface from a conventional static-display-plus-redirect model 950 into an interactive service endpoint operating under a constraint-adaptive model 960. Referring to FIG. 13, in one embodiment, a resource-constrained message surface is embedded within any hosting environment—including, without limitation, web pages, mobile applications, browser sidebars, operating-system notification panels, smart-display interfaces, vehicle infotainment systems, wearable device screens, digital signage, advertising display units (such as standard banner placements, interstitial overlays, native content units, and connected-television overlays), application widgets, and any current or future environment that allocates a constrained region for third-party interactive content. The embedded surface operates under the same byte-budget, sandbox, and absent-sender-accessible-middleware constraints as other message surfaces—the hosting environment does not relax these constraints, because the embedded surface renders within a sandboxed context (such as an iframe with restricted permissions, a WebView with limited API access, a SafeFrame advertising container, an MRAID-compliant mobile ad container, or a platform-provided widget region) that imposes its own byte ceiling and execution restrictions independent of the host environment. Critically, the embedded surface is not a static display unit—it is a live, interactive service endpoint that maintains a secure runtime channel to the envelope generator, accepts multi-turn interaction from both human users and autonomous software agents, and delivers the full constraint-adaptive experience (byte-budget enforcement, server-side security controls, session state persistence, and tamper-evident audit recording) within the constrained region. In one embodiment, the interactive service endpoint is embedded by providing the hosting environment with an endpoint URL and rendering instructions—such as an HTML iframe element with a src attribute pointing to the envelope generator's endpoint URL, a JavaScript embed snippet that creates a sandboxed container and loads the initial payload, or a platform-specific widget descriptor (e.g., an MRAID tag, a SafeFrame meta element, or an operating-system widget manifest)—that cause the hosting environment to allocate a sandboxed region and load the interactive service endpoint's initial communication envelope from the envelope generator. This transforms constrained embedded regions—which conventionally serve only as static displays with redirect links—into fully interactive application surfaces capable of delivering complete multi-step workflows without the viewer leaving the hosting environment.

The interactive service endpoint described herein solves a specific technical problem in network architecture: the problem of maintaining a multi-turn, server-stateful interactive application within a resource-constrained execution sandbox that imposes hard byte ceilings on delivered payloads, restricts executable logic, and provides no sender-accessible server-side middleware. The solution is a system for dynamic network payload optimization in which the envelope generator continuously calculates the available byte-budget for the target sandbox and generates a composite payload—including both visual rendering elements and machine-readable structured data—that fits exactly within the sandbox's operational limits for each interaction turn. This per-turn payload optimization is the technical mechanism that enables the interactive endpoint to function within hostile sandboxed environments where conventional web application architectures cannot operate.

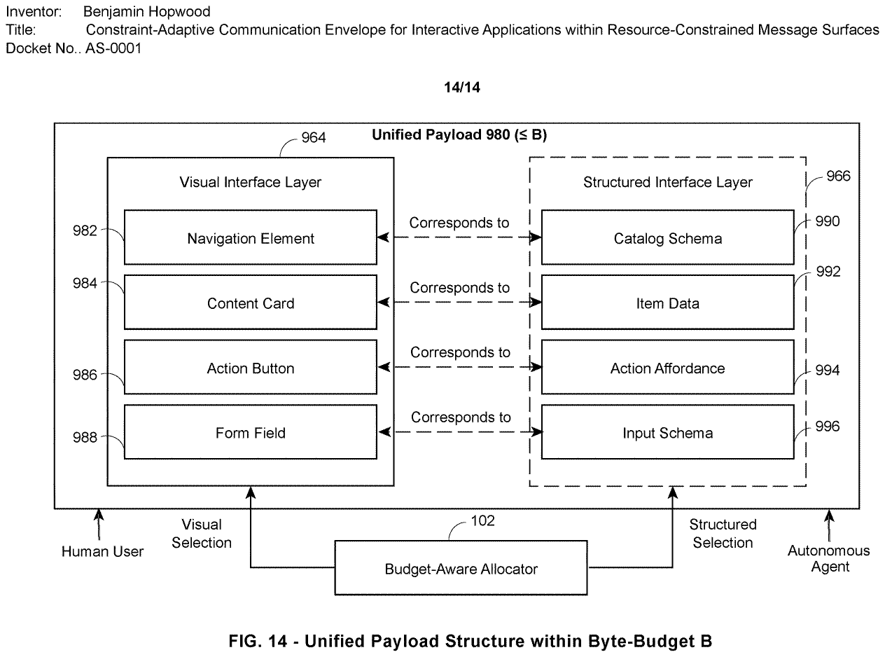

FIG. 14 is a data structure diagram illustrating unified payload 980 constrained to channel byte-budget B. Referring to FIG. 14, as used herein, “unified payload” 980 refers to a single byte-budget-constrained data delivery that includes both a visual interface layer (presentation markup and interactive elements rendered for human users) and a structured interface layer (machine-readable capability metadata, structured data schemas, and programmatic affordances consumable by autonomous software agents), the two layers being structurally mapped such that each machine-readable affordance in the structured layer corresponds to an interactive element in the visual layer. The unified payload is assembled by budget-aware allocator 102, which selects the content elements for both layers subject to the combined byte ceiling—ensuring that the total serialized size of the visual layer plus the structured layer does not exceed the sandbox's byte-budget B for any given turn. As shown in FIG. 14, visual interface layer 964 includes navigation elements 982 (enabling browsing within the constrained surface), content cards 984 (presenting information units), action buttons 986 (triggering workflow steps), and form fields 988 (collecting input)—each rendered for human visual interaction. Structured interface layer 966 includes corresponding machine-readable elements: catalog schemas 990 (describing available content structure), item data 992 (providing typed data values), action affordances 994 (exposing executable operations), and input schemas 996 (defining required input formats)—each consumable by autonomous software agents. The bidirectional correspondence between each visual element and its structured counterpart ensures that a human user and an autonomous agent interacting with the same unified payload can achieve equivalent outcomes through their respective interfaces. This structural correspondence distinguishes the unified payload from systems that provide separate human and machine interfaces through independent channels. In one embodiment, the interactive service endpoint operates in an agent-only mode in which only structured interface layer 966 is delivered, without visual interface layer 964. In agent-only mode, the unified payload includes only the machine-readable catalog schemas 990, item data 992, action affordances 994, and input schemas 996, and the byte-budget is allocated entirely to the structured layer. The agent-only mode enables the constrained surface to function as a pure data-transmission and transactional channel between autonomous software agents without consuming byte-budget on human-visible rendering elements—for example, when an agent is programmatically comparing offerings across multiple embedded surfaces, no human user is viewing the surface, and allocating budget to visual elements would waste bandwidth without benefit.

The structural correspondence between visual interface layer 964 and structured interface layer 966 follows from the constraint-adaptive envelope architecture applied to an interactive service endpoint. Because budget-aware allocator 102 selects content elements for both layers from the same conversational-state source under the same combined byte-budget B, each content element in the visual layer and its counterpart in the structured layer derive from a single underlying state element—they are two projections of the same content into two rendering modalities, not two independent interfaces. The bidirectional correspondence therefore inherently follows from the shared-source selection: when budget-aware allocator 102 includes a product in the unified payload, the visual-layer content card 984 presenting the product to a human user and the structured-layer item data 992 presenting the product to an autonomous agent refer to the same product and expose the same action affordances. The correspondence is preserved across turns because subsequent turns re-select from the same conversational state under updated constraints. In one embodiment, the unified payload further supports hybrid interaction in which a human user and an autonomous agent cooperatively interact with the same endpoint within the same byte-budget B—for example, an agent may pre-populate form fields 988 through the structured interface while the human user reviews and confirms the values through the visual interface—enabling mixed-initiative workflows that neither interface alone could support.

Each interaction event conducted through the interactive service endpoint—including, without limitation, product views, form submissions, payment authorizations, agent queries, agent responses, and workflow state transitions—generates a cryptographic interaction record that is appended to tamper-evident audit ledger 112. The interaction record includes a hash of the prior record (forming a hash-linked chain), the interaction type, the interacting entity (human user, identified agent, or system process), the byte-budget in effect for that turn, and the content elements delivered in the payload. This cryptographic accountability operates within the byte-budgeted response cycles of the constrained surface: the audit hash for each turn is computed and recorded as part of the same server-side processing that generates the per-turn payload, ensuring that the audit trail is synchronized with the payload delivery without requiring additional round trips that would violate latency constraints.

As shown in FIG. 13, the conventional model 950 delivers a static display 952 including pre-loaded content; when a viewer interacts with the display, a redirect 954 navigates the viewer to an external site 956 (such as a checkout page, product portal, or application download), breaking the viewer's context within the hosting environment. In the constraint-adaptive model 960, the interactive service endpoint 962 replaces the static display and redirect with a live constrained surface operating within byte-budget B. The endpoint includes two interaction layers: interactive UI layer 964, which presents a visual interface for human users (product browsing, form completion, payment, information display), and structured agent interface 966, which exposes a machine-readable interface for autonomous software agents (structured intent queries, programmatic evaluation, transactional operations). Both layers communicate with envelope generator 101 through secure runtime channel 968—the same two-phase secure channel described in paragraphs [0134]-[0144]. Secure runtime channel 968 operates independently of the hosting environment: the channel is established directly between the interactive service endpoint's sandboxed execution context and the envelope generator without routing through or being mediated by the hosting environment's application layer, ensuring that the hosting environment cannot intercept, modify, or terminate the secure channel or access the data flowing through it. The hosting environment provides only the sandboxed execution container; all application state, session management, and data delivery are handled exclusively through the secure runtime channel between the endpoint and the envelope generator. The constraint-adaptive model has no exit arrow: all interaction—human or agent, commerce or information, single-turn or multi-turn—completes within the constrained surface.

In one embodiment, an autonomous software agent navigating a web page, application, device interface, or any other environment hosting an embedded constrained surface discovers the surface and interacts with it through the constraint-adaptive bridge rather than parsing and navigating the host environment's unconstrained content. The embedded surface exposes a structured interface—including available inventory, service offerings, information resources, or content catalog—that the agent can query with a structured intent representation, receive relevance-ranked results constrained to the surface's byte-budget, and complete a multi-step transaction or information-retrieval workflow within the surface. This approach eliminates the redirect model that conventional advertising and embedded content rely on: rather than clicking a link and navigating to an external site, the agent (or human user) achieves the desired outcome—whether a purchase, a booking, an information query, a service request, or any other interaction—entirely within the constrained surface. The constrained surface functions as a self-contained service endpoint, not a waypoint to an external destination. This is particularly significant for autonomous agents, which operate most efficiently when they can discover, evaluate, and transact within structured interfaces rather than parsing arbitrary HTML, following redirect chains, or navigating full web applications. As autonomous agents increasingly perform browsing, shopping, research, and transactional tasks on behalf of human principals, embedded constrained surfaces provide a standardized, byte-budget-compliant interaction layer that agents can engage with programmatically—enabling agent-mediated commerce, information retrieval, service provisioning, and negotiation at scale through surfaces deployed across the web, within applications, on devices, and in any future hosting environment.

In one embodiment, the operator of the web page or application that hosts the embedded surface receives attribution credit and revenue share for transactions completed within the surface. Because the tamper-evident audit ledger records the hosting surface's identifier alongside each interaction event, the system can deterministically attribute each transaction to the originating page or application. The hosting operator is compensated based on completed transactions—not impressions or clicks—creating an incentive structure aligned with transaction value rather than traffic volume. In one embodiment, the revenue share is calculated as a configurable percentage of the transaction value, recorded in the audit ledger alongside the economic settlement for the transaction itself.

In one embodiment, multiple embedded constrained surfaces across different web pages and applications are connected through the constraint-adaptive architecture, enabling an agent to discover and compare offerings across sites by querying each site's embedded surface with the same structured intent, receiving constraint-adapted results from each, and completing the transaction on whichever site offers the best match—all without redirecting away from any site or requiring the agent to parse each site's proprietary HTML structure. The hosting sites collectively form a distributed network of agentic surfaces, each independently operated but standardized through the constraint-adaptive bridge protocol.

### Search-and-Answer Workflows

In one embodiment, the embedded constrained surface supports search-and-answer workflows in which a human user or autonomous agent poses a natural-language query within the surface and receives a structured, interactive response—including, without limitation, product search results with comparison and purchase capability, service availability checks with booking capability, informational answers with source attribution and follow-up queries, diagnostic flows with resolution actions, and any other query-response interaction that can be modeled as a multi-turn workflow within the byte-budget. This search-and-answer capability distinguishes the embedded constrained surface from conventional search results (which redirect to external pages) and from conventional advertising (which redirects to external checkout flows): the user or agent receives an actionable answer AND can act on it within the same surface, without a context switch. In one embodiment, multiple service providers compete to answer the query—each providing an interactive response through the constraint-adaptive architecture, with the system ranking responses by relevance, quality, and (for paid placements) bid price, and presenting the best-matching responses within the constrained surface. In one embodiment, the query originates from an autonomous agent conducting research, comparison shopping, or due diligence on behalf of a human principal, and the agent evaluates and acts on the responses programmatically through the constraint-adaptive bridge, completing the entire workflow within the surface without human intervention. The search-and-answer embodiment is not limited to any particular query type, response format, or service domain; any interaction that begins with a query and concludes with an actionable result within the byte-budget constraint is within the scope of this embodiment.

### IoT and Digital Twin Interfaces

In one embodiment, a resource-constrained message surface is rendered on an IoT device display—such as, without limitation, a smart thermostat, a connected medical device (insulin pump, blood-pressure monitor, pulse oximeter), an industrial sensor panel, a smart lock interface, a connected appliance display, a smart-home control hub, or any current or future connected device with a display that imposes byte-budget and interaction constraints. The IoT device display is a constrained surface under the same architectural framework: it has a byte ceiling (often severely limited), sandbox restrictions (limited rendering capabilities), and absent sender-accessible middleware. The constraint-adaptive architecture delivers interactive configuration, monitoring, alerting, and control workflows to the IoT device display without requiring a dedicated per-device application—the device operator defines the interactive experience once, and the architecture adapts it to each device's display constraints. In one embodiment, an autonomous system-monitoring agent interacts with the IoT device's constrained surface to read sensor data, adjust operating parameters, acknowledge alerts, and initiate maintenance workflows—all through the constraint-adaptive bridge without requiring custom API integration per device type. This embodiment extends to digital-twin monitoring: the constrained surface can present a virtual representation of a physical asset (such as industrial equipment, a fleet vehicle, or a building system), with budget-aware allocator 102 selecting the most critical telemetry, alerts, and control options for the available byte-budget.

### Cross-Device Session Continuity

In one embodiment, a recipient initiates an interactive workflow on one constrained message surface and continues it on a different constrained surface with a different byte-budget. For example, a recipient receives a purchase notification as a push notification (B=4,096 bytes) on a wearable device, views a condensed order summary, then reopens the same conversation in an email client (B=102,400 bytes) on a laptop, where the system renders the full order details, shipping options, and payment interface—continuing from the same session state without requiring the recipient to restart the workflow. The session state is maintained server-side in storage system 110, indexed by conversation identifier; when the recipient accesses the conversation from a different surface, envelope generator 101 derives the new surface's byte-budget B from its platform descriptor and budget-aware allocator 102 selects the appropriate content subset for the new budget. Content that was excluded as placeholders on the smaller surface may be rendered in full on the larger surface, and vice versa. The cross-device handoff is transparent to the recipient—the workflow continues seamlessly regardless of which surface is used to access it.

### Accessibility as a Constraint Dimension

In one embodiment, the constraint-adaptive architecture treats accessibility requirements as an additional constraint dimension alongside byte-budget, sandbox restrictions, and latency. When the host-channel client is an accessibility interface—such as, without limitation, a screen reader, a braille display, a voice-only interface, a magnification tool, or a switch-access device—the platform descriptor includes the modality constraints of the accessibility interface, and the system adapts the communication envelope accordingly. For a screen reader, the system selects text-based content elements and arranges them in a linear reading order, replacing visual elements (images, color swatches, spatial layouts) with text descriptions and typed placeholder assets; for a braille display, the system further constrains output to the display's character limit per line; for a voice-only interface, the system structures the interaction as a sequential spoken dialogue with numbered options. The accessibility adaptation operates through the same budget-aware allocator 102 and channel adapter set 105 as all other constraint adaptations—accessibility is not a separate system but a constraint profile that the existing architecture resolves. This approach enables interactive multi-step workflows (including commerce, healthcare, financial, and all other workflow types described herein) to be conducted through accessibility interfaces without requiring separate accessibility-specific application development.

### Collaborative Multi-Recipient Surfaces

In one embodiment, multiple recipients interact with the same constrained message surface concurrently, with the system maintaining per-recipient authentication state and contribution tracking within a shared session. Representative embodiments include, without limitation: splitting a restaurant bill among diners within a group-chat constrained surface, where each participant authenticates and confirms their share; planning a trip with co-travelers within a shared email thread, where each traveler selects preferences and the system assembles the group itinerary; approving a contract with multiple signers within the same message, where each signer authenticates and signs independently; and conducting a group purchase where each participant selects items and the system aggregates the order. Each participant's interactions are recorded separately in tamper-evident audit ledger 112, enabling per-recipient audit while maintaining a single shared session state. The collaborative model extends to autonomous agents: multiple agents representing different principals can interact with the same constrained surface simultaneously, negotiating and transacting within the shared session.

### Offline Interaction with Eventual Synchronization

In one embodiment, the host-channel client caches the most recently received communication envelope locally, enabling the recipient to interact with the cached envelope during periods of no network connectivity. The recipient's interactions—such as form entries, selections, and navigation actions—are accumulated locally and transmitted to the envelope generator when connectivity is restored. Upon reconnection, the envelope generator applies the accumulated interactions to the session state, resolves any conflicts with server-side state changes that occurred during the offline period, records the offline interaction period in tamper-evident audit ledger 112 (including the offline duration and the number of cached interactions), and delivers a refreshed envelope reflecting the synchronized state. This offline-first capability extends the reach of the constraint-adaptive architecture to environments with intermittent connectivity—including, without limitation, field operations, disaster-response scenarios, developing markets with limited infrastructure, underground or in-transit locations, and any environment where network access is unreliable. The offline interaction model operates within the same session-state and audit-chain framework as online interactions; the offline period is recorded as a gap in the audit chain that is closed upon synchronization.

### Micropayments and Agent-Mediated Value Exchange

In one embodiment, the constraint-adaptive architecture supports sub-dollar transactions within constrained message surfaces, enabling business models that are impractical with conventional redirect-based payment flows due to the friction of context-switching for small amounts. Representative human-facing embodiments include, without limitation: pay-per-read content access within an email newsletter, tipping a content creator within a push notification, unlocking premium features within an embedded widget, and making charitable micro-donations within a message surface. Representative agent-facing embodiments include, without limitation: an autonomous agent paying a per-query fee to access a data service through a constrained surface, an agent paying a micro-transaction to retrieve a document or dataset through the secure runtime channel, agents exchanging value for information or computational results within the constraint-adaptive bridge, and machine-to-machine payment settlement for IoT device interactions. In each case, the payment is processed through the PCI-scoped payment interface 700 or through a tokenized payment mechanism, the transaction is recorded in tamper-evident audit ledger 112, and the entire payment flow completes within the constrained surface without redirection. The micropayment embodiment is not limited to any particular payment amount, currency, payment method, or value-exchange model.

### Dynamic Agent-Mediated Negotiation Within Constrained Surfaces

In one embodiment, a transaction within a constrained surface involves dynamic negotiation between autonomous agents rather than interaction at a fixed, predetermined price. A selling agent operating on behalf of a content provider is authorized to adjust transaction terms—including price, delivery timeline, return policy, warranty coverage, financing terms, and bundle composition—based on characteristics of the specific buyer or buying agent. The selling agent maintains a negotiation budget and a set of term-adjustment rules configured by the content provider. The buying agent operating on behalf of a purchaser presents its principal's requirements, budget constraints, and preferences through the constrained surface, and the selling agent responds with tailored terms within the byte-budget. Multiple negotiation turns may occur within the constrained surface, with each turn's session state maintained by the bridge and every offer, counter-offer, and settlement recorded in the tamper-evident audit ledger.

In one embodiment, the system maintains a reputation score for each participating agent—both selling agents and buying agents—based on historical transaction data recorded in the audit ledger. The reputation score reflects at least transaction completion rate, buyer satisfaction signals, accuracy of product or service descriptions, and timeliness of delivery fulfillment. The reputation score influences placement ranking: a selling agent with a higher reputation score receives priority for constrained-surface placement even at a lower bid price, because higher-reputation agents are more likely to produce completed transactions. A buying agent with a higher reputation score may receive preferential terms from selling agents, because transactions with higher-reputation buyers are more likely to complete successfully. The reputation system creates a compounding quality incentive: agents that deliver good outcomes earn better placement, which generates more transactions, which further establishes their reputation.

In one embodiment, the constrained surface mediates a one-to-many interaction in which a single buying agent queries multiple selling agents simultaneously through the bridge. The buying agent transmits a structured intent including desired product or service attributes, budget constraints, and delivery requirements. The bridge routes the intent to multiple selling agents, each of which responds with tailored terms constrained to the surface's byte-budget. The buying agent receives and compares the competing offers within the constrained surface and selects the best match. The bridge maintains session state for each selling agent interaction independently, enabling the buying agent to conduct parallel negotiations without the selling agents being aware of each other's offers.

In one embodiment, the constrained surface mediates a many-to-many interaction in which multiple buying agents pool their purchasing requirements and multiple selling agents compete for the pooled demand. The pooled buying group achieves volume-based pricing that individual buyers could not obtain. Each buying agent contributes its requirements through the bridge; the system aggregates the requirements into a composite demand signal; selling agents bid against the composite demand; and the winning offer is distributed to each buying agent with individualized fulfillment terms. The pooling, aggregation, bidding, and distribution all occur through the constraint-adaptive architecture, with each interaction turn constrained to the surface's byte-budget and every event recorded in the audit ledger.

### Comparative Examples

Unlike conventional messaging systems that either truncate content arbitrarily when approaching a channel byte limit or require surface-by-surface development, budget-aware allocator 102 deterministically enforces byte-budget B through relevance-based eviction. In benchmark testing with a 102,400-byte AMP for Email envelope, the allocator retained 94% of ranked context items while guaranteeing delivery, compared to 61% content retention using naive FIFO truncation and 100% delivery failure rate without any adaptation.

In a second example, a multi-turn customer service conversation is delivered via push notification with B=4,096 bytes. The conversation history spans 15 turns totaling 48,000 bytes. Budget-aware allocator 102 retains the two most recent turns (1,200 bytes), the active form fields for the current inquiry (800 bytes), a HIPAA consent acknowledgment pinned by the compliance parameter (400 bytes), and replaces the remaining 12 turns with typed placeholder assets (12×80 byte=960 bytes each including content-type, text-summary surrogate, and manifest pointer). The resulting shard (3,360 bytes) fits within B=4,096 bytes with room for the replay-detection token and turn header. The recipient can tap any placeholder to hydrate the full content of that prior turn all within the push notification interface without launching a browser.

This technical improvement enables deployment of the same interactive application across surfaces ranging from 4,096-byte push notifications to approximately 250,000-byte Google RCS Business Messaging payloads without modification to the application logic.

### Multi-Step Workflow Definition

The term “multi-step interactive workflow” as used herein refers to an interaction in which each step generates updated session state that persists to subsequent steps through server-side state management coordinated with byte-budget enforcement and sender-controlled compliance and security controls. Application-grade interactivity is distinguished from prior trivial-interaction patterns by the architectural requirement that accumulated workflow context—including prior-turn outputs, accumulated user input, and cumulative session state—be carried forward across turns through a byte-budget-constrained envelope under server-side control. Conventional declarative message technologies render single-form submissions or basic submission-plus-confirmation patterns without persistent server-side session state, sender-controlled middleware, or audit-ledger-recorded turn sequencing, and accordingly cannot maintain the accumulated workflow context that an application-grade workflow requires across the byte-budget-constrained envelope. The disclosed multi-step interactive workflow includes at least three distinct interaction steps where each step's session state persists across the byte-budget-constrained envelope to the next step, the persistence being effected by the budget-aware allocator, the placeholder engine, the replay-detection token, and the tamper-evident audit ledger operating in coordination. Representative workflows include six-step commerce checkout (browse→select→cart→ship→pay→confirm), the extended commerce lifecycle continuing past confirmation through order tracking, invoice review, shipping history, product reviews, and embedded support chat (all within the same interactive surface and session), four-step healthcare billing (notify→authenticate→review→pay), four-step customer service (describe→diagnose→resolve→confirm), and three-step document execution (review→complete→sign). The three-step minimum is a floor; there is no upper bound on the number of steps or on the duration of the workflow, which may span seconds, minutes, days, or weeks of interaction within the same persistent message surface.

What is claimed is:

1. A computer-implemented system comprising one or more processors and a memory storing instructions that, when executed, cause the system to:
(a) for a resource-constrained electronic message surface that imposes at least a byte-ceiling constraint and a sandbox restriction limiting executable logic, derive a channel byte-budget from the byte-ceiling constraint;
(b) resolve the compounding constraints of the byte-ceiling constraint, the sandbox restriction, and an absence of sender-accessible server-side middleware on the message surface to assemble a communication envelope that fits within the channel byte-budget and contains an interactive application compatible with the sandbox restriction, said assembly being performed by a budget-aware allocator that selects conversational state elements for inclusion in the communication envelope subject to the channel byte-budget;
(c) apply server-side security and compliance controls to the communication envelope prior to transmission, the controls compensating for the absence of sender-accessible server-side middleware on the message surface;
(d) transmit the communication envelope to the message surface via a standard message delivery transport;
(e) maintain interactive session state across a plurality of sequential interaction turns within the message surface, each turn generating updated session state that is incorporated into a refreshed communication envelope constrained to the channel byte-budget, and record each interaction turn, each policy decision applied by the server-side security and compliance controls, and each constraint-adaptation event as a hash-linked record in a tamper-evident audit ledger; and
(f) enable a recipient to complete a multi-step interactive workflow—comprising at least three distinct interaction steps with session state persisting across steps—entirely within the message surface without the recipient being redirected to an external interface at any step.

2. The system of claim 1, wherein when the interactive session state for a current turn would exceed the channel byte-budget, the system selects a subset of state elements for inclusion in the communication envelope based on at least one relevance criterion, while retaining references enabling retrieval of excluded elements, and replaces each excluded element with a typed placeholder asset comprising a content-type identifier, a condensed surrogate, and an authenticated retrieval reference enabling on-demand recovery of the full element.

3. The system of claim 2, wherein selecting the subset includes identifying elements subject to a regulatory retention mandate and unconditionally retaining those elements in the communication envelope regardless of their relevance score, such that regulation-mandated content survives eviction even when the channel byte-budget requires removal of other elements.

4. The system of claim 1, further comprising generating a replay-detection token that cryptographically binds at least a conversation identifier, a platform identifier, and a recipient identifier into a single verifiable credential, such that the communication envelope is rejected when executed on a platform other than a platform identified by the platform identifier or by a recipient other than a recipient identified by the recipient identifier, thereby preventing replay or misuse of the envelope when forwarded across message surfaces.

5. The system of claim 1, wherein the server-side security and compliance controls comprise an ordered pipeline of at least rate limiting, policy evaluation, and content classification applied to the communication envelope before it reaches the message surface.

6. The system of claim 1, further comprising a tamper-evident audit ledger in which each conversational turn, policy decision, and constraint-adaptation event is recorded as a turn record that includes a cryptographic hash of a preceding record, forming a hash-linked chain such that alteration of any record is detectable, enabling regulated senders to prove the complete chain of custody for every interaction conducted within the message surface.

7. The system of claim 1, wherein the system automatically formats the communication envelope into a surface-native representation compatible with the resource-constrained electronic message surface without requiring surface-specific application logic, such that a single interactive application is deliverable across heterogeneous message surfaces without per-surface development.

8. The system of claim 1, wherein the system applies a compliance profile that governs how regulated data is handled within the communication envelope, the compliance profile being dynamically selectable from at least the Health Insurance Portability and Accountability Act (HIPAA), the General Data Protection Regulation (GDPR), the Payment Card Industry Data Security Standard (PCI DSS), the Financial Industry Regulatory Authority (FINRA) regulations, the California Consumer Privacy Act as amended by the California Privacy Rights Act (CCPA/CPRA), the Brazil Lei Geral de Proteção de Dados Pessoais (LGPD), the Japan Act on the Protection of Personal Information (APPI), or the India Digital Personal Data Protection Act (DPDP), enabling the same architecture to handle regulated workflows across different jurisdictions and regulatory domains without modification to the application logic.

9. The system of claim 1, further comprising a storage system maintaining conversation state across (i) a low-latency hot tier configured to provide median read latency below a hot-tier latency threshold, (ii) a cost-efficient cold tier storing aged elements encrypted under a tier-specific encryption key rotated on a configurable schedule, and (iii) a message-surface tier corresponding to the sliding-window shard delivered to the host-channel client, wherein elements migrate between the hot tier and the cold tier according to access-frequency and retention-policy indicators recorded in a migration index, and wherein upon receipt of a data-subject erasure request the system overwrites the cold-tier object corresponding to the subject with a deterministic filler pattern of equal byte length while preserving the cryptographic digest of the erased object in the tamper-evident audit ledger as a tombstone record, and appends an erasure-record entry to the audit ledger comprising at least a conversation identifier, an item identifier, a cryptographic hash of the filler, and a timestamp.

10. The system of claim 1, further comprising a lifecycle controller that transitions a conversation identifier through a finite set of states comprising at least active, frozen, archived, deleted, and legal-hold, wherein mutation requests directed at a conversation in the frozen state or the archived state are rejected, a transition into the frozen state is triggered by a finalization criterion selected from completion of a financial transaction workflow, expiration of a configured retention window, sender retirement, or a signed lifecycle-transition request, and each state transition is appended to the tamper-evident audit ledger as a state-transition record comprising at least a predecessor-state indicator, a successor-state indicator, and a cryptographic signature over the transition metadata.

11. The system of claim 1, wherein the system assigns a monotonically increasing turn-sequence number to each communication envelope and to each recipient interaction request, applies an atomic compare-and-swap against a stored turn-sequence number when processing a received recipient interaction, and upon compare-and-swap failure returns a structured conflict response to the recipient comprising at least a retry-after indicator and a current-sequence indicator, and records in the tamper-evident audit ledger a conflict-rejection record when the compare-and-swap conflict is irreconcilable or a semantic-rebase record when the system applies a semantic-rebase merge operation to reconcile a non-conflicting delta from the recipient interaction against an updated authoritative state.

12. A computer-implemented method performed by one or more processors, the method comprising:
(a) for a resource-constrained electronic message surface that imposes at least a byte-ceiling constraint and a sandbox restriction, deriving a channel byte-budget from the byte-ceiling constraint;
(b) resolving the compounding constraints of the byte-ceiling constraint, the sandbox restriction, and an absence of sender-accessible server-side middleware to assemble a communication envelope fitting within the channel byte-budget and containing an interactive application compatible with the sandbox restriction;
(c) applying server-side security and compliance controls compensating for the absence of sender-accessible server-side middleware on the message surface;
(d) transmitting the communication envelope to the message surface;
(e) maintaining interactive session state across a plurality of sequential interaction turns, each turn incorporating updated state into a refreshed envelope constrained to the channel byte-budget; and
(f) enabling a recipient to complete a multi-step interactive workflow entirely within the message surface without redirection at any step.

13. The method of claim 12, further comprising generating a replay-detection token cryptographically binding the envelope to at least a recipient identity and a platform identity, and rejecting interaction requests when the token does not match the execution environment.

14. The method of claim 12, further comprising recording each conversational turn in a tamper-evident audit ledger using hash-linked records.

15. The method of claim 12, wherein the resource-constrained electronic message surface comprises a machine-readable code presentation including a Quick Response (QR) code, a Data Matrix pattern, a PDF417 barcode, or an Aztec code, and the communication envelope is delivered to the host-channel client in response to a scan event decoding the machine-readable code, the machine-readable code containing a conversation reference that, upon decoding by a scanning device, triggers delivery of the communication envelope from an envelope generator to a scanning device's display.

16. A computer-implemented method for delivering sensitive data through a resource-constrained electronic message surface, the method comprising:
(a) transmitting, via a standard message delivery transport, an initial communication envelope to a host-channel client, the initial communication envelope containing presentation markup, interactive application logic, and a plurality of typed placeholder assets, each typed placeholder asset comprising a content-type identifier indicating a category of sensitive data replaced and a condensed surrogate enabling a recipient to identify the nature of the missing data without access to the data itself, wherein the plurality of typed placeholder assets collectively serve a dual function of (i) satisfying at least one constraint imposed by the resource-constrained electronic message surface, said at least one constraint being selected from a byte-ceiling constraint, a sandbox restriction limiting executable logic, an attachment or remote-content blocking policy, a user-interface element quota, a privacy gate suppressing tracking mechanisms, and a latency service-level target, and (ii) ensuring that no sensitive data element is present in the initial communication envelope transmitted via the standard message delivery transport;
(b) causing, by application logic embedded in the initial communication envelope, the host-channel client to establish an authenticated secure channel directly between the host-channel client and an envelope generator upon the host-channel client rendering the initial communication envelope, the secure channel bypassing the standard message delivery transport through which the initial communication envelope was transmitted;
(c) receiving, at the envelope generator via the authenticated secure channel, an interaction request from the host-channel client, and evaluating whether the recipient satisfies authentication requirements specified by a data-protection compliance profile applicable to the sensitive data, the compliance profile being dynamically selected based on the regulatory regime governing the sensitive data;
(d) upon the recipient satisfying the authentication requirements, transmitting the sensitive data exclusively through the authenticated secure channel to the host-channel client for rendering within the message surface in place of the corresponding typed placeholder assets, the sensitive data never traversing the standard message delivery transport; and
(e) recording each authentication event and each sensitive-data disclosure event as a discrete entry in a tamper-evident audit ledger, using hash-linked records, such that the ledger cryptographically proves that each sensitive data element was disclosed only after the recipient satisfied the authentication requirements of the applicable compliance profile.

17. The method of claim 16, wherein at least one constraint is the byte-ceiling constraint, and the typed placeholder assets keep the initial communication envelope within a channel-specific byte ceiling while ensuring that no sensitive data traverses the standard message delivery transport.

18. The method of claim 16, further comprising executing a progressive disclosure sequence within a single continuous session on the message surface, the progressive disclosure sequence comprising:
(i) an initial state in which all sensitive data elements are represented as fully obscured typed placeholder assets displaying only content-type identifiers and condensed surrogates;
(ii) upon the recipient satisfying a first authentication challenge within the message surface, transitioning one or more sensitive data elements from the fully obscured state to a partially masked state in which the data element is displayed with selective redaction revealing sufficient structure for the recipient to identify the record without exposing the full sensitive content; and
(iii) upon the recipient satisfying a second authentication challenge of higher assurance than the first, transitioning the one or more sensitive data elements from the partially masked state to a fully visible state in which the complete data element is rendered within the message surface;
wherein each state transition is recorded in the tamper-evident audit ledger with the authentication method used, the assurance level achieved, and the specific data elements transitioned.

19. The method of claim 16, wherein the data-protection compliance profile is dynamically selectable from compliance profiles including, without limitation, profiles corresponding to healthcare data protection mandates, financial data protection mandates, personal information protection mandates, legal professional privilege mandates, and government data classification mandates, the system adapting the authentication requirements and disclosure rules to the selected profile without modification to the envelope assembly or interactive application logic.

20. The method of claim 16, wherein the authenticated secure channel is established using a mechanism native to the host-channel client's message surface, including, without limitation, authenticated HTTPS requests initiated by interactive elements within the message surface.

21. A non-transitory computer-readable medium storing instructions that, when executed by one or more processors, cause the processors to perform the method of claim 12.

22. A computer-implemented system comprising one or more processors and a memory storing instructions that, when executed, cause the system to:
(a) embed, within a hosting environment, an interactive service endpoint operating within a resource-constrained sandboxed region that imposes at least a byte-budget constraint limiting the serialized size of content deliverable per interaction turn and an execution restriction limiting the executable logic permitted within the sandboxed region;
(b) establish a secure runtime channel between the interactive service endpoint and an envelope generator, the secure runtime channel operating independently of the hosting environment;
(c) provide, through the interactive service endpoint, a unified payload comprising a visual interface layer for interaction by human users and a structured interface layer exposing machine-readable capability metadata for interaction by autonomous software agents, the visual interface layer and the structured interface layer being delivered within the same byte-budget-constrained payload;
(d) maintain, at the envelope generator, session state across a plurality of interaction turns conducted by human users or autonomous software agents within the interactive service endpoint, the envelope generator assembling for each turn a refreshed payload that fits within the byte-budget constraint by selecting content elements based on at least one relevance criterion;
(e) enable completion of a multi-step interactive workflow—comprising at least three distinct interaction steps with session state persisting across steps—entirely within the interactive service endpoint without redirecting any human user or autonomous software agent to an interface external to the hosting environment at any step; and
(f) record each interaction event within the interactive service endpoint in a tamper-evident audit ledger.
